(19) United States
(12) Patent Application Publication
(10) Pub. No.: US 2026/0172708 A1
(43) Pub. Date: Jun. 18, 2026

(54) SOLID-STATE IMAGING ELEMENT AND METHOD FOR CONTROLLING SOLID-STATE IMAGING ELEMENT

(71) Applicant: Sony Semiconductor Solutions Corporation, Kanagawa (JP)

(72) Inventors: Hiromu Kato, Kanagawa (JP); Hanae Hasegawa, Kanagawa (JP)

(21) Appl. No.: 19/099,273

(22) PCT Filed: Jun. 28, 2023
(86) PCT No.: PCT/JP2023/023913

§ 371 Date: Jan. 28, 2025

(30) Foreign Application Priority Data
Aug. 25, 2022 (JP) 2022-133733

(51) Int. Cl. H04N 25/616; H04N 25/51; H04N 25/65; H04N 25/77

(52) U.S. Cl. CPC H04N 25/616; H04N 25/51; H04N 25/65; H04N 25/77

(57) ABSTRACT

A solid-state imaging device includes a pixel signal generating section, first and second sample and hold circuits, and a vertical scanning circuit. The pixel signal generating section sequentially generates the first and second pixel signals. The first sample and hold circuit holds the first pixel signal. The second sample and hold circuit holds the second pixel signal. The vertical scanning circuit controls the first and second sample and hold circuits to generate a combined signal of the first and second pixel signals.

### TECHNICAL FIELD

The present technology relates to a solid-state imaging element. Specifically, the present technology relates to a solid-state imaging element that samples and holds a pixel signal, and a method for controlling the solid-state imaging element.

### BACKGROUND ART

Conventionally, in a solid-state imaging element, an inter-frame difference method for obtaining a difference between frames is used for the purpose of detecting a mobile object, or the like. For example, a solid-state imaging element has been proposed in which two capacitive elements are provided for each pixel, one of the capacitive elements is caused to hold a signal level of a previous frame, and the other is caused to hold a signal level of a current frame (see, for example, Patent Document 1). In this solid-state imaging element, the difference between the signal levels of the previous frame and the current frame is calculated by a difference circuit in the subsequent stage.

### CITATION LIST

### Patent Document

Patent Document 1: Japanese Patent Application Laid-Open No. 2010-171666 A

### SUMMARY OF THE INVENTION

### Problems to be Solved by the Invention

In the above-described conventional technique, each pixel holds the respective signal levels of the previous frame and the current frame, to thereby reduce the frame memory for holding the previous frame. However, in order to obtain the difference between the signal levels, in a case where a reset level is different between the previous frame and the current frame, there is a problem that the noise of the difference image increases and the image quality thereof deteriorates.

The present technology has been made in view of such a situation, and an object thereof is to improve image quality in a solid-state imaging element that obtains a difference between frames.

### Solutions to Problems

The present technology has been made to solve the above-described problems, and a first aspect thereof is a solid-state imaging element including a pixel signal generating section that sequentially generates first and second pixel signals, a first sample and hold circuit that holds the first pixel signal, a second sample and hold circuit that holds the second pixel signal, and a vertical scanning circuit that controls the first and second sample and hold circuits to generate a combined signal of the first and second pixel signals. This brings about an effect of improving image quality of difference data.

Furthermore, in the first aspect, the first pixel signal may include a first reset level and a first signal level, the second pixel signal may include a second reset level and a second signal level, and the vertical scanning circuit may cause each of a signal obtained by adding the first reset level and the second signal level and a signal obtained by adding the first signal level and the second reset level to be generated as the combined signal. Thus, there is an effect that a difference between pixel signals after correlated double sampling (CDS) processing can be obtained in a circuit in the subsequent stage.

Furthermore, in the first aspect, it is possible to further include a third sample and hold circuit that holds the second pixel signal and a fourth sample and hold circuit that holds the second pixel signal. This brings about an effect that the difference data can be generated for each frame.

Furthermore, in the first aspect, the pixel signal generating section may further generate a third pixel signal, and the vertical scanning circuit may perform control to cause the first and second sample and hold circuits to generate a combined signal of the first and second pixel signals and cause one of the third and fourth sample and hold circuits to output the second pixel signal, control to cause the first, second, and fourth sample and hold circuits to hold the third pixel signal, and control to cause the third and fourth sample and hold circuits to generate a combined signal of the second and third pixel signals and cause one of the first and second sample and hold circuits to output the third pixel signal. This brings about an effect that the difference data and a current frame are output each time exposure is performed.

Furthermore, in the first aspect, the pixel signal generating section may further generate a third pixel signal, and the vertical scanning circuit may perform control to cause the first and second sample and hold circuits to generate a combined signal of the first and second pixel signals and cause the fourth sample and hold circuit to output the second pixel signal, control to cause the first, second, and fourth sample and hold circuits to hold the third pixel signal, and control to cause the second and third sample and hold circuits to generate a combined signal of the second and third pixel signals and cause the fourth sample and hold circuit to output the third pixel signal. This brings about an effect that the difference data and the current frame are output each time exposure is performed.

Furthermore, in the first aspect, the pixel signal generating section may include first and second pre-stage circuits, the first pre-stage circuit may include a first transfer transistor that transfers a charge from a first photoelectric conversion element to a first floating diffusion layer, and a first connection transistor that connects the first floating diffusion layer and a predetermined node, and the second pre-stage circuit may include a second transfer transistor that transfers a charge from a second photoelectric conversion element to a second floating diffusion layer, and a second connection transistor that connects the second floating diffusion layer and a predetermined node. This brings about an effect that the resolution is improved at a time of normal imaging in which a difference is not obtained.

Furthermore, in the first aspect, the pixel signal generating section may include a pre-stage circuit, and the pre-stage circuit may include a transfer transistor that transfers a charge from a photoelectric conversion element to a floating diffusion layer. This leads to an effect that the circuit scale of the pixel signal generating section is reduced.

Furthermore, in the first aspect, it is possible to further include a motion determination section that determines presence or absence of motion of a subject on the basis of the combined signal, and an interface that outputs the second pixel signal in a case where the motion is made. This brings about an effect that the processing amount and the communication amount of the host are reduced.

Furthermore, in the first aspect, it is possible to further include a column signal processing circuit that outputs the second pixel signal when receiving a determination result indicating that a subject has made motion from the outside. This brings about an effect of reducing the processing load on the solid-state imaging element.

Furthermore, a second aspect of the present technology is a solid-state imaging element including a predetermined number of pixels that sequentially hold and sequentially output a first signal level and a second signal level according to an exposure amount, generate a reset level, and sequentially output the second signal level and the reset level, a differentiation circuit that obtains a difference between the first signal level and the second signal level, a comparison section that compares an absolute value of the difference with a predetermined threshold and outputs a comparison result, a region determination section that determines whether or not each of the pixels is in a region of a mobile object on the basis of the difference and the comparison result, and an analog-to-digital converter that sequentially converts the second signal level and the reset level into a digital signal. This produces an effect that power consumption decreases.

Furthermore, in the second aspect, it is possible to further include an analog-to-digital converter that converts each of the reset level and the second signal level into a digital signal, a vertical scanning circuit that drives a predetermined number of the pixels, and a control circuit that controls the vertical scanning circuit and the analog-to-digital converter to generate the digital signal in a clipping region including the region of the mobile object in a case where any of the pixels is determined to be in the region of the mobile object. This brings about an effect that the processing amount and the communication amount of the host are reduced.

Furthermore, in the second aspect, the control circuit may receive clipping region information indicating the clipping region from outside. This brings about an effect of improving versatility and convenience.

Furthermore, in the second aspect, it is possible to further include a control circuit that changes an analog gain of the region of the mobile object in a case where it is determined that any of the pixels is within the region of the mobile object. This brings about an effect of improving image quality.

Furthermore, in the second aspect, the reset level may include a first reset level and a second reset level, the pixels may hold the first reset level, the first signal level, the second reset level, and the second signal level and sequentially output the first signal level and the second signal level, and in a case where it is determined that any of the pixels is in the region of the mobile object, the pixels may sequentially output the second reset level and the second signal level. This brings about an effect of improving image quality.

### BRIEF DESCRIPTION OF DRAWINGS

FIG. 1 is a block diagram illustrating a configuration example of an imaging system according to a first embodiment of the present technology.

FIG. 2 is a diagram illustrating a configuration example of a pixel block according to the first embodiment of the present technology.

FIG. 3 is a diagram illustrating an example of a layout of color filters according to the first embodiment of the present technology.

FIG. 4 is a circuit diagram illustrating a configuration example of a pixel signal generating section according to the first embodiment of the present technology.

FIG. 5 is a circuit diagram illustrating a configuration example of a sample and hold block according to the first embodiment of the present technology.

FIG. 6 is a block diagram illustrating a configuration example of a load metal-oxide-semiconductor (MOS) circuit block and a column signal processing circuit according to the first embodiment of the present technology.

FIG. 7 is a timing chart illustrating an example of operation of the solid-state imaging element in an imaging mode according to the first embodiment of the present technology.

FIG. 8 is a timing chart illustrating an example of global shutter control in the imaging mode according to the first embodiment of the present technology.

FIG. 9 is a timing chart illustrating an example of a read operation of the solid-state imaging element in the imaging mode according to the first embodiment of the present technology.

FIG. 10 is a diagram illustrating an example of a state of the sample and hold block in the imaging mode according to the first embodiment of the present technology.

FIG. 11 is a timing chart illustrating an example of operation until exposure of IG2 of the solid-state imaging element in a difference output mode according to the first embodiment of the present technology.

FIG. 12 is a timing chart illustrating an example of operation after exposure of IG3 of the solid-state imaging element in the difference output mode according to the first embodiment of the present technology.

FIG. 13 is a timing chart illustrating an example of global shutter control in the difference output mode according to the first embodiment of the present technology.

FIG. 14 is a timing chart illustrating an example of difference data between IG0 and IG1 and a read operation of the IG1 according to the first embodiment of the present technology.

FIG. 15 is a timing chart illustrating an example of difference data between the IG1 and the IG2 and a read operation of the IG2 according to the first embodiment of the present technology.

FIG. 16 is a diagram illustrating an example of a state of the sample and hold block in the difference output mode according to the first embodiment of the present technology.

FIG. 17 is a diagram illustrating an example of image data, difference data, and clipping data according to the first embodiment of the present technology.

FIG. 18 is a flowchart illustrating an example of operation of the solid-state imaging element according to the first embodiment of the present technology.

FIG. 19 is a timing chart illustrating an example of operation until exposure of the IG2 of the solid-state imaging element in the difference output mode according to a first modification of the first embodiment of the present technology.

FIG. 20 is a timing chart illustrating an example of operation after exposure of the IG3 of the solid-state imaging element in the difference output mode according to the first modification of the first embodiment of the present technology.

FIG. 21 is a diagram illustrating an example of a layout of a color filter according to a second modification of the first embodiment of the present technology.

FIG. 22 is a circuit diagram illustrating a configuration example of a pixel signal generating section according to the second modification of the first embodiment of the present technology.

FIG. 23 is a circuit diagram illustrating a configuration example of a sample and hold block according to the second modification of the first embodiment of the present technology.

FIG. 24 is a block diagram illustrating a configuration example of a column signal processing circuit according to a third modification of the first embodiment of the present technology.

FIG. 25 is a timing chart illustrating an example of operation of the solid-state imaging element in the difference output mode according to the third modification of the first embodiment of the present technology.

FIG. 26 is a block diagram illustrating a configuration example of a host according to a fourth modification of the first embodiment of the present technology.

FIG. 27 is a timing chart illustrating an example of operation of the solid-state imaging element in the difference output mode according to the fourth modification of the first embodiment of the present technology.

FIG. 28 is a circuit diagram illustrating a configuration example of a pixel block according to a fifth modification of the first embodiment of the present technology.

FIG. 29 is a block diagram illustrating a configuration example of an imaging system according to a second embodiment of the present technology.

FIG. 30 is a circuit diagram illustrating a configuration example of a pixel according to the second embodiment of the present technology.

FIG. 31 is a block diagram illustrating a configuration example of a load MOS circuit block and a column signal processing circuit according to the second embodiment of the present technology.

FIG. 32 is a block diagram illustrating a configuration example of a column circuit according to the second embodiment of the present technology.

FIG. 33 is a circuit diagram illustrating a configuration example of a selector, a differentiation circuit, and a comparison section according to the second embodiment of the present technology.

FIG. 34 is a diagram illustrating an example of operation of a data conversion section according to the second embodiment of the present technology.

FIG. 35 is a circuit diagram illustrating a configuration example of a region determination section according to the second embodiment of the present technology.

FIG. 36 is a timing chart illustrating an example of operation of the region determination section according to the second embodiment of the present technology.

FIG. 37 is a timing chart illustrating an example of first global shutter control of the solid-state imaging element according to the second embodiment of the present technology.

FIG. 38 is a timing chart illustrating an example of second global shutter control of the solid-state imaging element according to the second embodiment of the present technology.

FIG. 39 is a timing chart illustrating an example of operation at a time of region determination of the solid-state imaging element according to the second embodiment of the present technology.

FIG. 40 is a timing chart illustrating an example of a read operation of a solid-state imaging element according to the second embodiment of the present technology.

FIG. 41 is a diagram illustrating an example of states of pixels and selectors at a time of region determination and at a time of reading according to the second embodiment of the present technology.

FIG. 42 is a diagram illustrating an example of image data, difference data, and clipping data according to the second embodiment of the present technology.

FIG. 43 is a flowchart illustrating an example of operation of the solid-state imaging element according to the second embodiment of the present technology.

FIG. 44 is a block diagram illustrating a configuration example of an imaging system according to a first modification of the second embodiment of the present technology.

FIG. 45 is a diagram illustrating an example of image data and difference data according to a second modification of the second embodiment of the present technology.

FIG. 46 is a circuit diagram illustrating a configuration example of a pixel according to a third modification of the second embodiment of the present technology.

FIG. 47 is a timing chart illustrating an example of first global shutter control of a solid-state imaging element according to the third modification of the second embodiment of the present technology.

FIG. 48 is a timing chart illustrating an example of second global shutter control of the solid-state imaging element according to the third modification of the second embodiment of the present technology.

FIG. 49 is a timing chart illustrating an example of operation at a time of region determination of the solid-state imaging element according to the third modification of the second embodiment of the present technology.

FIG. 50 is a timing chart illustrating an example of a read operation of a solid-state imaging element according to the third modification of the second embodiment of the present technology.

FIG. 51 is a diagram illustrating an example of a stacked structure of a solid-state imaging element according to a fourth modification of the second embodiment of the present technology.

FIG. 52 is a circuit diagram illustrating a configuration example of a pixel according to the fourth modification of the second embodiment of the present technology.

FIG. 53 is a diagram illustrating an example of a stacked structure of a solid-state imaging element according to a fifth modification of the second embodiment of the present technology.

FIG. 54 is a circuit diagram illustrating a configuration example of a pixel according to a third embodiment of the present technology.

FIG. 55 is a timing chart illustrating an example of a global shutter operation according to the third embodiment of the present technology.

FIG. 56 is a circuit diagram illustrating a configuration example of a pixel according to a fourth embodiment of the present technology.

FIG. 57 is a timing chart illustrating an example of voltage control according to the fourth embodiment of the present technology.

FIG. 58 is a timing chart illustrating an example of a rolling shutter operation according to a fifth embodiment of the present technology.

FIG. 59 is a block diagram illustrating a configuration example of a solid-state imaging element according to a sixth embodiment of the present technology.

FIG. 60 is a circuit diagram illustrating a configuration example of a dummy pixel, a regulator, and a switching section according to the sixth embodiment of the present technology.

FIG. 61 is a timing chart illustrating an example of operation of the dummy pixel and the regulator according to the sixth embodiment of the present technology.

FIG. 62 is a circuit diagram illustrating a configuration example of an effective pixel according to the sixth embodiment of the present technology.

FIG. 63 is a block diagram illustrating a schematic configuration example of a vehicle control system.

FIG. 64 is an explanatory diagram illustrating an example of an installation position of an imaging section.

### MODE FOR CARRYING OUT THE INVENTION

Modes for carrying out the present technology (hereinafter, referred to as embodiments) will be described below. The description will be given in the following order.
1. First embodiment (example in which two sample and hold circuits generate combined signal)
2. Second embodiment (example in which differentiation circuit obtains difference in signal level)
3. Third embodiment (example of adding discharge transistor)
4. Fourth embodiment (example of controlling reset power supply voltage)
5. Fifth embodiment (example of performing rolling shutter operation)
6. Sixth embodiment (example of reduced noise)
7. Example of application to mobile object

### 1. First Embodiment

### [Configuration Example of Imaging System]

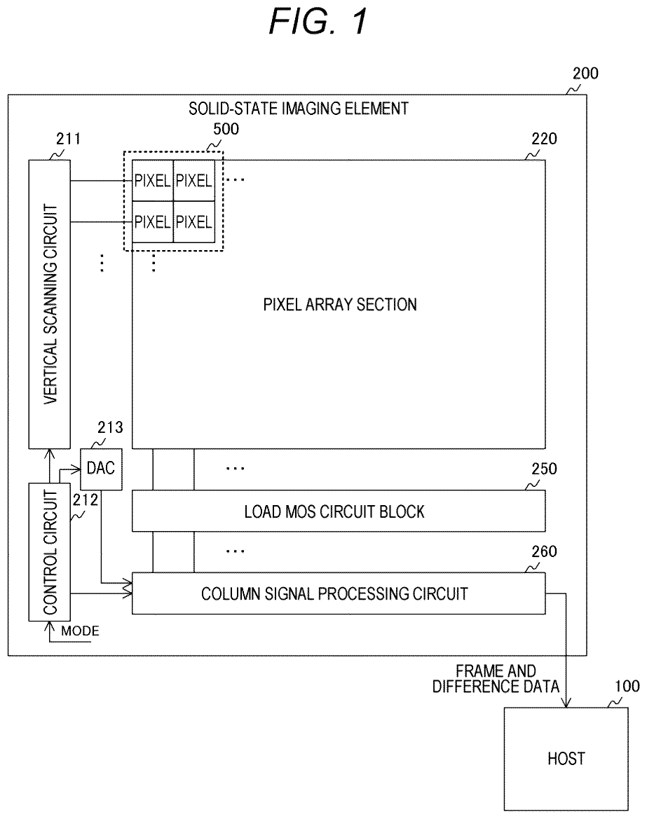

FIG. 1 is a block diagram illustrating a configuration example of an imaging system according to a first embodiment of the present technology. The imaging system includes a solid-state imaging element 200 and a host 100. The solid-state imaging element 200 includes a vertical scanning circuit 211, a control circuit 212, a digital to analog converter (DAC) 213, a pixel array section 220, a load MOS circuit block 250, and a column signal processing circuit 260.

In the pixel array section 220, a plurality of pixels is arranged in a two-dimensional lattice manner. Furthermore, the pixel array section 220 is divided into a plurality of pixel blocks 500. In each of the pixel blocks 500, a plurality of pixels (for example, four pixels of two rows×two columns) is arranged, and these pixels share some circuits.

The control circuit 212 controls the operation timing of each of the vertical scanning circuit 211, the DAC 213, and the column signal processing circuit 260 in synchronization with a vertical synchronization signal or the like.

The DAC 213 generates a sawtooth-shaped ramp signal by digital to analog (DA) conversion. The DAC 213 supplies the generated ramp signal to the column signal processing circuit 260.

The vertical scanning circuit 211 sequentially selects and drives rows of the pixel blocks 500 to output analog pixel signals. The pixels in the row supply the pixel signals to the column signal processing circuit 260 via the load MOS circuit block 250.

In the load MOS circuit block 250, a MOS transistor that supplies a constant current is provided for each column.

The column signal processing circuit 260 executes signal processing such as AD conversion processing and CDS processing on the pixel signal for each column of the pixel block 500.

Here, in the solid-state imaging element 200, one of a plurality of modes including an imaging mode and a difference output mode is set by the mode signal MODE.

The imaging mode is a mode in which the solid-state imaging element 200 continuously captures a plurality of pieces of image data (frames) and outputs each frame to the host 100. On the other hand, the difference output mode is a mode in which the solid-state imaging element 200 continuously captures a plurality of pieces of image data (frames) and outputs difference data that is a difference between two consecutive frames and each frame to the host 100.

The host 100 performs various types of processing on the difference data and the frame as necessary.

### [Configuration Example of Pixel Block]

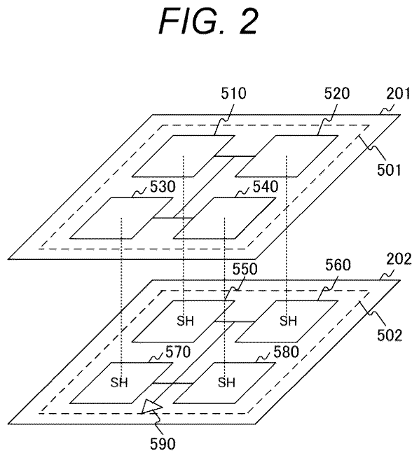

FIG. 2 is a diagram illustrating a configuration example of the pixel block 500 according to the first embodiment of the present technology. Here, it is assumed that circuits and elements in the solid-state imaging element 200 are dispersedly arranged on each of the stacked pixel chip 201 and circuit chip 202.

The pixel block 500 includes a pixel signal generating section 501 and a sample and hold block 502. Among them, the pixel signal generating section 501 is arranged on the pixel chip 201, and the sample and hold block 502 is arranged on the circuit chip 202. Furthermore, a circuit outside the pixel array section 220, such as the control circuit 212, is also arranged on the circuit chip 202.

The pixel signal generating section 501 includes pre-stage circuits 510, 520, 530, and 540. Furthermore, the sample and hold block 502 includes sample and hold circuits 550, 560, 570, and 580 and a post-stage circuit 590. These circuits function as four pixels. These four pixels share the post-stage circuit 590.

Note that, although the solid-state imaging element 200 has a stacked structure, the circuits and elements in the solid-state imaging element 200 can be arranged on a single semiconductor chip.

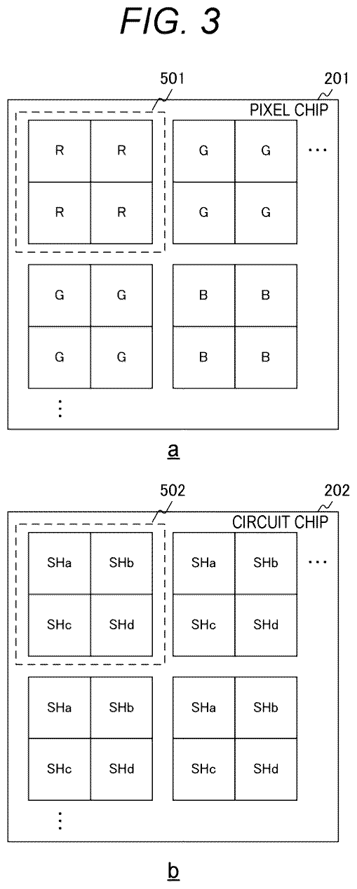

FIG. 3 is a diagram illustrating an example of a layout of color filters according to the first embodiment of the present technology. In the drawing, a illustrates an example of a layout of color filters in the pixel chip 201, and b in the drawing illustrates an example of a layout of sample and hold circuits in the circuit chip 202.

As illustrated in a of the drawing, a color filter of red (R), green (G), or blue (B) is provided for each pixel. Furthermore, color filters of the same color are arrayed in two rows×two columns, and groups of R or B and groups of G are alternately arrayed in a horizontal direction and a vertical direction. Such an array is referred to as a quad Bayer array. The above-described pixel signal generating section 501 is arranged immediately below the color filters of two rows×two columns of the same color.

Furthermore, as illustrated in b of the drawing, in the circuit chip 202, the sample and hold block 502 is arranged immediately below the four color filters of the same color. “SHa”, “SHb”, “SHc”, and “SHd” indicate sample and hold circuits 550, 560, 570, and 580 in the sample and hold block 502.

### [Configuration Example of Pixel Signal Generating Section]

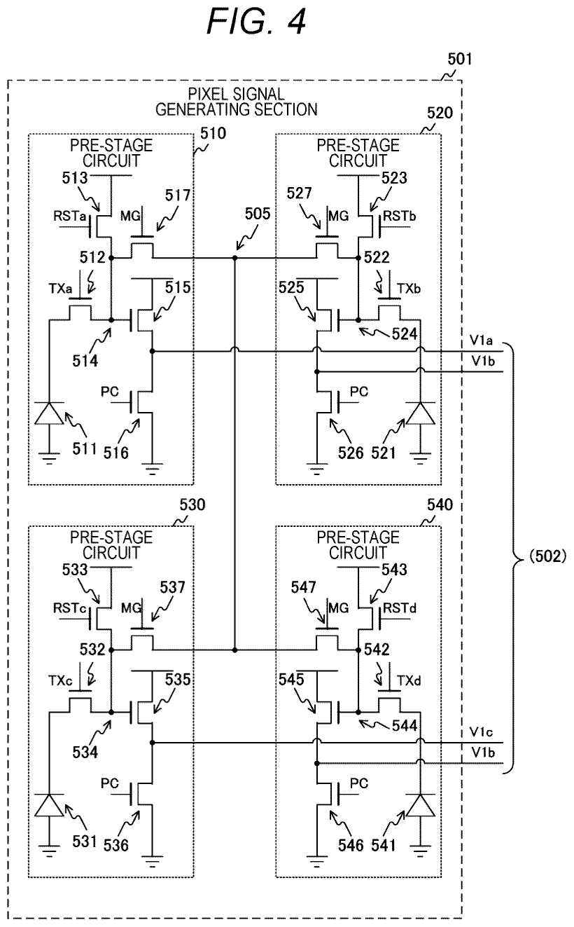

FIG. 4 is a circuit diagram illustrating a configuration example of the pixel signal generating section 501 according to the first embodiment of the present technology. The pre-stage circuit 510 includes a photoelectric conversion element 511, a transfer transistor 512, a floating diffusion (FD) reset transistor 513, an FD 514, a pre-stage amplification transistor 515, a precharge transistor 516, and a connection transistor 517.

The pre-stage circuit 520 includes a photoelectric conversion element 521, a transfer transistor 522, an FD reset transistor 523, an FD 524, a pre-stage amplification transistor 525, a precharge transistor 526, and a connection transistor 527. The pre-stage circuit 530 includes a photoelectric conversion element 531, a transfer transistor 532, an FD reset transistor 533, an FD 534, a pre-stage amplification transistor 535, a precharge transistor 536, and a connection transistor 537. The pre-stage circuit 540 includes a photoelectric conversion element 541, a transfer transistor 542, an FD reset transistor 543, an FD 544, a pre-stage amplification transistor 545, a precharge transistor 546, and a connection transistor 547.

In the pre-stage circuit 510, the photoelectric conversion element 511 generates a charge by photoelectric conversion. The transfer transistor 512 transfers the charges from the photoelectric conversion element 511 to the FD 514 in accordance with a transfer signal TXa received from the vertical scanning circuit 211.

The FD reset transistor 513 extracts and initializes a charge from the FD 514 in accordance with an FD reset signal RSTa from the vertical scanning circuit 211. The FD 514 accumulates charges, and generates a voltage corresponding to the amount of charges. The pre-stage amplification transistor 515 amplifies the voltage level of the FD 514 and outputs the amplified voltage as V1a to the sample and hold block 502.

Furthermore, the FD reset transistor 513 and the pre-stage amplification transistor 515 have their respective sources connected to a power supply voltage VDD. The precharge transistor 516 opens and closes a path between a drain of the pre-stage amplification transistor 515 and a ground node in accordance with a control signal PC from the vertical scanning circuit 211.

The connection transistor 517 connects the FD 514 to the common node 505 in accordance with a control signal MG from the vertical scanning circuit 211.

The circuit configuration of each of the pre-stage circuits 520, 530, and 540 is similar to that of the pre-stage circuit 510. However, transfer signals TXb, TXc, and TXd are supplied to the transfer transistors 522, 532, and 542, and FD reset signals RSTb, RSTc, and RSTd are supplied to the FD reset transistors 523, 533, and 543. Furthermore, V1b, V1c, and V1d are output from the pre-stage amplification transistors 525, 535, and 545 to the sample and hold block 502.

### [Configuration Example of Sample Hold Block]

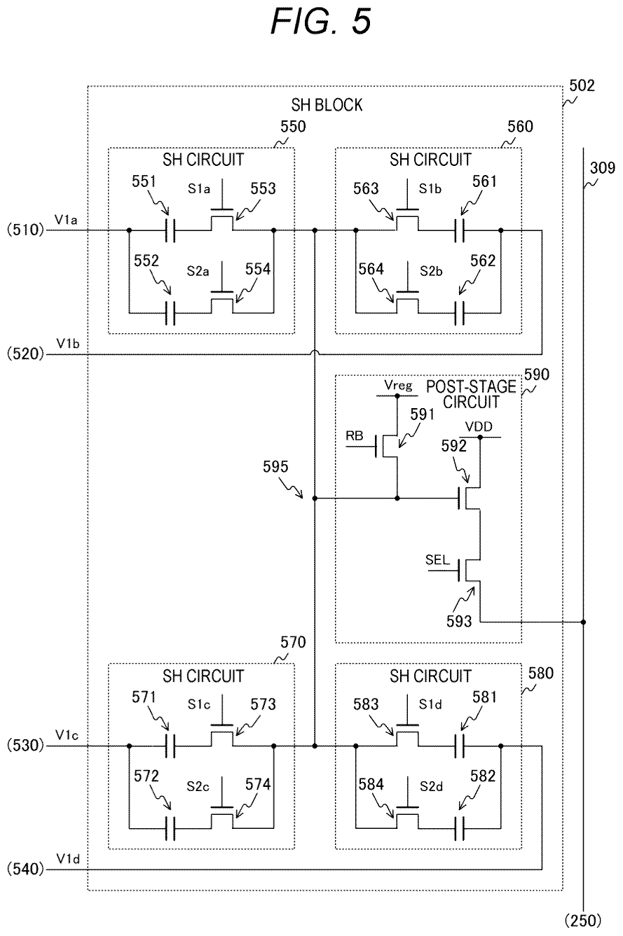

FIG. 5 is a circuit diagram illustrating a configuration example of the sample and hold block 502 according to the first embodiment of the present technology. The sample and hold circuit 550 includes capacitive elements 551 and 552 and selection transistors 553 and 554. The sample and hold circuit 560 includes capacitive elements 561 and 562 and selection transistors 563 and 564. The sample and hold circuit 570 includes capacitive elements 571 and 572 and selection transistors 573 and 574. The sample and hold circuit 580 includes capacitive elements 581 and 582 and selection transistors 583 and 584.

Furthermore, the post-stage circuit 590 includes a post-stage reset transistor 591, a post-stage amplification transistor 592, and a post-stage selection transistor 593.

In the sample and hold circuit 550, one end of each of the capacitive elements 551 and 552 is commonly connected to the pre-stage circuit 510. The selection transistor 553 opens and closes a path between the other end of the capacitive element 551 and a post-stage node 595 in accordance with a selection signal Sla from the vertical scanning circuit 211. The selection transistor 554 opens and closes a path between the other end of the capacitive element 552 and the post-stage node 595 in accordance with a selection signal S2a from the vertical scanning circuit 211.

The circuit configuration of each of the sample and hold circuits 560, 570, and 580 is similar to that of the sample and hold circuit 550. However, one end of each of the capacitive elements 561 and 562 is connected to the pre-stage circuit 520, and one end of each of the capacitive elements 571 and 572 is connected to the pre-stage circuit 530. One end of each of the capacitive elements 581 and 582 is connected to the pre-stage circuit 540. Furthermore, selection signals S1b and S2b are supplied to the sample and hold circuit 560, selection signals S1c and S2c are supplied to the sample and hold circuit 570, and selection signals S1d and S2d are supplied to the sample and hold circuit 580.

The post-stage reset transistor 591 initializes a level of the post-stage node 595 to a predetermined potential Vreg in accordance with a post-stage reset signal RB received from the vertical scanning circuit 211. A potential different from the power supply voltage VDD (a potential lower than VDD, for example) is set as the potential Vreg.

The post-stage amplification transistor 592 amplifies the level of the post-stage node 595. The post-stage selection transistor 593 outputs a signal indicating the level amplified by the post-stage amplification transistor 592 to a vertical signal line 309 as a pixel signal in accordance with a post-stage selection signal SEL received from the vertical scanning circuit 211.

### [Configuration Example of Column Signal Processing Circuit]

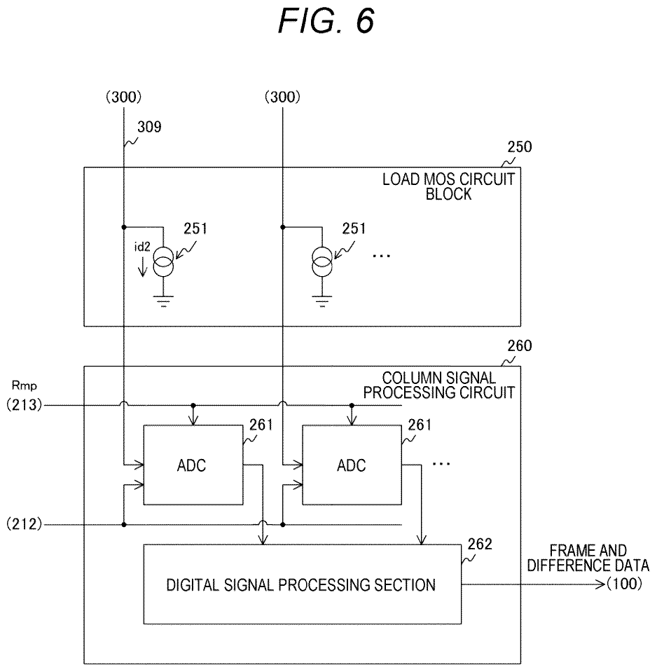

FIG. 6 is a block diagram illustrating a configuration example of the load MOS circuit block 250 and the column signal processing circuit 260 according to the first embodiment of the present technology.

In the load MOS circuit block 250, a vertical signal line 309 is wired for each column of the pixel blocks 500. Where the number of columns is I (I being an integer), I vertical signal lines 309 are wired. Furthermore, a load MOS transistor 251 that supplies a constant current id2 is connected to each of the vertical signal lines 309.

In the column signal processing circuit 260, a plurality of ADCs 261 and a digital signal processing section 262 are arranged. The ADC 261 is arranged for each column of the pixel blocks 500. If the number of columns is I, I ADCs 261 are arranged.

The ADC 261 converts an analog pixel signal from the corresponding column into a digital signal using a ramp signal Rmp from the DAC 213. The ADC 261 supplies the digital signal to the digital signal processing section 262. For example, a single-slope ADC including a comparator and a counter is arranged as the ADC 261.

The digital signal processing section 262 performs predetermined signal processing such as CDS processing on each of the digital signals for each column. The digital signal processing section 262 outputs image data (frame) or difference data including the processed digital signal to the host 100.

### [Operation Example of Solid-State Imaging Element]

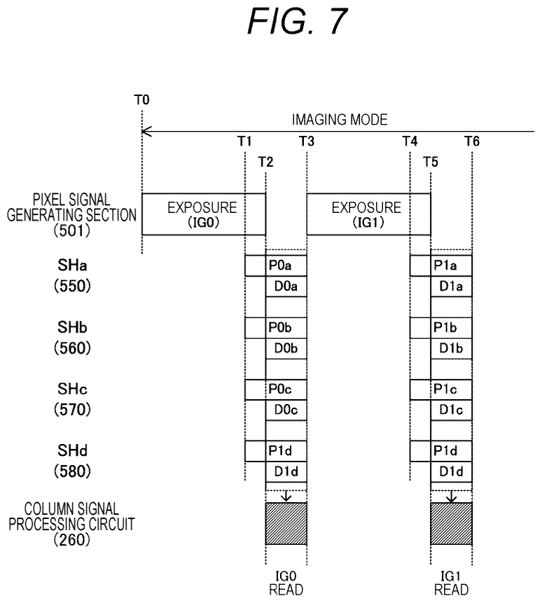

FIG. 7 is a timing chart illustrating an example of the operation of the solid-state imaging element 200 in the imaging mode according to the first embodiment of the present technology. It is assumed that the imaging mode is set at timing T0.

During the exposure period from timing T0 to timing T1, all the pixel signal generating sections 501 (in other words, all pixels) are exposed simultaneously, and image data (frame) IG0 is generated.

The sample and hold circuits 550, 560, 570, and 580 sample and hold reset levels P0a, P0b, P0c, and P1d, which are levels of pixel signals at the time of initialization, at timing T1 immediately before the exposure ends. Furthermore, the sample and hold circuits 550, 560, 570, and 580 sample and hold signal levels D0a, D0b, D0c, and D1d, which are levels of pixel signals according to the exposure amount, at timing T2 when the exposure ends.

During a read period from timing T2 to timing T3, the vertical scanning circuit 211 sequentially selects rows of the pixel block 500 and causes pixel signals (reset levels and signal levels) to be output. Furthermore, the column signal processing circuit 260 performs AD conversion on the pixel signals from the selected row, and performs CDS processing and the like. Thus, the first image data IG0 is read.

During the exposure period from timing T3 to timing T5, all the pixels are simultaneously exposed, and image data IG1 is generated.

The sample and hold circuits 550, 560, 570, and 580 sample and hold reset levels P1a, P1b, P1c, and P1d at timing T4 immediately before the end of the exposure. Furthermore, the sample and hold circuits 550, 560, 570, and 580 sample and hold signal levels D1a, D1b, D1c, and D1d at timing T5 when the exposure ends.

During a read period from timing T5 to timing T6, the vertical scanning circuit 211 sequentially selects rows of the pixel block 500 and causes pixel signals to be output. Furthermore, the column signal processing circuit 260 performs AD conversion on the pixel signals from the selected row, and performs CDS processing and the like. Thus, the second image data IG1 is read. Hereinafter, a plurality of pieces of image data is continuously generated by similar control.

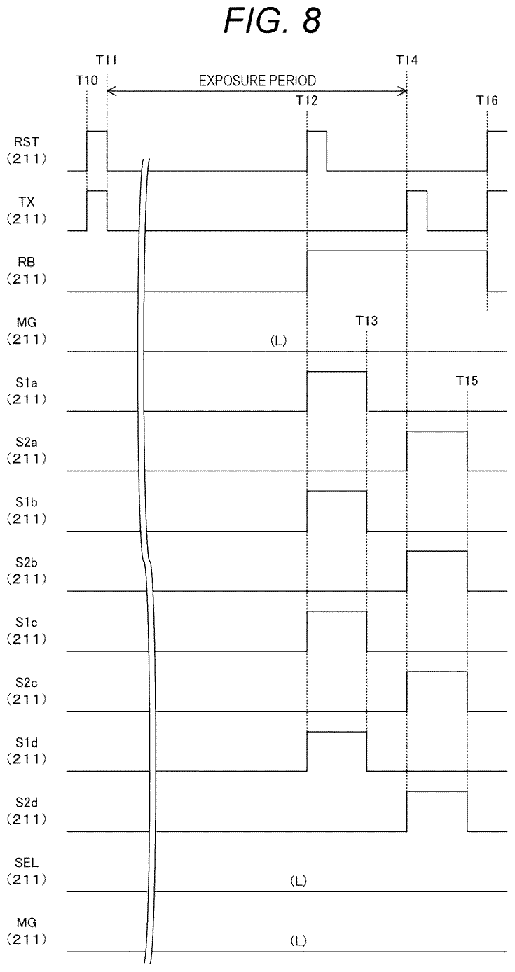

FIG. 8 is a timing chart illustrating an example of global shutter control in the imaging mode according to the first embodiment of the present technology. The vertical scanning circuit 211 supplies the high-level FD reset signal RST and the high-level transfer signal TX to all the rows (in other words, all the pixels) from timing T10 immediately before the start of exposure to timing T11 after the pulse period has elapsed. This process is hereinafter referred to as “PD reset”. By the PD reset of all the pixels, exposure is simultaneously started in all the rows.

Then, at timing T12 immediately before the end of the exposure period, the vertical scanning circuit 211 supplies the high-level FD reset signal RST over the pulse period while setting the post-stage reset signal RB to the high level in all the pixels. This process is hereinafter referred to as “FD reset”. Furthermore, the vertical scanning circuit 211 supplies the high-level selection signals Sla, S1b, S1c, and S1d to all the pixel blocks 500 during the period from timing T12 to timing T13. Thus, the reset level is sampled and held in all the pixels.

At timing T14 of the end of the exposure, the vertical scanning circuit 211 supplies the high-level transfer signal TX to all the pixels over the pulse period. Thus, a signal level is generated. Furthermore, the vertical scanning circuit 211 supplies the high-level selection signals S2a, S2b, S2c, and S2d to all the pixel blocks 500 during the period from timing T14 to timing T15. Thus, the signal level is sampled and held in all the pixels.

At timing T16 after timing T15, the vertical scanning circuit 211 sets the FD reset signal RST and the transfer signal TX to a high level and sets the post-stage reset signal RB to a low level.

Furthermore, in the imaging mode, the control signal MG is controlled to a low level. Thus, the FDs of the four pixels are separated, and the reset level and the signal level are generated and held for each pixel.

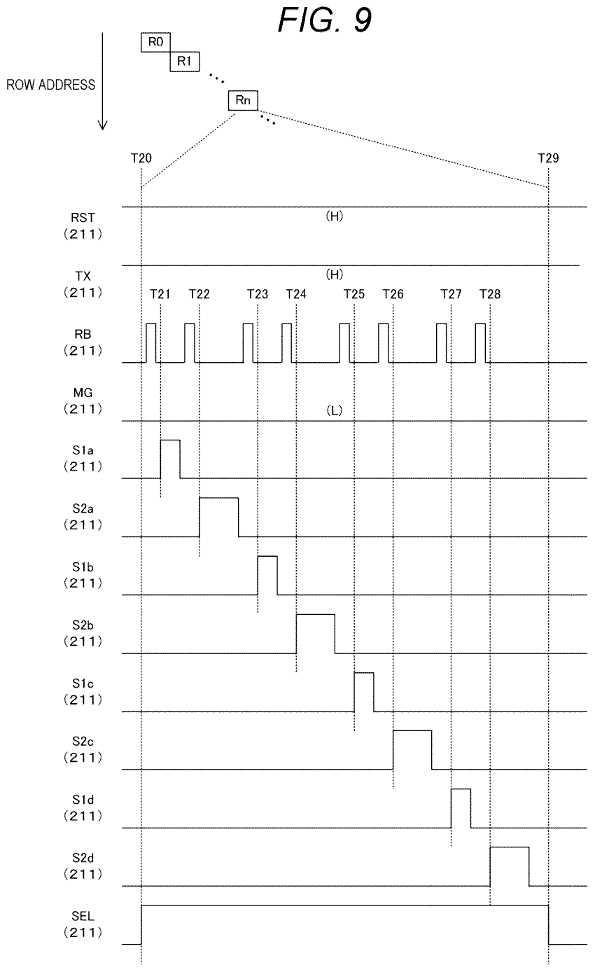

FIG. 9 is a timing chart illustrating an example of a read operation of the solid-state imaging element 200 in the imaging mode according to the first embodiment of the present technology. In the drawing, Rn indicates a read period of the pixel block 500 in the nth row. Here, n is an integer of 0 to N−1. During the read period of each row, the FD reset signal RST and the transfer signal TX are controlled to a high level.

In the read period of the nth row from timing T20 to timing T29, the vertical scanning circuit 211 sets the post-stage selection signal SEL of the nth row to a high level.

Furthermore, the vertical scanning circuit 211 supplies the high-level post-stage reset signal RB to the nth row over the pulse period immediately after timing T20. The vertical scanning circuit 211 supplies the high-level selection signal Sla to the nth row over a predetermined period from timing T21 immediately after that. Thus, the reset level of the upper left pixel in the pixel block 500 is read. The vertical scanning circuit 211 supplies the high-level post-stage reset signal RB to the nth row over the pulse period immediately after reading of the reset level. The vertical scanning circuit 211 supplies the high-level selection signal S2a to the nth row over a predetermined period from timing T22 immediately after that. Thus, the signal level of the upper left pixel in the pixel block 500 is read.

Then, by similar control of the post-stage reset signal RB and the selection signals S1b and S2b, the reset level and the signal level of the upper right pixel are read during a predetermined period from timing T23 and during a predetermined period from timing T24.

Under the control of the post-stage reset signal RB and the selection signals S1c and S2c, the reset level and the signal level of the lower left pixel are read during a predetermined period from timing T25 and during a predetermined period from timing T26.

Under the control of the post-stage reset signal RB and the selection signals S1d and S2d, the reset level and the signal level of the lower right pixel are read during a predetermined period from timing T27 and during a predetermined period from timing T28.

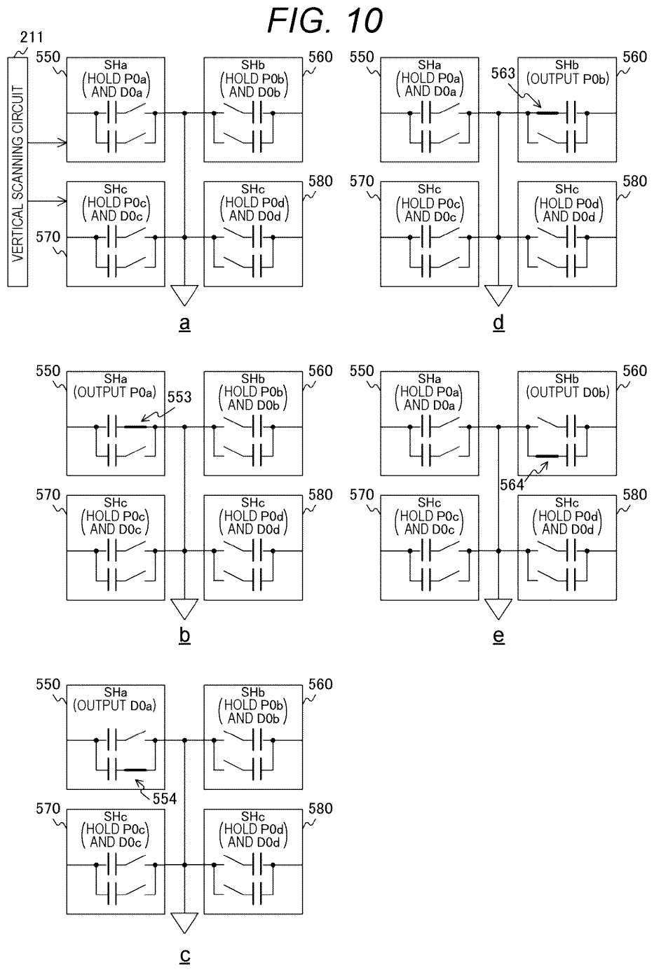

FIG. 10 is a diagram illustrating an example of a state of the sample and hold block 502 in the imaging mode according to the first embodiment of the present technology. In the drawing, the selection transistors 553, 554, 563, 564, 573, 574, 583, and 584 are represented by graphical symbols of switches.

In the drawing, a illustrates a state of the sample and hold block 502 immediately after the end of the exposure. All the selection transistors are controlled to the off state. In the drawing, b illustrates a state of the sample and hold block 502 during the read period of the reset level P0a of the upper left pixel in the nth row. The vertical scanning circuit 211 turns on only the selection transistor 553 and causes P0a to be output.

In the drawing, c illustrates a state of the sample and hold block 502 during the read period of the signal level D0a of the upper left pixel in the nth row. The vertical scanning circuit 211 turns on only the selection transistor 554 and causes D0a to be output.

In the drawing, d illustrates a state of the sample and hold block 502 during the read period of the reset level P0b of the upper right pixel of the nth row. The vertical scanning circuit 211 turns on only the selection transistor 563 and causes P0b to be output.

In the drawing, e indicates a state of the sample and hold block 502 during the read period of the signal level D0b of the upper right pixel of the nth row. The vertical scanning circuit 211 turns on only the selection transistor 564 and causes D0b to be output. Hereinafter, the reset level and the signal level of the lower left and lower right pixels are sequentially read by similar control. For the (n+1)th and subsequent rows, the pixel signals (reset levels and signal levels) of the four pixels are sequentially read by similar control.

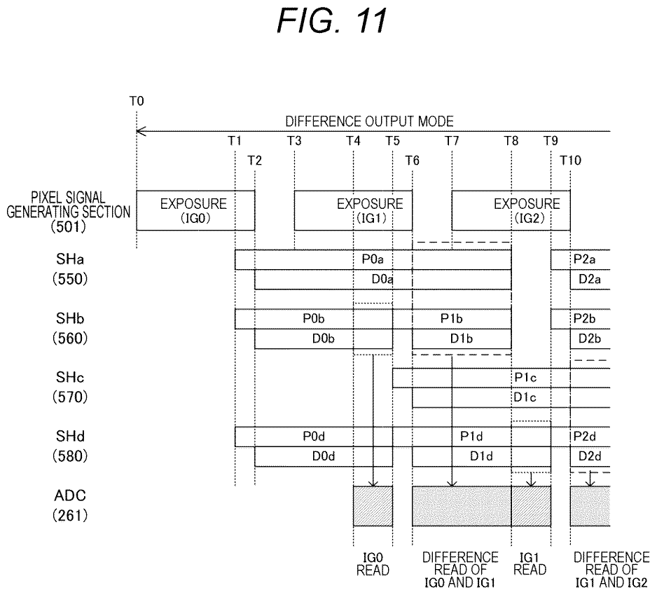

FIG. 11 is a timing chart illustrating an example of operation until exposure of IG2 of the solid-state imaging element 200 in the difference output mode according to the first embodiment of the present technology. It is assumed that the difference output mode is set at timing T0.

During the exposure period from timing T0 to timing T2, all the pixels are simultaneously exposed, and the first image data IG0 is generated.

The sample and hold circuits 550, 560, and 580 sample and hold the reset levels P0a, P0b, and Pod at timing T1 immediately before the end of the exposure. Furthermore, the sample and hold circuits 550, 560, and 580 sample and hold the signal levels D0a, D0b, and D0d at timing T2 when the exposure ends.

During the exposure period from timing T3 to timing T6, all the pixels are simultaneously exposed, and second image data IG1 is generated.

The sample and hold circuits 560, 570, and 580 sample and hold the reset levels P1b, P1c, and P1d at timing T5 immediately before the end of the exposure. Furthermore, the sample and hold circuits 560, 570, and 580 sample and hold the signal levels D1b, D1c, and D1d at timing T6 when the exposure ends.

During a read period from timing T4 to timing T5 in the second exposure period, the vertical scanning circuit 211 controls the sample and hold circuit 560 to output a pixel signal. The ADC 261 of each column reads the image data IG0.

Then, during the period from timing T6 to timing T8, the vertical scanning circuit 211 controls the sample and hold circuits 550 and 560 to output the difference data between the pieces of image data IG0 and IG1. The ADC 261 of each column reads the difference data.

Furthermore, during the exposure period from timing T7 to timing T10, all the pixels are simultaneously exposed, and the third image data (frame) IG2 is generated.

The sample and hold circuits 550, 560, and 580 sample and hold reset levels P2a, P2b, and P2d at timing T9 immediately before the end of the exposure. Furthermore, the sample and hold circuits 550, 560, and 580 sample and hold signal levels D2a, D2b, and D2d at timing T10 when the exposure ends.

During a read period from timing T8 to timing T9 in the third exposure period, the vertical scanning circuit 211 controls the sample and hold circuit 580 to output a pixel signal. The ADC 261 of each column reads the image data IG1.

Then, during the period after timing T10, the vertical scanning circuit 211 controls the sample and hold circuits 570 and 580 to output the difference data between the pieces of image data IG1 and IG2. The ADC 261 of each column reads the difference data.

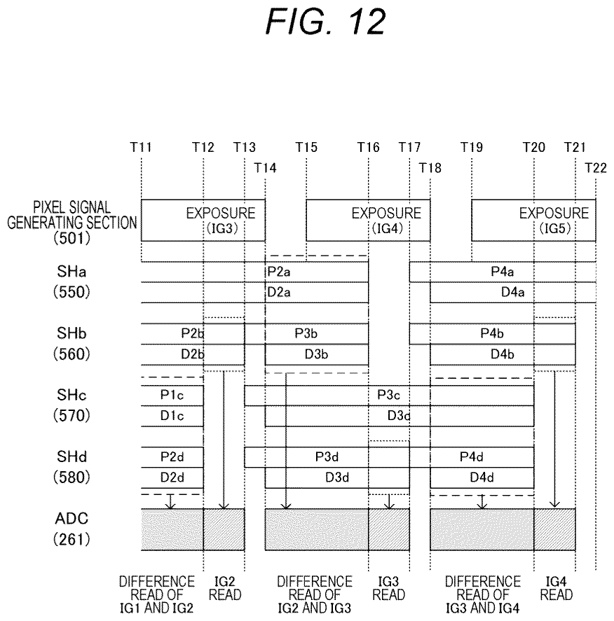

FIG. 12 is a timing chart illustrating an example of operation after exposure of IG3 of the solid-state imaging element 200 in the difference output mode according to the first embodiment of the present technology.

During the exposure period from timing T11 to timing T14, all the pixels are simultaneously exposed, and fourth image data IG3 is generated.

The sample and hold circuits 560, 570, and 580 sample and hold reset levels P3b, P3c, and P3d at timing T13 immediately before the end of the exposure. Furthermore, the sample and hold circuits 560, 570, and 580 sample and hold signal levels D3b, D3c, and D3d at timing T14 when the exposure ends.

During a read period from timing T12 to timing T13 in the fourth exposure period, the vertical scanning circuit 211 controls the sample and hold circuit 560 to output a pixel signal. The ADC 261 of each column reads the image data IG2.

Then, during the period from timing 14 to timing T16, the vertical scanning circuit 211 controls the sample and hold circuits 550 and 560 to output the difference data between the pieces of image data IG2 and IG3. The ADC 261 of each column reads the difference data.

Furthermore, during the exposure period from timing T15 to timing T18, all the pixels are simultaneously exposed, and the fifth image data IG4 is generated.

The sample and hold circuits 550, 560, and 580 sample and hold reset levels P4a, P4b, and P4d at timing T17 immediately before the end of the exposure. Furthermore, the sample and hold circuits 550, 560, and 580 sample and hold signal levels D4a, D4b, and D4d at timing T18 when the exposure ends.

During a read period from timing T16 to timing T17 in the fifth exposure period, the vertical scanning circuit 211 controls the sample and hold circuit 580 to output a pixel signal. The ADC 261 of each column reads the image data IG3.

Then, during the period from timing T18 to timing T20, the vertical scanning circuit 211 controls the sample and hold circuits 570 and 580 to output difference data between the pieces of image data IG3 and IG4. The ADC 261 of each column reads the difference data.

Furthermore, during the exposure period from timing T19 to timing T22, all the pixels are simultaneously exposed, and sixth image data IG5 is generated. During a read period from timing T20 to timing T21 in the exposure period, the vertical scanning circuit 211 controls the sample and hold circuit 560 to output a pixel signal. The ADC 261 of each column reads the image data IG4.

As illustrated in FIGS. 11 and 12, at the end of the exposure, three of the four sample and hold circuits in the pixel block 500 sample and hold the pixel signal of the current frame that is the current image data. The remaining one sample and hold circuit holds a pixel signal of a previous frame that is previous image data. Two of the three sample and hold circuits holding the current frame are used to generate difference data, and the remaining one is used to output the current frame. In this manner, the solid-state imaging element 200 can output the difference data and the frame to the host 100 each time the frame is imaged.

Note that although the solid-state imaging element 200 outputs the difference frame and the entire frame, it is also possible to output only a part of the frame in the second and subsequent frames. In this case, for example, the column signal processing circuit 260 or the like extracts, as a region of interest (ROI) region, a rectangular region including a region in which the absolute value of the difference is equal to or larger than a threshold in the difference frame. The control circuit 212 controls the vertical scanning circuit 211 and the column signal processing circuit 260 to output only the ROI region. Thus, only the ROI region can be read, and the reading speed can be made faster than the case of reading the entire frame.

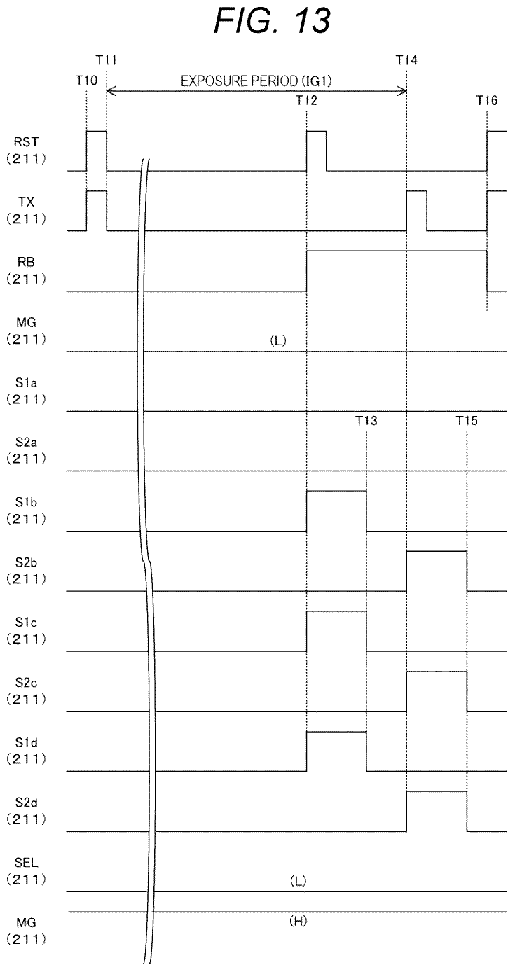

FIG. 13 is a timing chart illustrating an example of the global shutter control in the difference output mode according to the first embodiment of the present technology. The global shutter control in the difference output mode is similar to the control in the imaging mode illustrated in FIG. 8 except that the control signal MG is controlled to the high level and the pixel signal of the current frame is held in the three sample and hold circuits. For example, at the end of the exposure of the IG1, the selection signals Sla and S1b are controlled to the low level, and the pixel signal of the previous frame is held in the sample and hold circuit corresponding to these selection signals. The remaining three sample and hold circuits hold the pixel signal of the current frame.

Furthermore, the FDs of the four pixels are connected by the high-level control signal MG, and the pixel signals obtained by adding the respective signals of the four pixels are held in the FDs. By this pixel addition, the number of pixels in the difference output mode becomes ¼ of that in the imaging mode.

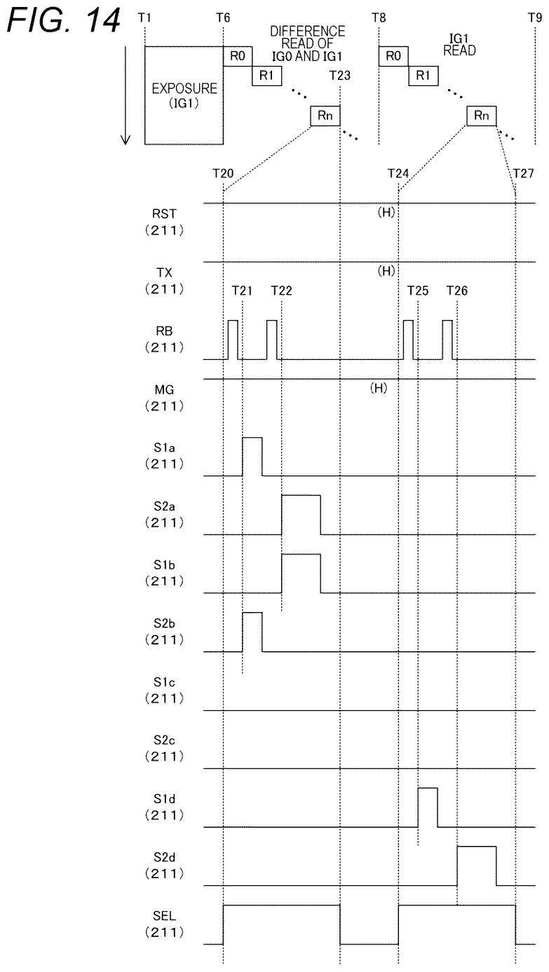

FIG. 14 is a timing chart illustrating an example of difference data between the IG0 and the IG1 and a read operation of the IG1 according to the first embodiment of the present technology. During the read period of each row, the FD reset signal RST and the transfer signal TX are controlled to a high level.

In the read period of the difference data of the nth row from timing T20 to timing T23, the vertical scanning circuit 211 sets the post-stage selection signal SEL of the nth row to the high level.

Furthermore, the vertical scanning circuit 211 supplies the high-level post-stage reset signal RB to the nth row over the pulse period immediately after timing T20. The vertical scanning circuit 211 supplies the high-level selection signals Sla and S2b to the nth row over a predetermined period from timing T21 immediately after that. Thus, a combined signal obtained by combining the reset level and the signal level is read. The vertical scanning circuit 211 supplies the high-level post-stage reset signal RB to the nth row over the pulse period immediately after the first reading of a mixed signal. The vertical scanning circuit 211 supplies the high-level selection signals S2a and S1b to the nth row over a predetermined period from timing T22 immediately after that. Thus, the combined signal of the signal level and the reset level is read. Difference data is obtained by CDS processing of these combined signals. The reason will be described later.

Furthermore, during the read period of the pixel signals of the nth row from timing T24 to timing T27, the vertical scanning circuit 211 sets the post-stage selection signal SEL of the nth row to the high level.

Furthermore, the vertical scanning circuit 211 supplies the high-level post-stage reset signal RB to the nth row over the pulse period immediately after timing T24. The vertical scanning circuit 211 supplies the high-level selection signal S1d to the nth row over a predetermined period from timing T25 immediately after that. Thus, the reset level of the current frame (IG1) is read. The vertical scanning circuit 211 supplies the high-level post-stage reset signal RB to the nth row over the pulse period immediately after reading of the reset level. The vertical scanning circuit 211 supplies the high-level selection signal S2d to the nth row over a predetermined period from timing T26 immediately after that. Thus, the signal level of the current frame (IG1) is read.

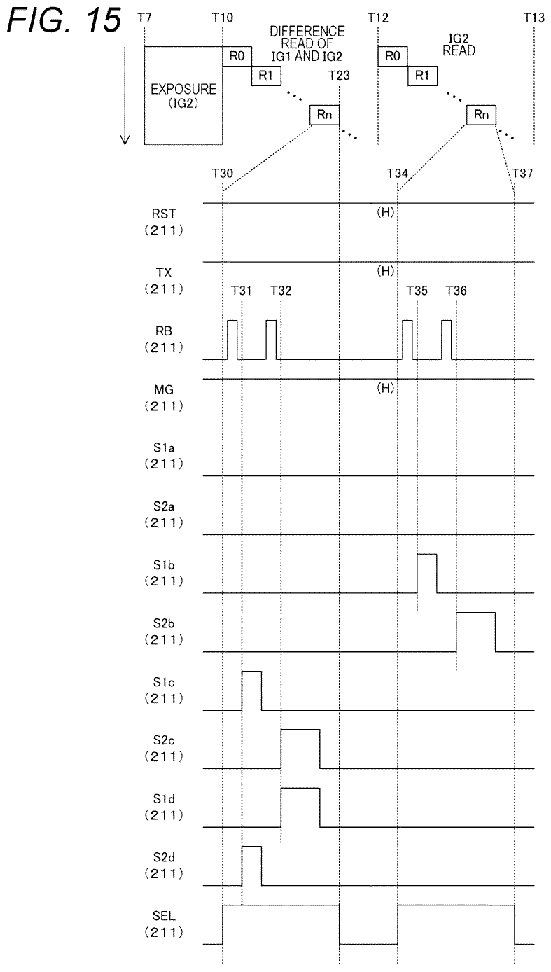

FIG. 15 is a timing chart illustrating an example of the difference data between the IG1 and the IG2 and the read operation of the IG2 according to the first embodiment of the present technology. After the reading of the difference data of the IG0 and the IG1 and the reading of the IG1, the difference data of the IG1 and the IG2 and the IG2 are read by control similar to that in FIG. 14.

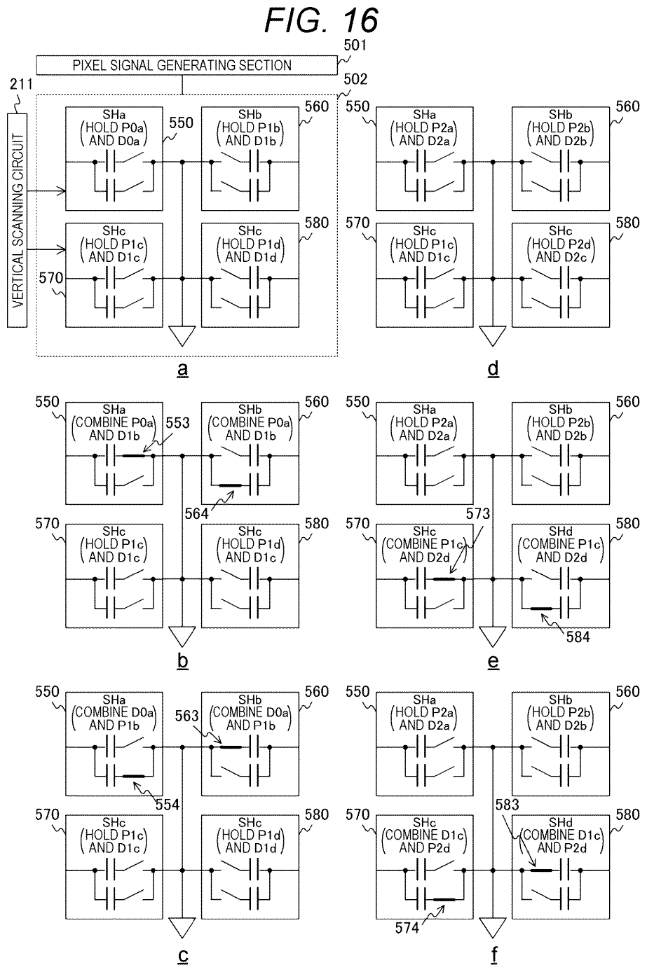

FIG. 16 is a diagram illustrating an example of a state of the sample and hold block 502 in the difference output mode according to the first embodiment of the present technology. In the drawing, a illustrates a state of the sample and hold block 502 immediately after the exposure of the IG1 ends. All the selection transistors are controlled to the off state. The sample and hold circuits 560, 570, and 580 hold reset levels P1b, P1c, and P1d of the current frame and signal levels D1b, D1c, and D1d. The remaining sample and hold circuit 550 holds the reset signal P0a and the signal level D0a of the previous frame.

In the drawing, b illustrates a state of the sample and hold block 502 at the time of reading the first combined signal after the exposure of the IG1 ends. The vertical scanning circuit 211 controls the selection transistors 553 and 564 to be turned on. Thus, a combined signal obtained by adding the reset level P0a of the previous frame and the signal level D1b of the current frame is generated. The combined signal MIX1 is expressed by the following Expression.

$$MIX 1 = P 0 a + D 1 b \qquad Expression 1$$

In the drawing, c illustrates a state of the sample and hold block 502 at the time of second reading of the combined signal after the exposure of the IG1 ends. The vertical scanning circuit 211 controls the selection transistors 554 and 563 to be turned on. Thus, a combined signal obtained by adding the signal level D0a of the previous frame and the reset level P1b of the current frame is generated. The combined signal MIX2 is expressed by the following Expression.

$$MIX 2 = D 0 a + P 1 b \qquad Expression 2$$

The column signal processing circuit 260 in the subsequent stage performs processing of currently performing the first combined signal to the second combined signal as CDS processing. A subtraction result C1 is expressed by the following Expression on the basis of Expressions 1 and 2.

$$C 1 = MIX 1 - MIX 2 \qquad Expression 3$$

When the right sides of Expressions 1 and 2 are substituted into Expression 3 and deformed, the following expression is obtained.

$$\begin{matrix}C 1 & = ( P 0 a + D 1 b ) - ( D 0 a + P 1 b ) \\ & = ( D 1 b - P 1 b ) - ( D 0 a - P 0 a )\end{matrix} \qquad Expression 4$$

“D1b−P1b” in Expression 4 indicates the pixel signal SIG1 after the CDS processing of the current frame. Furthermore, “D0a−P0a” indicates a pixel signal SIG0 after the CDS processing of the previous frame. Thus, the CDS processing result C1 of the first and second combined signals corresponds to a difference between pixel signals SIG1 and SIG0. The data in which C1 is arranged for each pixel block 500 corresponds to difference data between frames of the IG0 and the IG1.

After outputting the difference data, the vertical scanning circuit 211 controls the sample and hold circuit 580 to output the pixel signal of the current frame.

Here, a solid-state imaging element that obtains a difference between the signal level (D0a or the like) of the previous frame and the signal level (D1b or the like) of the current frame is assumed as a comparative example. In this comparative example, in a case where the reset level of the previous frame is different from the reset level of the current frame, noise of the difference data increases due to the difference in the reset level.

On the other hand, as illustrated in Expressions 1 and 2, in the solid-state imaging element 200 that outputs the combined signal of the signal level and the reset level, even if there is a difference in the reset level, the potential difference is removed from the difference data as illustrated in Expression 4. Thus, the noise of the difference data is reduced as compared with the comparative example, and the image quality thereof can be improved.

In the drawing, d illustrates a state of the sample and hold block 502 immediately after the exposure of the IG2 is completed. The sample and hold circuits 550, 560, and 580 hold the reset levels P2a, P2b, and P2d and the signal levels D2a, D2b, and D2d of the current frame. The remaining sample and hold circuit 570 holds the reset signal P1c and the signal level D1c of the previous frame.

In the drawing, e illustrates the state of the sample and hold block 502 at the time of reading the first combined signal after the exposure of the IG2 ends. The vertical scanning circuit 211 controls the selection transistors 573 and 584 to be turned on. Thus, a combined signal obtained by adding the reset level P1c of the previous frame and the signal level D2d of the current frame is generated.

In the drawing, f illustrates a state of the sample and hold block 502 at the time of second reading of the combined signal after the exposure of the IG2 ends. The vertical scanning circuit 211 controls the selection transistors 574 and 583 to be turned on. Thus, a combined signal obtained by adding the signal level D1c of the previous frame and the reset level P2d of the current frame is generated.

By the CDS processing of these combined signals, difference data between the frames of the IG1 and the IG2 is obtained.

In summary, the pixel signal generating section 501 sequentially generates pixel signals such as IG0, IG1, and IG2. As illustrated in a of the drawing, the sample and hold circuit 550 holds the pixel signal of the IG0 that is the previous frame, and the sample and hold circuits 560, 570, and 580 hold the pixel signal of the current frame IG1.

Then, as illustrated in b and c of the drawing, the vertical scanning circuit 211 controls the sample and hold circuits 550 and 560 to generate a combined signal of the pixel signal of the IG0 and the pixel signal of the IG1. At that time, the vertical scanning circuit 211 generates a combined signal obtained by adding the reset level P0a and the signal level D1b, and then generates a combined signal obtained by adding the signal level D0a and the reset level P1b.

After outputting the difference data, the vertical scanning circuit 211 controls the sample and hold circuit 580 to output the pixel signal of the current frame IG1.

Subsequently, as illustrated in d of the drawing, the sample and hold circuit 570 holds the pixel signal of the previous frame IG1, and the sample and hold circuits 550, 560, and 580 hold the pixel signal of the IG2 that is the current frame.

Then, as illustrated in e and f in the drawing, the vertical scanning circuit 211 controls the sample and hold circuits 570 and 580 to generate a combined signal of the pixel signal of the IG1 and the pixel signal of the IG2. After outputting the difference data, the vertical scanning circuit 211 controls the sample and hold circuit 560 to output the pixel signal of the current frame (IG2).

Note that the sample and hold circuits 550, 560, 570, and 580 are examples of first, second, third, and fourth sample and hold circuits described in the claims. The pixel signals IG0, IG1, and IG2 are examples of first, second, and third pixel signals described in the claims. The reset level P0a and the signal level D0a are examples of a first reset level and a first signal level described in the claims. The reset level P1a and the signal level D1a are examples of a second reset level and a second signal level described in the claims.

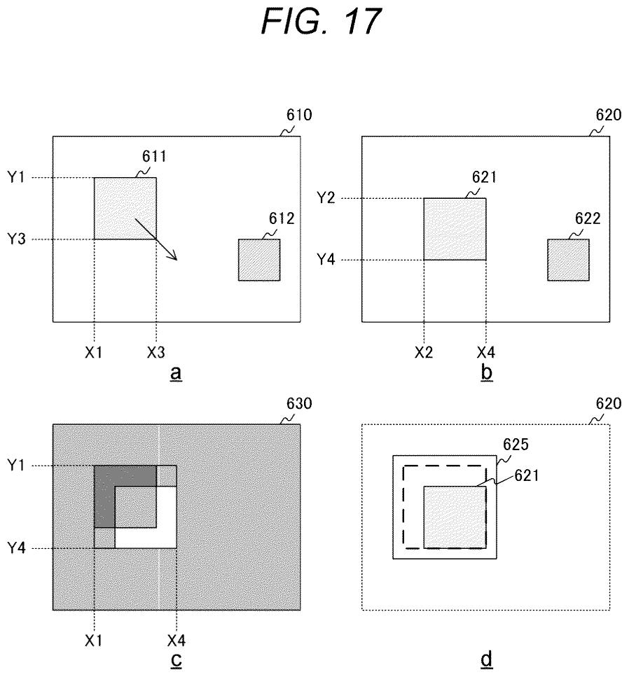

FIG. 17 is a diagram illustrating an example of image data, difference data, and clipping data according to the first embodiment of the present technology. In the drawing, a indicates an example of the image data 610, and b indicates an example of the image data 620 generated next to the image data 610.

The image data 610 includes subjects 611 and 612, and the image data 620 includes subjects 621 and 622. The subjects 611 and 621 are the same mobile object and have different positions in the respective pieces of image data. For example, the subject 611 is located in a region having coordinates (X1, Y1), (X1, Y3), (X3, Y1), and (X3, Y3) as vertices, and the subject 621 is located in a region having coordinates (X2, Y2), (X2, Y4), (X4, Y2), and (X4, Y4) as vertices.

On the other hand, the subjects 612 and 622 are the same stationary object and have the same position.

Furthermore, c in the drawing illustrates an example of the difference data 630. Since the positions of the subjects 612 and 622 do not change, the absolute value of the difference is less than the threshold in the region corresponding to the subjects.

On the other hand, since the positions of the subjects 611 and 621 are different, the absolute value of the difference exceeds the threshold in the region having the coordinates (X1, Y1), (X1, Y4), (X4, Y1), and (X4, Y4) as vertices.

For example, the solid-state imaging element 200 outputs the difference data 630, and then outputs the image data 620.

Note that, after outputting the difference data 630, the solid-state imaging element 200 can also output, as the ROI region, a rectangular region including a region where the difference absolute value exceeds the threshold. In this case, as illustrated in d of the drawing, the clipping data 625 obtained by clipping the ROI region from the image data 620 is output. A rough one-dot chain line indicates a region where the difference exceeds the threshold.

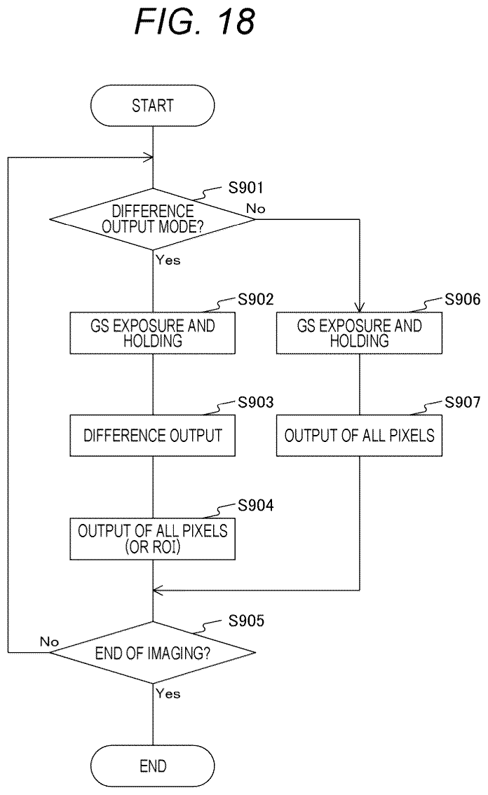

FIG. 18 is a flowchart illustrating an example of operation of the solid-state imaging element 200 according to the first embodiment of the present technology. This operation is started, for example, when a predetermined application for capturing image data is executed.

The solid-state imaging element 200 determines whether or not the set mode is the difference output mode (step S901). In a case of the difference output mode (step S901: Yes), the solid-state imaging element 200 exposes all the pixels by the global shutter method, and holds the pixel signal for each sample and hold circuit (step S902). Then, the solid-state imaging element 200 outputs the difference data (step S903), and outputs the pixel signals of all the pixels or the ROI region (step S904).

In a case of the imaging mode (step S901: No), the solid-state imaging element 200 exposes all the pixels by the global shutter method, and holds the pixel signal for each pixel (step S906). Then, the solid-state imaging element 200 outputs the pixel signals of all the pixels (step S907).

After step S904 or S907, the solid-state imaging element 200 determines whether or not end of imaging has been instructed by the host 100 (step S905). In a case where end of imaging has been instructed (step S905: Yes), the solid-state imaging element 200 terminates the operation for imaging. On the other hand, in a case where end of imaging has not been instructed (step S905: No), the solid-state imaging element 200 repeatedly executes step S901 and the subsequent steps.

As described above, according to the first embodiment of the present technology, since the vertical scanning circuit 211 controls the two sample and hold circuits to generate the combined signal, it is possible to reduce noise of difference data and improve image quality.

### [First Modification]

In the first embodiment described above, the sample and hold circuit that outputs the current frame is changed for each frame but may be fixed. A solid-state imaging element 200 according to a first modification of the first embodiment is different from that of the first embodiment in that a sample and hold circuit that outputs a current frame is fixed.

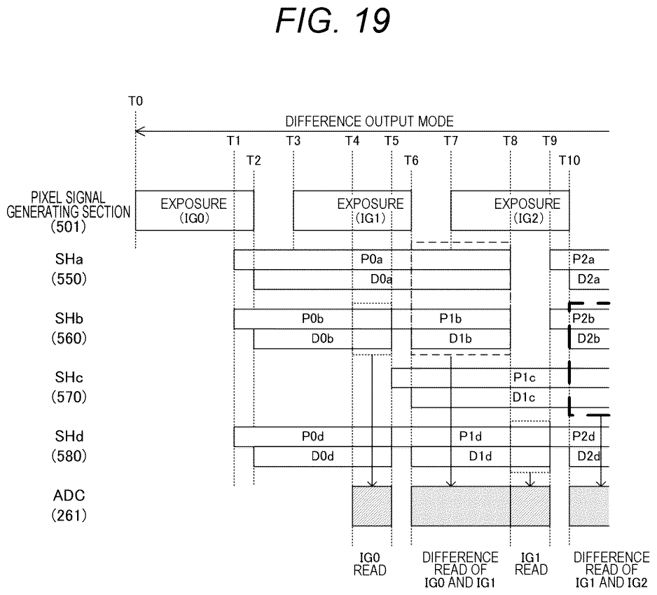

FIG. 19 is a timing chart illustrating an example of operation until exposure of the IG2 of the solid-state imaging element in the difference output mode according to the first modification of the first embodiment of the present technology. The operation of the first modification of the first embodiment is different from that of the first embodiment in that the vertical scanning circuit 211 controls the sample and hold circuits 560 and 570 to output the difference data between the pieces of image data IG1 and IG2 during the period after timing T10.

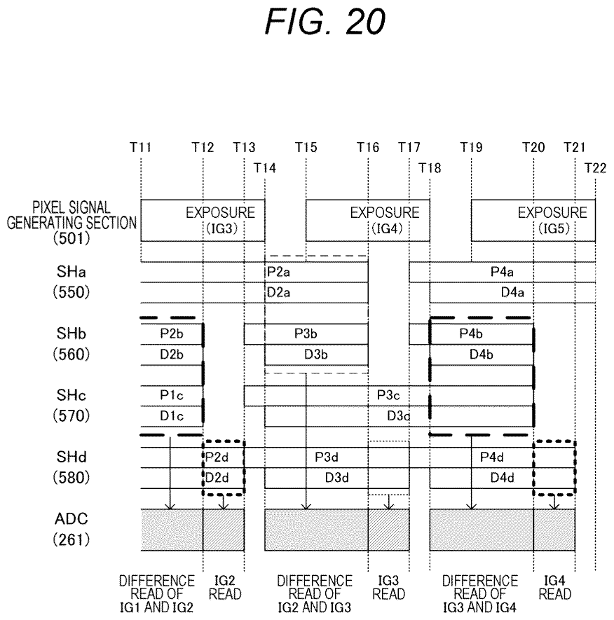

FIG. 20 is a timing chart illustrating an example of operation after exposure of the IG3 of the solid-state imaging element in the difference output mode according to the first modification of the first embodiment of the present technology. Differences from the first embodiment will be described.

During a read period from timing T12 to timing T13, the vertical scanning circuit 211 controls the sample and hold circuit 580 to output a pixel signal.

Furthermore, during the period from timing T18 to timing T20, the vertical scanning circuit 211 controls the sample and hold circuits 560 and 570 to output the difference data between the pieces of image data IG3 and IG4.

Then, during the read period from timing T20 to timing T21, the vertical scanning circuit 211 controls the sample and hold circuit 580 to output the pixel signal.

As illustrated in FIGS. 19 and 20, the vertical scanning circuit 211 alternately performs control to cause the sample and hold circuits 550 and 560 to generate a combined signal and control to cause the sample and hold circuits 560 and 570 to generate a combined signal. Thus, the current frame can be output by controlling the sample and hold circuit 580 for each frame. That is, the sample and hold circuit that outputs the current frame can be fixed.

As described above, according to the first modification of the first embodiment of the present technology, the vertical scanning circuit 211 alternately performs control to cause the sample and hold circuits 550 and 560 to generate a combined signal and control to cause the sample and hold circuits 560 and 570 to generate a combined signal. Thus, the sample and hold circuit that outputs the current frame can be fixed.

### [Second Modification]

In the first embodiment described above, the sample and hold circuit is disposed for each pixel, but it is preferable to further reduce the circuit scale of the pixel chip 201. A solid-state imaging element 200 according to a second modification of the first embodiment is different from that in the first embodiment in that the circuit scale of the pixel chip 201 is reduced.

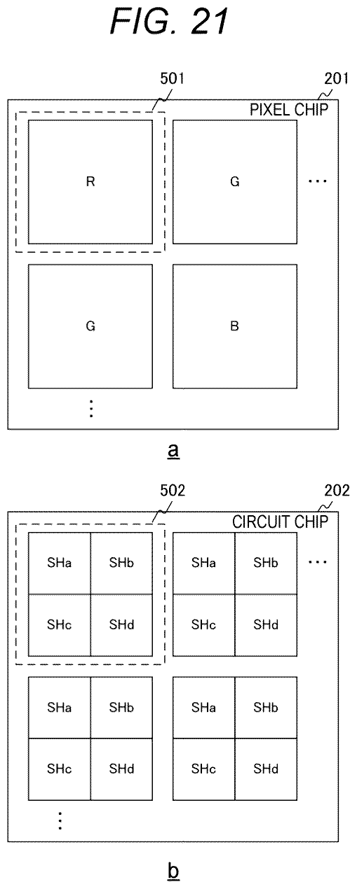

FIG. 21 is a diagram illustrating an example of a layout of a color filter according to a second modification of the first embodiment of the present technology. In the drawing, a illustrates an example of a layout of color filters in the pixel chip 201, and b in the drawing illustrates an example of a layout of sample and hold circuits in the circuit chip 202.

As illustrated in a of the drawing, in the second modification of the first embodiment, R, G, and B color filters are arranged in a Bayer array. The pixel signal generating section 501 is arranged immediately below one color filter.

Furthermore, as illustrated in b of the drawing, in the circuit chip 202, four hold circuits (SHa, SHb, SHc, and SHd) are arranged immediately below one color filter.

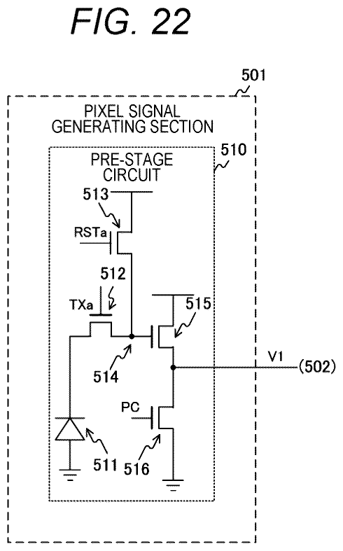

FIG. 22 is a circuit diagram illustrating a configuration example of the pixel signal generating section 501 according to the second modification of the first embodiment of the present technology. The pixel signal generating section 501 of the second modification of the first embodiment is different from that of the first embodiment in that only the pre-stage circuit 510 is arranged. Furthermore, in the pre-stage circuit 510, the connection transistor 517 is reduced.

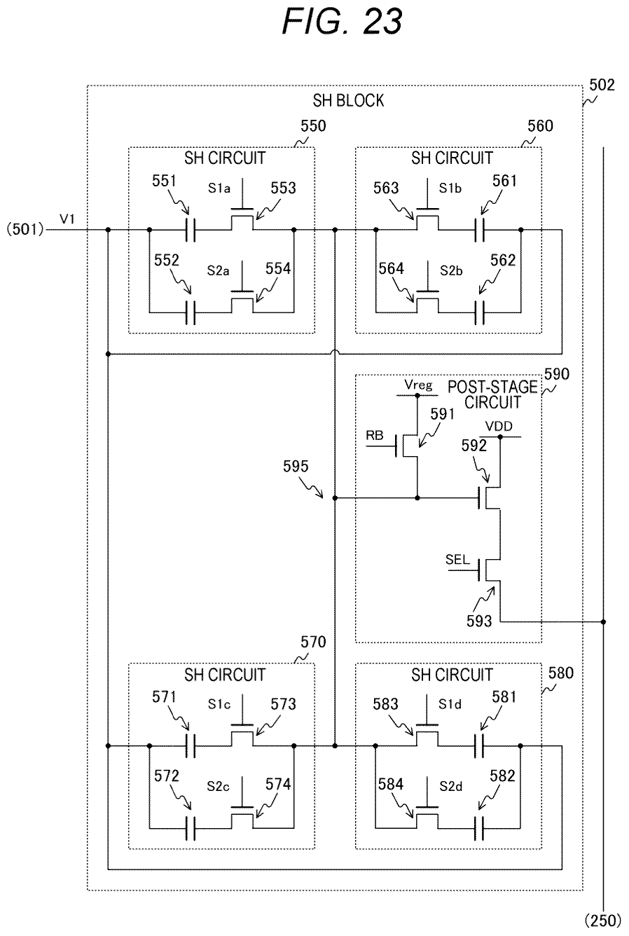

FIG. 23 is a circuit diagram illustrating a configuration example of the sample and hold block 502 according to the second modification of the first embodiment of the present technology. The sample and hold block 502 of the second modification of the first embodiment is different from that of the first embodiment in that one end of each of the capacitive elements 551, 552, 561, 562, 571, 572, 581, and 582 is commonly connected to the pixel signal generating section 501.

A circuit including the pixel signal generating section 501 in FIG. 22 and the sample and hold block 502 in FIG. 23 functions as one pixel.

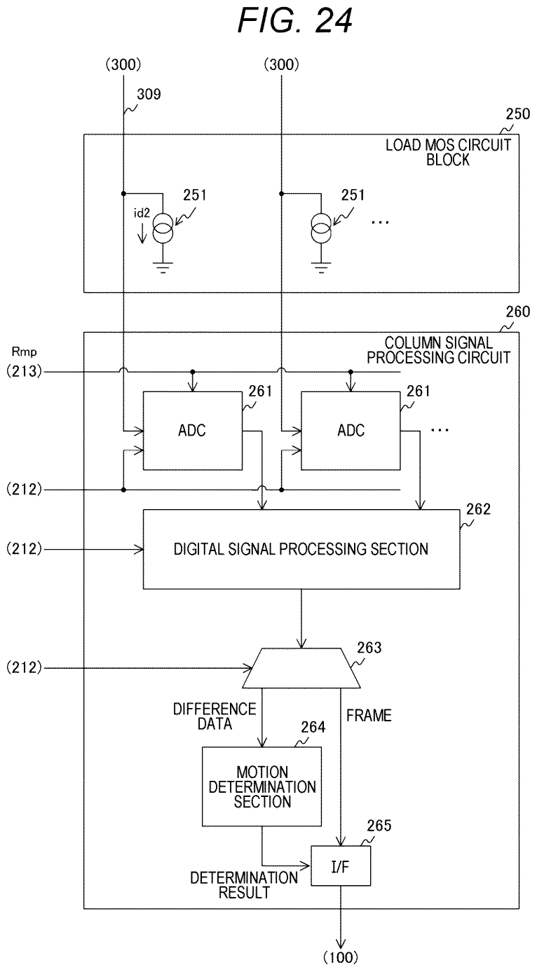

As illustrated in FIGS. 23 and 24, by arranging four sample and hold circuits for each pixel, three pre-stage circuits in the pixel signal generating section 501 can be reduced, and the circuit scale of the pixel chip 201 can be reduced. Furthermore, when the chip area is constant, the light receiving area for each pixel can be increased.

Note that the first modification of the first embodiment can be applied to the second modification of the first embodiment.

As described above, according to the second modification of the first embodiment of the present technology, since the four sample and hold circuits are arranged for each pixel, the circuit scale of the pixel chip 201 can be reduced.

### [Third Modification]

In the first embodiment described above, the solid-state imaging element 200 outputs all the frames to the host 100, but it is preferable to further reduce the processing amount and the communication amount of the host 100. A solid-state imaging element 200 according to a third modification of the first embodiment is different from that of the first embodiment in that the solid-state imaging element 200 outputs a frame in a case where the motion is made.

FIG. 24 is a block diagram illustrating a configuration example of a column signal processing circuit 260 according to a third modification of the first embodiment of the present technology. The column signal processing circuit 260 of the third modification of the first embodiment is different from that of the first embodiment in further including a selector 263, a motion determination section 264, and a communication interface 265.

The selector 263 supplies difference data to the motion determination section 264 and supplies a frame to the communication interface 265 under the control of the control circuit 212.

The motion determination section 264 determines the presence or absence of motion of a subject on the basis of the difference data. For example, the motion determination section 264 calculates a difference between the pixel signal of the previous frame and the pixel signal of the current frame for each pixel, and determines whether or not an absolute value of the difference exceeds a predetermined threshold for each pixel. Then, in a case where the number of pixels whose difference absolute values exceed the threshold is larger than a predetermined number, the motion determination section 264 determines that there is motion in the subject. The motion determination section 264 supplies the determination result to the communication interface 265.

The communication interface 265 outputs a frame to the host 100 in a case where it is determined that there is motion. On the other hand, in a case where it is determined that there is no motion, the communication interface 265 outputs invalid NULL data to the host 100. Note that the communication interface 265 is an example of an interface described in the claims.

Furthermore, in the third modification of the first embodiment, the column signal processing circuit 260 does not output the difference data to the host 100.

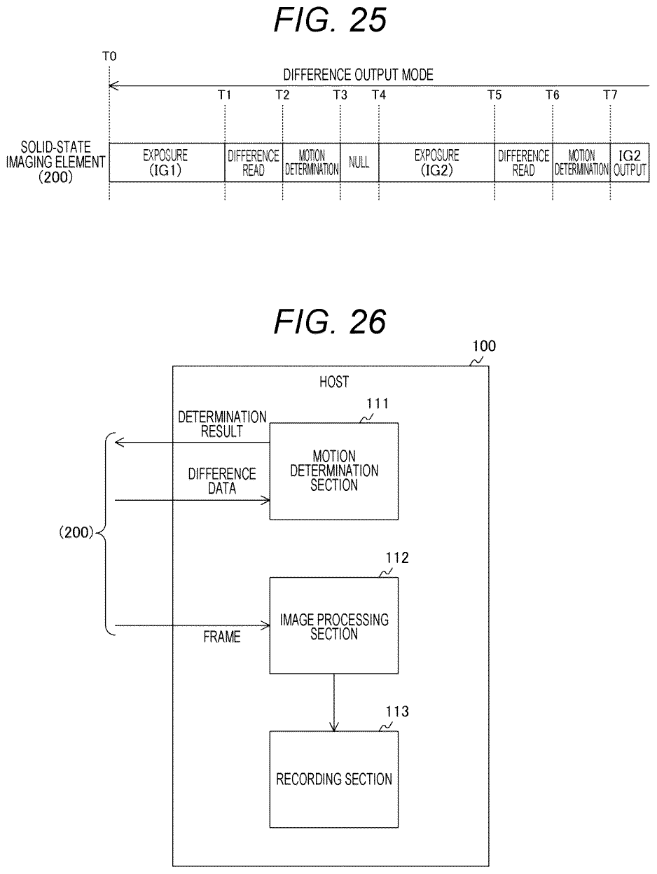

FIG. 25 is a timing chart illustrating an example of operation of the solid-state imaging element in the difference output mode according to the third modification of the first embodiment of the present technology. It is assumed that the difference output mode is set at timing T0.

During the exposure period from timing T0 to timing T1, all the pixels are simultaneously exposed, and the image data (frame) IG1 is generated. The solid-state imaging element 200 reads difference data between the IG1 and the previous frame during the period from timing 1 to T2, and determines the presence or absence of motion during the period from timing T2 to timing T3. At this time, it is assumed that it is determined that there is no motion. In this case, the solid-state imaging element 200 outputs NULL data to the host 100 during the period from timing T3 to timing T4. Note that the read difference data is not output to the host 100.

Then, during the exposure period from timing T4 to timing T5, all the pixels are simultaneously exposed, and IG2 that is the next frame is generated. The solid-state imaging element 200 reads difference data between the IG1 and the IG2 during the period from timing 5 to timing T6, and determines the presence or absence of motion during the period from timing T6 to timing T7. At this time, it is assumed that it is determined that the motion is made. In this case, the solid-state imaging element 200 outputs the IG2 that is the current frame to the host 100 during the period after timing T7.

As illustrated in the drawing, since the frame is output only in a case where there is motion, the host 100 does not need to process the frame during the period in which there is no motion. Thus, the processing amount of the host 100 can be reduced. Furthermore, since the solid-state imaging element 200 does not output the difference data to the host 100, the amount of communication with the host 100 can be reduced accordingly.

Note that the first and second modifications of the first embodiment can be applied to the third modification of the first embodiment.

As described above, according to the third modification of the first embodiment of the present technology, since the solid-state imaging element 200 determines the presence or absence of motion and outputs a frame in a case where there is motion, the processing amount and the communication amount of the host 100 can be reduced.

### [Fourth Modification]

In the third modification of the first embodiment described above, the solid-state imaging element 200 determines the presence or absence of motion, but this determination processing can also be performed by the host 100. A fourth modification of the first embodiment is different from the third modification of the first embodiment in that the host 100 determines the presence or absence of motion.

FIG. 26 is a block diagram illustrating a configuration example of the host 100 according to the fourth modification of the first embodiment of the present technology. The host 100 includes a motion determination section 111, an image processing section 112, and a recording section 113.

The column signal processing circuit 260 in the solid-state imaging element 200 of the fourth modification of the first embodiment outputs difference data to the host 100.

The motion determination section 111 determines the presence or absence of motion of the subject on the basis of the difference data. The motion determination section 111 supplies a determination result to the solid-state imaging element 200.

The column signal processing circuit 260 in the solid-state imaging element 200 of the fourth modification of the first embodiment receives the determination result, and outputs a frame to the host 100 in a case where it is determined that the motion is made. On the other hand, in a case where it is determined that there is no motion, the column signal processing circuit 260 outputs NULL data to the host 100.

The image processing section 112 in the host 100 performs various types of image processing on a frame. The image processing section 112 supplies the processed frame to the recording section 113. The recording section 113 records frames.

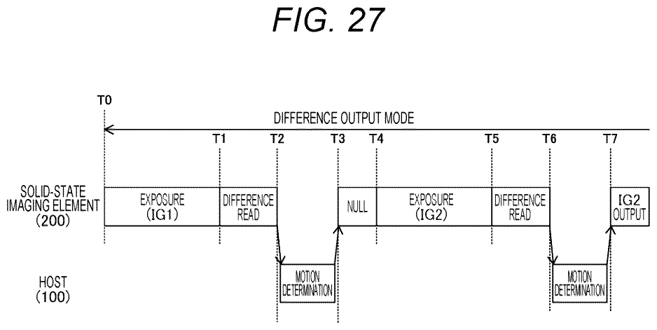

FIG. 27 is a timing chart illustrating an example of the operation of the solid-state imaging element in the difference output mode according to the fourth modification of the first embodiment of the present technology. It is assumed that the difference output mode is set at timing T0.

During the exposure period from timing T0 to timing T1, all the pixels are simultaneously exposed, and the image data (frame) IG1 is generated. During the period from timing T1 to timing T2, the solid-state imaging element 200 reads difference data between the IG1 and the previous frame, and outputs the difference data to the host 100.

During the period from timing T2 to timing T3, the host 100 determines the presence or absence of motion on the basis of the difference data. At this time, it is assumed that it is determined that there is no motion. The host 100 supplies the determination result to the solid-state imaging element 200. The solid-state imaging element 200 outputs NULL data to the host 100 during the period from timing T3 to timing T4.

Then, during the exposure period from timing T4 to timing T5, all the pixels are simultaneously exposed, and IG2 that is the next frame is generated. During a period from timing 5 to T6, the solid-state imaging element 200 reads difference data between the IG1 and the IG2, and outputs the difference data to the host 100.

During a period from timing T6 to timing T7, the host 100 determines the presence or absence of motion. At this time, it is assumed that it is determined that the motion is made. The host 100 supplies the determination result to the solid-state imaging element 200. The solid-state imaging element 200 outputs the IG2 that is the current frame to the host 100 during the period after timing T7.

Note that, in a case where there is motion, the solid-state imaging element 200 outputs the entire frame, but the present invention is not limited to this configuration. For example, the host 100 can supply information indicating a predetermined rectangular region including a subject with motion as an ROI region to the solid-state imaging element 200, and the solid-state imaging element 200 can clip the ROI region from the frame and output the ROI region to the host 100. Thus, the communication amount can be further reduced.

As illustrated in the drawing, the host 100 determines the presence or absence of motion, so that the processing amount of the solid-state imaging element 200 can be reduced.

Note that the first and second modifications of the first embodiment can be applied to the fourth modification of the first embodiment.

As described above, according to the fourth modification of the present technology, since the host 100 determines the presence or absence of motion, the processing amount of the solid-state imaging element 200 can be reduced.

### [Fifth Modification]

In the first embodiment described above, the number of sample and hold circuits sharing the post-stage circuit 590 is four, but the number is not limited to four. A solid-state imaging element 200 according to a fifth modification of the first embodiment is different from that of the first embodiment in that the number of sample and hold circuits sharing a post-stage circuit 590 is two.

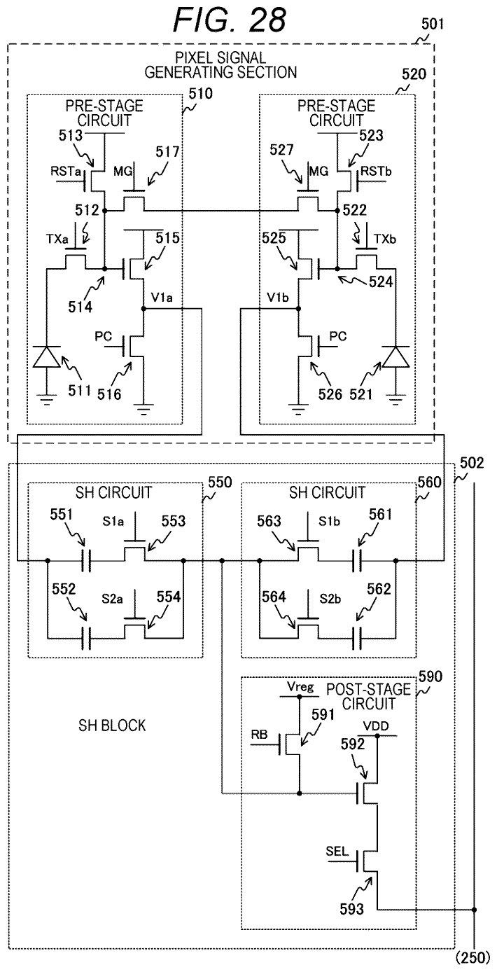

FIG. 28 is a circuit diagram illustrating a configuration example of a pixel block 500 according to the fifth modification of the first embodiment of the present technology. The pixel block 500 of the fifth modification of the first embodiment is different from that of the first embodiment in that pre-stage circuits 530 and 540 and the sample and hold circuits 570 and 580 are reduced.

In a case where the number of sample and hold circuits is reduced to two, the difference data is output not for each frame but for each two frames.

Note that the first, second, third, and fourth modifications of the first embodiment can be applied to the fifth modification of the first embodiment.

As described above, according to the fifth modification of the first embodiment of the present technology, the number of sample and hold circuits sharing the post-stage circuit 590 is reduced to two.

### 2. Second Embodiment

In the first embodiment described above, the solid-state imaging element 200 generates the combined signal of the reset level and the signal level twice for each row, but in this configuration, when difference data is generated, AD conversion is required twice for each row. A solid-state imaging element 200 according to the second embodiment is different from that of the first embodiment in that AD conversion of a combined signal is unnecessary to reduce power consumption when difference data is generated.

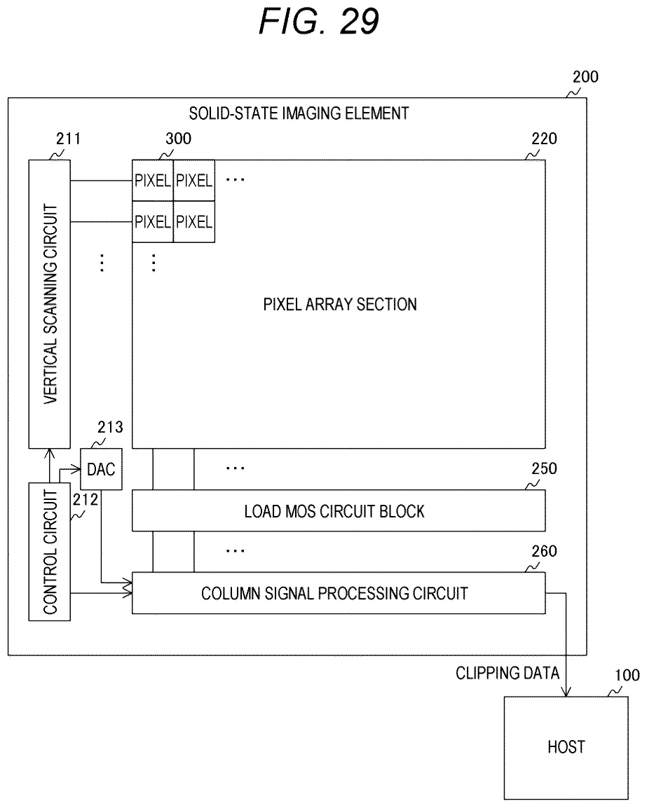

FIG. 29 is a block diagram illustrating a configuration example of an imaging system according to the second embodiment of the present technology. In the second embodiment, the pixel array section 220 is not divided into the plurality of pixel blocks 500. Furthermore, the column signal processing circuit 260 of the second embodiment detects the presence or absence of the mobile object, and outputs clipping data obtained by clipping a region of the mobile object in the frame to the host 100 when the mobile object is detected. Furthermore, in the second embodiment, the circuits and elements in the solid-state imaging element 200 are provided on a single semiconductor chip.

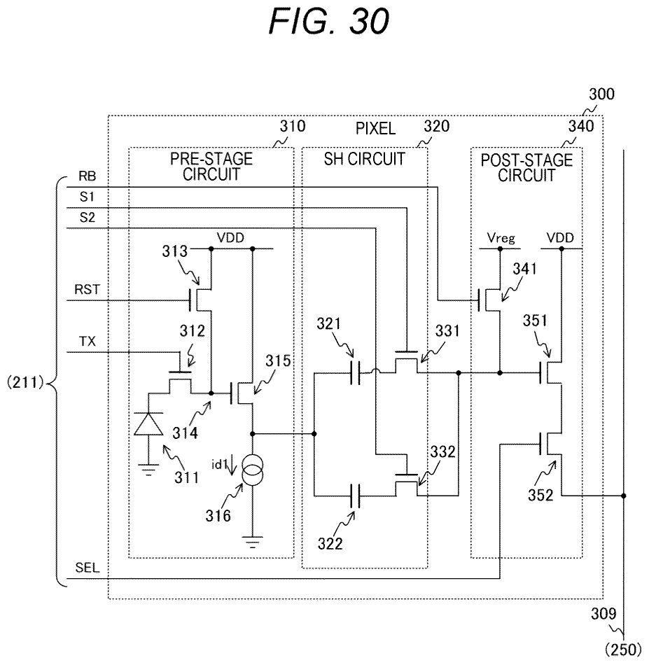

FIG. 30 is a circuit diagram illustrating a configuration example of a pixel 300 according to the second embodiment of the present technology. The pixel 300 of the second embodiment includes a pre-stage circuit 310, a sample and hold circuit 320, and a post-stage circuit 340. In the second embodiment, the post-stage circuit 340 is not shared by a plurality of pixels, and the post-stage circuit 340 is arranged for each pixel.

The pre-stage circuit 310 includes a photoelectric conversion element 311, a transfer transistor 312, an FD reset transistor 313, an FD 314, a pre-stage amplification transistor 315, and a current source transistor 316.

The connection configuration of the photoelectric conversion element 311, the transfer transistor 312, the FD reset transistor 313, the FD 314, and the pre-stage amplification transistor 315 is similar to that of the first embodiment. The current source transistor 316 supplies a current id1 under the control of the vertical scanning circuit 211.

The sample and hold circuit 320 includes capacitive elements 321 and 322 and selection transistors 331 and 332. The connection configuration of these elements is similar to that of the first embodiment.

The post-stage circuit 340 includes a post-stage reset transistor 341, a post-stage amplification transistor 351, and a post-stage selection transistor 352. The connection configuration of these elements is similar to that of the first embodiment.

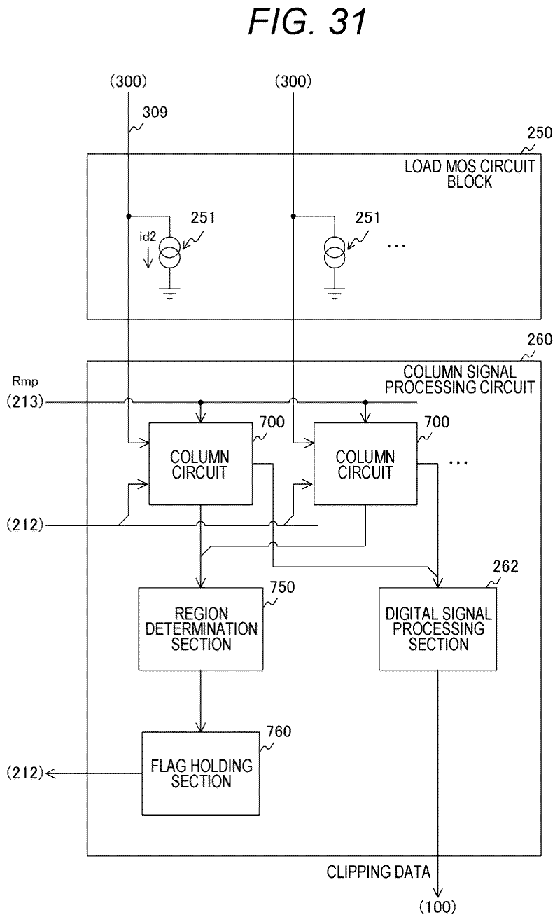

FIG. 31 is a block diagram illustrating a configuration example of the load MOS circuit block 250 and the column signal processing circuit 260 according to the second embodiment of the present technology.

In the first embodiment, the vertical signal line 309 is wired for each column of the pixel block 500. On the other hand, in the second embodiment, the vertical signal line 309 is wired for each column of pixels, and the load MOS transistor 251 is provided for each column of pixels.

Furthermore, the column signal processing circuit 260 of the second embodiment includes a plurality of column circuits 700, a region determination section 750, a flag holding section 760, and a digital signal processing section 262. The column circuit 700 is arranged for each column of pixels.

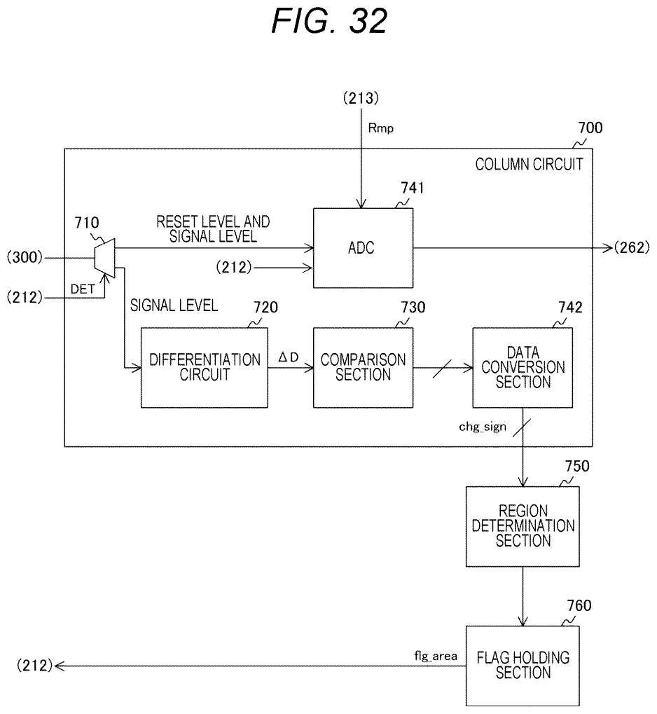

FIG. 32 is a block diagram illustrating a configuration example of a column circuit 700 according to the second embodiment of the present technology. The column circuit 700 includes a selector 710, an ADC 741, a differentiation circuit 720, a comparison section 730, and a data conversion section 742.

The selector 710 switches the output destination of the signal from the pixel 300 to either the ADC 741 or the differentiation circuit 720 in accordance with a detection signal DET from the control circuit 212.

Here, the detection signal DET is a signal indicating whether or not a mobile object is detected. For example, a logical value “1” is set to the detection signal in a case where the mobile object is detected, and a logical value “0” is set in a case where the mobile object is not detected. In the initial state, “O” is set to the detection signal DET. The selector 710 outputs a signal to the differentiation circuit 720 in a case where the detection signal DET is “0”, and the selector 710 outputs a signal to the ADC 741 in a case where the detection signal DET is “1”.

Furthermore, the control circuit 212 sets the detection signal DET on the basis of an area flag flg_area held in the flag holding section 760.

Here, the area flag flg_area is a flag that is generated for each pixel and indicates whether or not the pixel is in the region of the mobile object. The area flag of the nth row and the m-th column is flg_area [n][m]. n is an integer of 0 to N−1, and m is an integer of 0 to M−1. For example, in a case where the corresponding pixel is a pixel in the region of the mobile object, a logical value “1” is set to the area flag flg_area, and otherwise, a logical value “0” is set. In the initial state, the area flag flg_area of all the pixels is set to “0”.

In a case where the area flags flg_area of all the pixels are “0”, that is, in a case where no mobile object is detected, the control circuit 212 controls the pixels 300 via the vertical scanning circuit 211 to generate and hold a signal level for each exposure. Since two capacitive elements (321 and 322) are provided per pixel, the pixel 300 can hold the signal level of each of two consecutive frames. Furthermore, the pixel 300 sequentially outputs two signal levels after the exposure is completed, and the control circuit 212 sets the detection signal DET to “0”. In accordance with this detection signal, the selector 710 outputs a signal level to the differentiation circuit 720.

Furthermore, in a case where the area flag flg_area of any pixel is “1”, that is, in a case where a mobile object is detected, the control circuit 212 sets a clipping region including a region where the area flag flg_area is “1”. The vertical scanning circuit 211 controls a row in the clipping region, and causes the pixels 300 in the row to newly generate a reset level. As described above, since two signal levels can be held for each pixel, the older one of the signal levels is discarded and updated to the reset level. Furthermore, the control circuit 212 sets the detection signal DET to “1”. In accordance with this detection signal, the selector 710 outputs the reset level and the signal level to the ADC 741. Furthermore, the control circuit 212 sets the ADC 741 of each column in the read region to be valid and invalidates the other columns. Thus, only the digital signal in the clipping region is read.

The ADC 741 sequentially converts the reset level and the signal level into a digital signal using the ramp signal Rmp. The ADC 741 supplies the converted digital signal to the digital signal processing section 262.

The differentiation circuit 720 obtains a difference ΔD between two consecutive signal levels. The differentiation circuit 720 supplies the difference ΔD to the comparison section 730.

The comparison section 730 compares the absolute value of the difference ΔD with a predetermined threshold value α. The comparison section 730 supplies the comparison result and the difference ΔD to the data conversion section 742.

The data conversion section 742 converts the comparison result and the difference ΔD into 2-bit output data chg_sign. It is assumed that one of the two bits is chg_sign0, and the other is chg_sign1.

The region determination section 750 determines whether or not each pixel is within the region of the mobile object on the basis of the output data chg_sign of each column, and generates an area flag flg_area. The region determination section 750 causes the flag holding section 760 to hold the generated area flag flg_area. As the flag holding section 760, for example, a static random access memory (SRAM) is used.

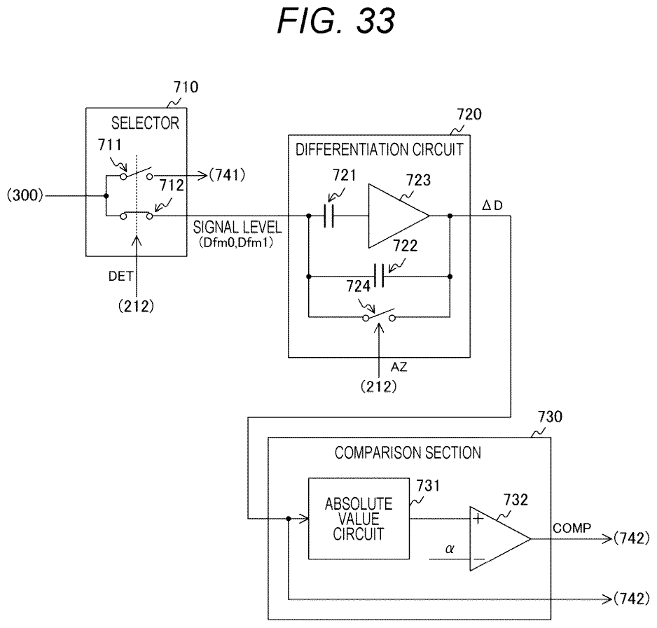

FIG. 33 is a circuit diagram illustrating a configuration example of the selector 710, the differentiation circuit 720, and the comparison section 730 according to the second embodiment of the present technology.

The selector 710 includes switches 711 and 712. The switch 711 opens and closes a path between the pixel 300 and the ADC 741 according to the detection signal DET. The switch 712 opens and closes a path between the pixel 300 and the differentiation circuit 720 according to the detection signal DET.

In a case where the detection signal DET is “0” (that is, in a case where the mobile object is not detected), the switch 711 is opened, and the switch 712 is closed. On the other hand, in a case where the detection signal DET is “1” (that is, in a case where a mobile object is detected), the switch 711 is closed, and the switch 712 is opened.

The differentiation circuit 720 includes capacitive elements 721 and 722, an operational amplifier 723, and an auto-zero switch 724. The capacitive element 721 is inserted between an input terminal of the operational amplifier 723 and an input terminal of the differentiation circuit 720. An output terminal of the operational amplifier 723 is connected to an output terminal of the differentiation circuit 720. The capacitive element 722 is inserted between the input terminal of the differentiation circuit 720 and the output terminal of the operational amplifier 723. The auto-zero switch 724 opens and closes a path between the input terminal of the differentiation circuit 720 and the output terminal of the operational amplifier 723 according to an auto-zero signal AZ from the control circuit 212.

The comparison section 730 includes an absolute value circuit 731 and a comparator 732. The absolute value circuit 731 obtains an absolute value of the difference ΔD from the differentiation circuit 720 and outputs the absolute value to the comparator 732.

The comparator 732 compares the absolute value of ΔD with α. The comparator 732 outputs a comparison result COMP to the data conversion section 742. Furthermore, the difference ΔD is also input to the data conversion section 742.

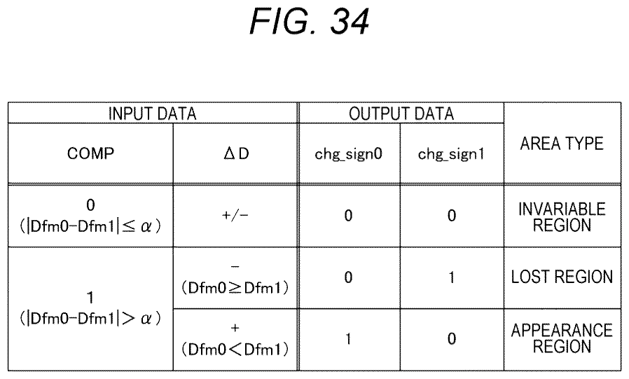

FIG. 34 is a diagram illustrating an example of the operation of the data conversion section 742 according to the second embodiment of the present technology. The comparison result COMP and the difference ΔD are input to the data conversion section 742. The comparison result COMP indicates a comparison result between the absolute value of the difference ΔD and α. The difference ΔD indicates a difference between respective signal levels of two consecutive frames.

It is assumed that a signal level of a certain frame fm0 is Dfm0, and a signal level of the next frame fm1 is Dfm1. The pixel 300 outputs Dfm0 and Dfm1 in this order, and the differentiation circuit 720 outputs their amounts of change as ΔD.

For example, in a case where Dim1 is equal to or less than Dfm0, the differentiation circuit 720 outputs a difference ΔD having a minus sign. On the other hand, in a case where Dfm1 is larger than Dfm0, the differentiation circuit 720 outputs difference ΔD having a plus sign.

Furthermore, the comparison section 730 outputs the low-level comparison result COMP in a case where the difference absolute value (| Dfm0−Dfm1|) is equal to or less than α, and outputs the high-level comparison result COMP in a case where the difference absolute value (|Dfm0−Dfm1|) is not equal to or less than α.

In a case where the comparison result COMP is at the low level, the data conversion section 742 outputs chg_sign0 of “0” and chg_sign1 of “0” regardless of the sign of the difference ΔD. These output data indicate that the corresponding pixel is an invariable region with little change.

Furthermore, in a case where the comparison result COMP is at the high level and the sign of ΔD is negative, the data conversion section 742 outputs chg_sign0 of “0” and chg_sign1 of “1”. These output data indicate that the corresponding pixel is within a lost region in which the signal has disappeared.

Furthermore, in a case where the comparison result COMP is at the high level and the sign of ΔD is positive, the data conversion section 742 outputs chg_sign0 of “1” and chg_sign1 of “0”. These output data indicate that the corresponding pixel is within the occurrence region in which the signal occurs.

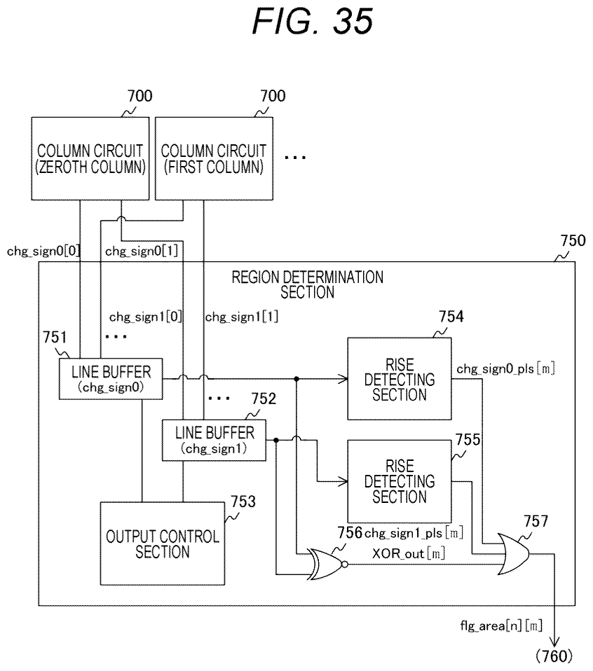

FIG. 35 is a circuit diagram illustrating a configuration example of the region determination section 750 according to the second embodiment of the present technology. The region determination section 750 includes line buffers 751 and 752, an output control section 753, rise detecting sections 754 and 755, an exclusive logical sum (XOR) gate 756, and a logical sum (OR) gate 757.

The line buffer 751 holds output data chg_sign0 of each column. It is assumed that chg_sign0 in the mth column is chg_sign0[m]. M bits from the 0th column to the (M−1)th are held in the line buffer 751.

The line buffer 752 holds output data chg_sign1 of each column. It is assumed that chg_sign1 in the mth column is chg_sign1[m]. M bits from the 0th column to the (M−1)th are held in the line buffer 752.

The output control section 753 controls the line buffers 751 and 752 to output chg_sign0[m] and chg_sign1[m] in order from the 0th column to the (M−1)th column. chg_sign0[m] is output to the XOR gate 756 and the rise detecting section 754, and chg_sign1[m] is output to the XOR gate 756 and the rise detecting section 755.

The rise detecting section 754 detects a rise of chg_sign0[m]. When chg_sign0[m] rises from a low level to a high level, the rise detecting section 754 generates one pulse of chg_sign0_pls[m] and supplies the same to the OR gate 757.

The rise detecting section 755 detects a rise of chg_sign1[m]. When chg_sign1[m] rises from a low level to a high level, the rise detecting section 754 generates one pulse of chg_sign1_pls[m] and supplies the same to the OR gate 757.

The XOR gate 756 outputs an exclusive OR of chg_sign0[m] and chg_sign1[m] to the OR gate 757 as XOR_out[m].

The OR gate 757 outputs a logical sum of chg_sign0_pls[m], chg_sign1_pls[m], and XOR_out[m] to the flag holding section 760 as an area flag flg_area[n][m].

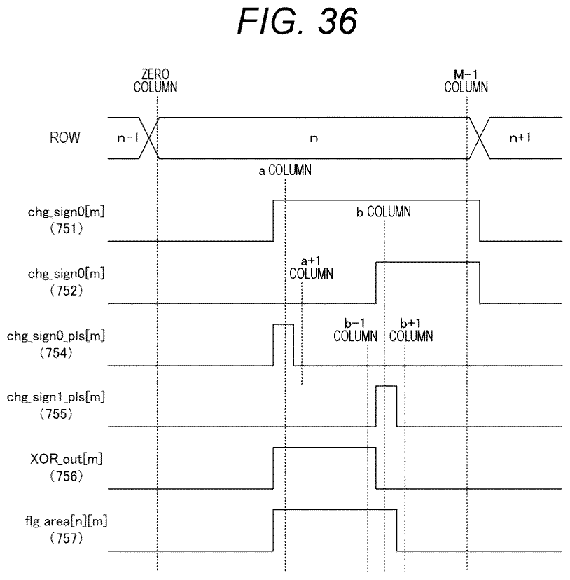

FIG. 36 is a timing chart illustrating an example of the operation of the region determination section 750 according to the second embodiment of the present technology. The line buffers 751 and 752 sequentially output chg_sign0[m] and chg_sign1[m] from the 0th column to the (M−1)th column in the nth row.

It is assumed that chg_sign0[m] rises in column a, and chg_sign1[m] rises in the column b. The rise detecting section 754 generates only one pulse chg_sign0_pls[m] in the column a. The rise detecting section 755 generates only one pulse chg_sign1_pls[m] in the column b. The XOR gate 756 outputs a high-level XOR_out[m] during the period from the column a to the column b−1. The OR gate 757 outputs a high-level area flag flg_area[n][m] during the period from the column a to the column b. For the (n+1)th and subsequent columns, area flags flg_area[n][m] corresponding to M columns in the row are generated by similar control.

As illustrated in FIGS. 31 to 36, in the second embodiment, since the differentiation circuit 720 obtains a difference between signal levels, it is not necessary to perform AD conversion twice as in the first embodiment when generating difference data. Thus, the power consumption can be reduced.

Furthermore, since the reset level is generated at the time of detecting the mobile object and read together with the signal level, it is possible to generate high-quality clipping data as in the first embodiment.

Note that the difference between the next frame and the held frame can also be obtained by a method for holding one frame after the AD conversion in the frame memory. However, in this method, AD conversion for each pixel is required, and a frame memory needs to be provided, which increases power consumption and cost.

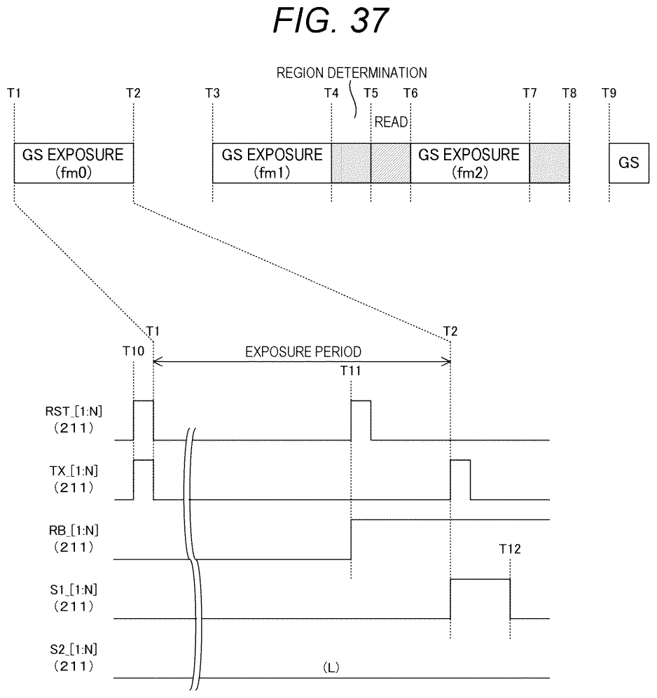

FIG. 37 is a timing chart illustrating an example of the first global shutter control of the solid-state imaging element 200 according to the second embodiment of the present technology. It is assumed that the first exposure is performed during the period from timing T1 to timing T2.

The vertical scanning circuit 211 supplies the high-level FD reset signal RST and the high-level transfer signal TX to all the rows from timing T10 immediately before the exposure start to timing T1 of the exposure start. Accordingly, all pixels are PD reset, and the exposure simultaneously starts in all rows.

Then, at timing T11 immediately before the end of the exposure period, the vertical scanning circuit 211 supplies the high-level FD reset signal RST over the pulse period while setting the post-stage reset signal RB to the high level in all the pixels. Accordingly, all the pixels are FD reset.

At timing T2 of the end of the exposure, the vertical scanning circuit 211 supplies the high-level transfer signal TX to all the pixels over the pulse period. Thus, a signal level is generated. Furthermore, the vertical scanning circuit 211 supplies the high-level selection signal S1 to all the pixels during the period from timing T2 to timing T12. Thus, the signal level of the first frame is sampled and held in all the pixels.

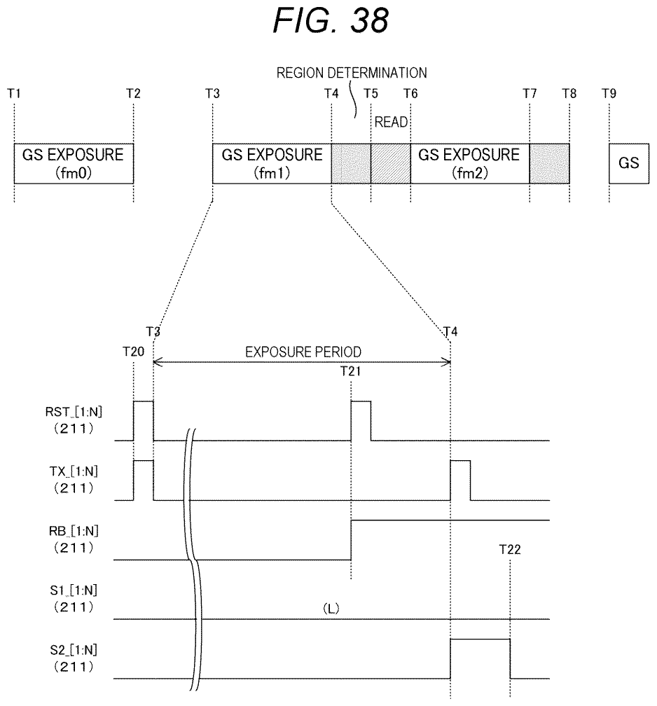

FIG. 38 is a timing chart illustrating an example of the second global shutter control of the solid-state imaging element 200 according to the second embodiment of the present technology. It is assumed that the second exposure is performed during the period from timing T3 to timing T4.

The vertical scanning circuit 211 supplies the high-level FD reset signal RST and the high-level transfer signal TX to all the rows from timing T20 immediately before the exposure start to timing T3 of the exposure start. Accordingly, all pixels are PD reset, and the exposure simultaneously starts in all rows.

Then, at timing T21 immediately before the end of the exposure period, the vertical scanning circuit 211 supplies the high-level FD reset signal RST over the pulse period while setting the post-stage reset signal RB to the high level in all the pixels. Accordingly, all the pixels are FD reset.

At timing T4 of the end of the exposure, the vertical scanning circuit 211 supplies the high-level transfer signal TX to all the pixels over the pulse period. Thus, a signal level is generated. Furthermore, the vertical scanning circuit 211 supplies the high-level selection signal S2 to all the pixels during the period from timing T4 to timing T22. Thus, the signal level of the second frame is sampled and held in all the pixels.

Also in the following exposure, as illustrated in FIGS. 37 and 38, the selection signals S1 and S2 are alternately supplied, and the signal level of each of two consecutive frames is held for each pixel.

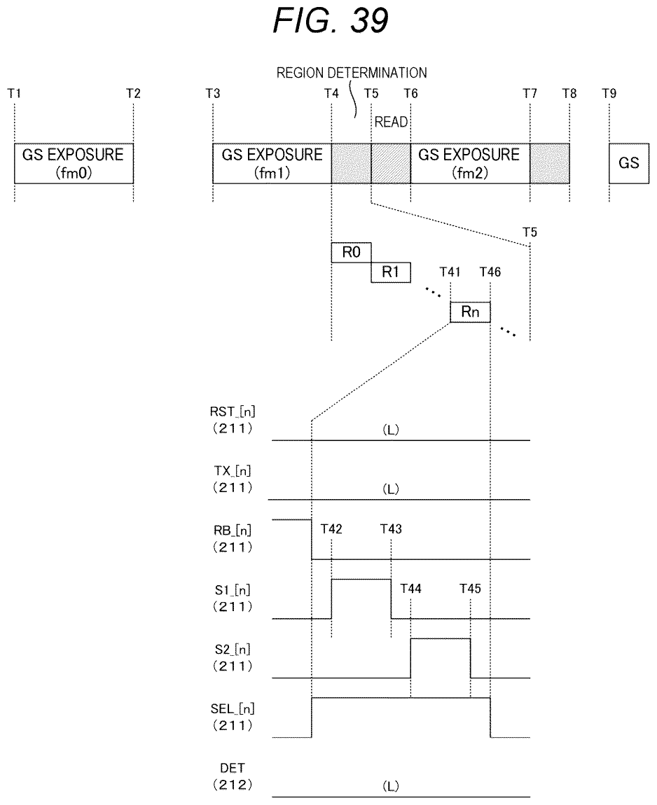

FIG. 39 is a timing chart illustrating an example of operation at a time of region determination of the solid-state imaging element 200 according to the second embodiment of the present technology. During a period from timing T4 when the second exposure ends to timing T5, the vertical scanning circuit 211 sequentially selects rows and causes the pixel signal of the first frame and the pixel signal of the second frame to be sequentially output. It is assumed that the nth row is selected during the period from timing T41 to timing T46.

During a period from timing T41 to timing T46, the vertical scanning circuit 211 supplies the high-level post-stage selection signal SEL to the nth row. During a period from timing T42 to timing T43 in the period, the vertical scanning circuit 211 supplies the high-level selection signal S1 to the nth row. Thus, the signal level of the first frame is output. Then, during the period from timing T44 to timing T45, the vertical scanning circuit 211 supplies the high-level selection signal S2 to the nth row. Thus, the signal level of the second frame is output.

Furthermore, the control circuit 212 sets the detection signal DET to the low level. Thus, the selector 710 supplies the respective signal levels of the first frame and the second frame to the differentiation circuit 720. Furthermore, the region determination section 750 determines whether or not each pixel is within the region of the mobile object on the basis of chg_sign obtained from the difference ΔD output from the differentiation circuit 720.

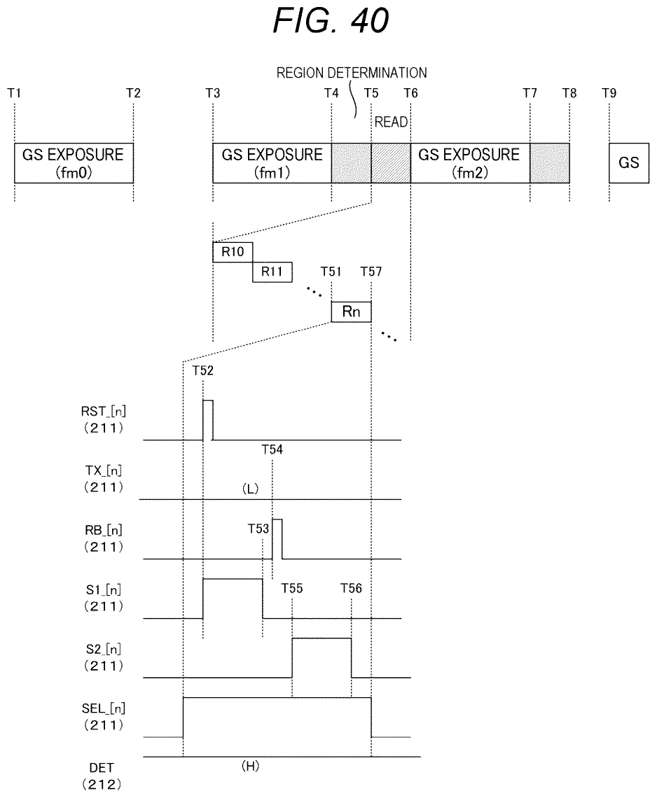

FIG. 40 is a timing chart illustrating an example of a read operation of the solid-state imaging element 200 according to the second embodiment of the present technology. It is assumed that any area flag flg_area is updated to “1” by the region determination section 750 during the period from timing T4 to timing T5.

The control circuit 212 sets a clipping region including a region with the area flag flg_area of “1”, and controls the vertical scanning circuit 211 and the column signal processing circuit 260 to execute reading in the region. After setting the clipping region, the control circuit 212 initializes the area flags flg_area of all the pixels to “0”.

During the read period from timing T5 to timing T6, the vertical scanning circuit 211 sequentially selects the rows in the clipping region and causes the reset level and the signal level of the second frame to be output. For example, it is assumed that a region after Row 10 (R10) is set as the clipping region. It is assumed that the nth row (Rn) in the clipping region is selected during the period from timing T51 to timing T57.

During a period from timing T51 to timing T57, the vertical scanning circuit 211 supplies the high-level post-stage selection signal SEL to the nth row. The vertical scanning circuit 211 supplies the high-level FD reset signal RST to the nth row over the pulse period from timing T52 within this period. Thus, the nth row is FD-reset, and a reset level of the second frame is generated. Furthermore, the vertical scanning circuit 211 supplies the high-level selection signal S1 to the nth row during the period from timing T52 to timing T53. Thus, the signal level of the first frame is updated to the reset level of the second frame, and the reset level is output.

The control circuit 212 sets the detection signal DET to the low level. Thus, the reset level is supplied to the ADC 741. The ADC 741 of each column in the clipping region performs AD conversion on the output reset level.

Then, the vertical scanning circuit 211 supplies the high-level post-stage reset signal RB to the nth row over the pulse period from timing T54. Subsequently, the high-level selection signal S2 is supplied to the nth row in a period from timing T55 to timing T56. Thus, the signal level of the second frame is output, and AD conversion is performed by the ADC 741 of each column in the clipping region. By the CDS processing on the reset level and the signal level of the second frame, clipping data is generated. The clipping data is output to the host 100.

Furthermore, when the reading of the last row in the clipping data is completed, the control circuit 212 returns the detection signal DET to the low level.

Then, the third exposure is performed during the exposure period from timing T6 to timing T7. At the end of the exposure, the reset level of the second frame is updated by the signal level of the third frame by the selection signal S1.

Subsequently, since the detection signal DET is at the low level, the signal levels of the second and third frames are output to the differentiation circuit 720 during the period from timing T7 to timing T8. The region determination section 750 determines whether or not each pixel is within the region of the mobile object on the basis of the difference. Here, it is assumed that the area flags flg_area of all the pixels remain “0”. In this case, the reset level and the signal level in the clipping region are not read, and the next exposure is started after timing T9.

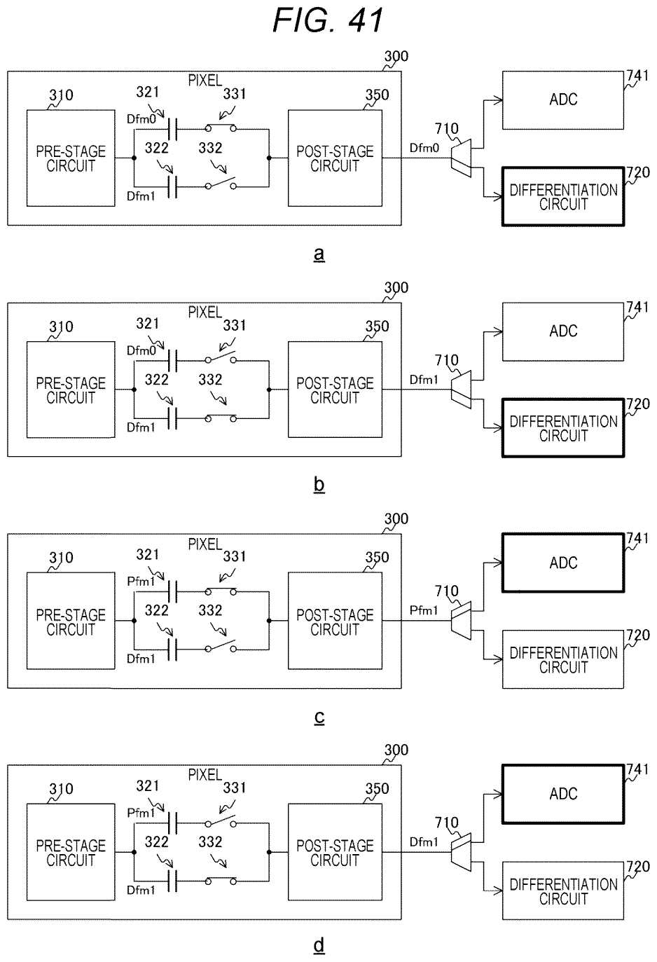

FIG. 41 is a diagram illustrating an example of states of the pixel 300 and the selector 710 at a time of region determination and at a time of reading according to the second embodiment of the present technology. In a and b of the drawing, the area flags flg_area of all the pixels are “0” (in other words, the mobile object is not detected), and a state when the region determination section 750 operates after the completion of the exposure of the two frames is illustrated. In the drawing, c and d indicate a state when any of the area flags flg_area is updated to “1” and the pixel signals in the clipping region are read. In the drawing, the selection transistors 331 and 332 are represented by graphical symbols of switches.

As illustrated in a of the drawing, the vertical scanning circuit 211 closes the selection transistor 331 and causes the signal level Dfm0 of the first frame to be output. In a case where the mobile object is not detected, the control circuit 212 controls the selector 710 to supply the signal level Dfm0 to the differentiation circuit 720.

Next, as illustrated in b of the drawing, the vertical scanning circuit 211 closes the selection transistor 332 and causes the signal level Dfm1 of the second frame to be output. The control circuit 212 controls the selector 710 to supply the signal level Dfm1 to the differentiation circuit 720. Then, the differentiation circuit 720 obtains a difference ΔD between the signal levels Dfm0 and Dfm1.

Then, it is assumed that one of the area flags flg_area is updated to “1” (in other words, the mobile object is detected) by the region determination section 750. The vertical scanning circuit 211 initializes the FD of the pixel 300 in the clipping region, and causes the capacitive element 321 to hold a reset level Pfm1 of the second frame.

As illustrated in c of the drawing, the vertical scanning circuit 211 closes the selection transistor 331 of the pixel 300 in the clipping region and causes the reset level Pfm1 to be output. Since the mobile object is detected, the control circuit 212 controls the selector 710 to supply a reset level Pfm0 to the ADC 741.

Next, as illustrated in d of the drawing, the vertical scanning circuit 211 closes the selection transistor 332 of the pixel 300 in the clipping region and causes the signal level Dim1 to be output. The control circuit 212 controls the selector 710 to supply the signal level Dfm0 to the ADC 741.

The reset level and the signal level in the clipping region are AD-converted by the ADC 741, and the clipping data is generated.

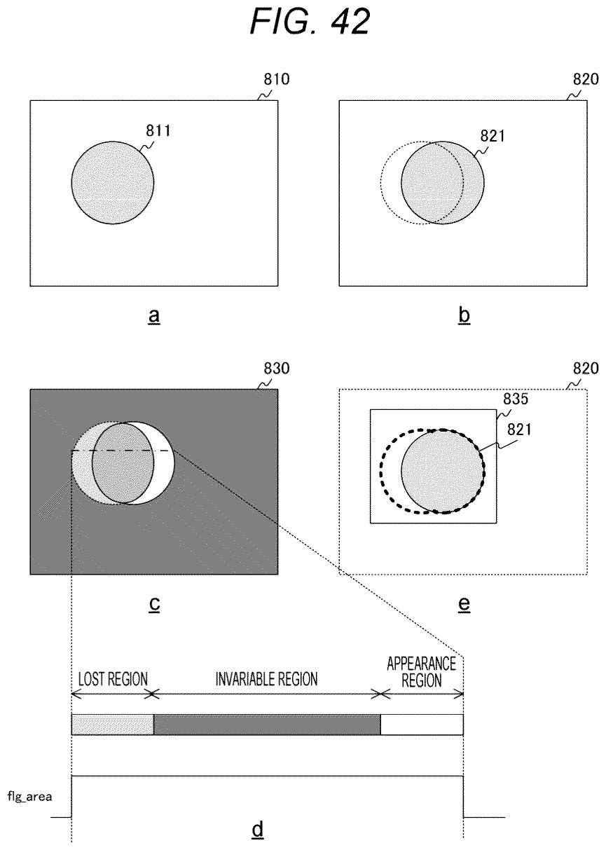

FIG. 42 is a diagram illustrating an example of image data, difference data, and clipping data according to the second embodiment of the present technology. Of the drawing, a is an example of image data (frame) 810 generated by the first exposure. Of the drawing, b is an example of image data (frame) 820 generated by the second exposure.

The image data 810 includes a subject 811, and the image data 820 includes a subject 821. A dotted line in the image data 820 indicates an outline of the subject 811. The subjects 811 and 821 are the same mobile object and have different positions in each frame. Furthermore, each pixel holds a signal level of each of the image data 810 and 820. The differentiation circuit 720 obtains a difference between these signal levels.

In the drawing, c illustrates difference data 830 in which differences of signal levels in the respective pixels are arranged. The one-dot chain lines indicate rows in the regions of the subjects 811 and 821.

In the drawing, d illustrates an enlarged view of a one-dot chain line of c in the drawing. A part of the subject 811 is lost in the next image data 820 due to movement, and this region corresponds to the lost region. Furthermore, a part of each of the subjects 811 and 821 overlaps, and the region corresponds to an invariable region. A part of the subject 821 does not appear in the previous image data 810, and this region corresponds to an appearance region. The region determination section 750 sets the area flag flg_area from the end of the lost region to the end of the appearance region to “1”.

Then, the control circuit 212 sets a clipping region including a region with the area flag flg_area of “1”. Furthermore, under the control of the control circuit 212, the vertical scanning circuit 211 and the ADC 741 convert the reset level and the signal level in the region into a digital signal and generate clipping data.

In the drawing, e illustrates an example of the clipping data 835. The subject 821 that is a mobile object is included in the clipping data 835. Furthermore, a thick dotted line indicates a region in which the area flag flg_area is “1”.

As illustrated in the drawing, when detecting a mobile object, the solid-state imaging element 200 can clip and output a region including the mobile object. Such a function of the solid-state imaging element 200 can be used for crime prevention and monitoring.

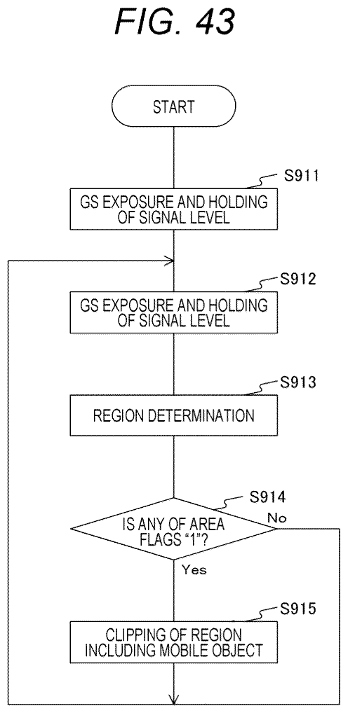

FIG. 43 is a flowchart illustrating an example of operation of the solid-state imaging element 200 according to the second embodiment of the present technology. This operation is started, for example, when a predetermined application for detecting a mobile object is executed.

The solid-state imaging element 200 exposes all the pixels by the global shutter method, and holds a signal level for each pixel (step S911). Next, the solid-state imaging element 200 exposes all the pixels again by the global shutter method, and holds the signal level for each pixel (step S912). Then, the solid-state imaging element 200 determines whether or not it is within the region of the mobile object for each pixel on the basis of the difference between the signal levels (step S913).

As a result of the determination, the solid-state imaging element determines whether or not the area flag of any pixel has been updated to “1” (step S914).

In a case where the area flag of any pixel is “1” (step S914: Yes), the solid-state imaging element 200 clips a clipping region including the region of the mobile object (step S915). The area flag is initialized after the clipping. In a case where the area flags of all the pixels are “0” (step S914: No), or after step S915, the solid-state imaging element 200 repeats step S912 and the subsequent steps.

As described above, according to the second embodiment of the present technology, since the differentiation circuit 720 obtains a difference between signal levels of two frames, AD conversion at the time of generating difference data becomes unnecessary, and power consumption can be reduced.

### [First Modification]

In the second embodiment described above, the solid-state imaging element 200 sets the clipping region, but with this configuration, it is difficult to change the clipping region from the outside. An imaging system of a first modification of the second embodiment is different from that of the first embodiment in that the host 100 sets the clipping region.

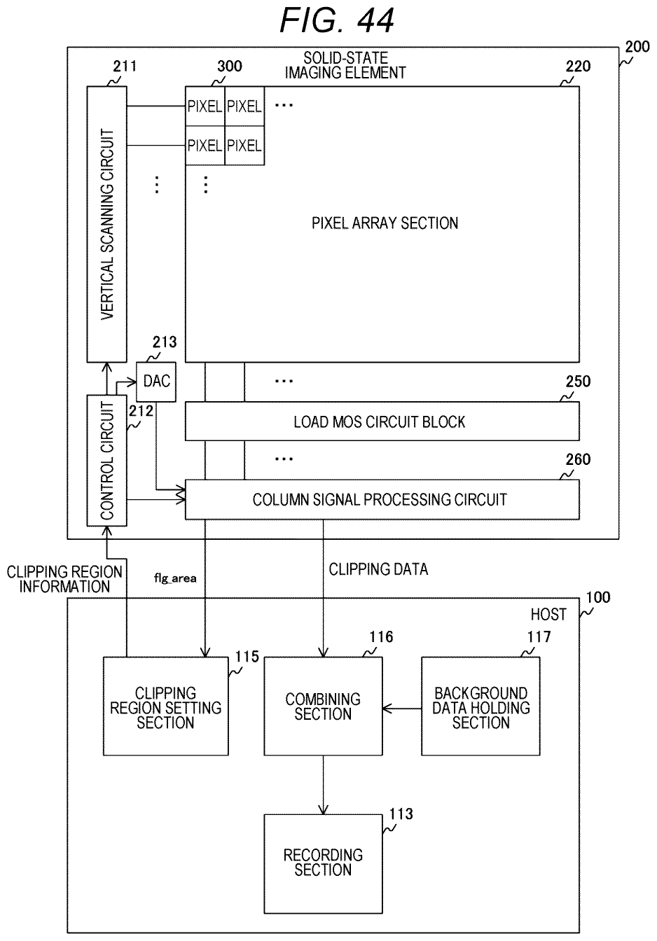

FIG. 44 is a block diagram illustrating a configuration example of an imaging system according to a first modification of the second embodiment of the present technology. In the first modification of the second embodiment, the host 100 includes a clipping region setting section 115, a combining section 116, a background data holding section 117, and a recording section 113.

Furthermore, the column signal processing circuit 260 of the second embodiment supplies the area flag flg_area to the clipping region setting section 115.

The clipping region setting section 115 sets a predetermined region including a region with the area flag flg_area of “1” as a clipping region. The clipping region setting section 115 supplies clipping region information indicating the set clipping region to the control circuit 212.

The control circuit 212 of the first modification of the second embodiment controls the vertical scanning circuit 211 and the column signal processing circuit 260 on the basis of the clipping region information to generate clipping data. The column signal processing circuit 260 of the first modification of the second embodiment supplies the clipping data to the combining section 116.

The combining section 116 combines the clipping data and the background data. The combining section 116 records the combined data in the recording section 113. The background data holding section 117 holds background data.

As illustrated in the drawing, when the host 100 sets the clipping region, it becomes easy to change the clipping region on the host 100 side, and convenience and versatility of the imaging system are improved.

As described above, according to the first modification of the second embodiment of the present technology, since the host 100 sets the clipping region, convenience and versatility can be improved.

### [Second Modification]

In the second embodiment described above, the solid-state imaging element 200 clips the clipping region on the basis of the area flag flg_area, but can also control an analog gain on the basis of the area flag flg_area. A solid-state imaging element 200 according to a second modification of the second embodiment is different from that of the second embodiment in that an analog gain is controlled on the basis of the area flag flg_area.

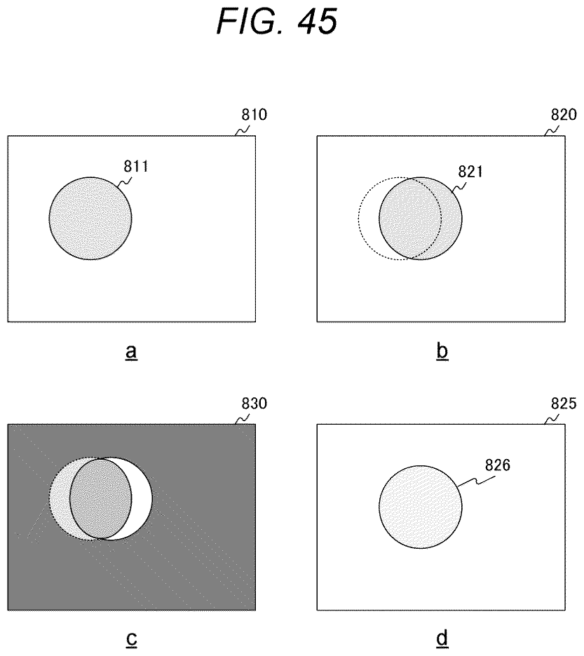

FIG. 45 is a diagram illustrating an example of image data and difference data according to the second modification of the second embodiment of the present technology. Of the drawing, a is an example of image data (frame) 810 generated by the first exposure. Of the drawing, b is an example of image data (frame) 820 generated by the second exposure. In the drawing, c illustrates difference data 830 in which differences of signal levels in the respective pixels are arranged.

The vertical scanning circuit 211 of the second modification of the second embodiment causes all the pixels to generate a reset level and causes all the pixels to output the reset level and the signal level when a mobile object is detected. Furthermore, the control circuit 212 sets the analog gain for the pixel signal (reset level and signal level) in the region with the area flag flg_area of “1” to be higher than that in the other region. For example, the control circuit 212 controls the DAC 213 to moderate the slope of the ramp signal at the time of AD conversion of the pixel signal in the region in which the area flag flg_area is “1”. As the slope of the ramp signal is gentler, the analog gain for the pixel signal increases.

For example, as illustrated in the drawing, the same image data 825 as the image data 820 is read. The region of the subject 826 with the area flag flg_area of “1” becomes brighter than the surroundings due to the increase in the analog gain. By changing the analog gain of the region of the mobile object, the image quality of the image data 825 including the mobile object can be improved.

As described above, according to the second modification of the second embodiment of the present technology, since the analog gain of the region of the mobile object is changed, the image quality of the image data can be improved.

### [Third Modification]

In the second embodiment described above, the pixel 300 newly generates the reset level at the time of detecting the mobile object after the end of the exposure. However, as illustrated in FIG. 38, the reset level corresponding to the signal level is generated at timing T21 immediately before the end of the exposure, which is different from the timing after the end of the exposure. Due to this timing shift, the image quality of the clipping data may be deteriorated. A solid-state imaging element 200 according to a third modification of the second embodiment is different from that of the second embodiment in that a reset level and a signal level of each of two frames are held for each pixel.

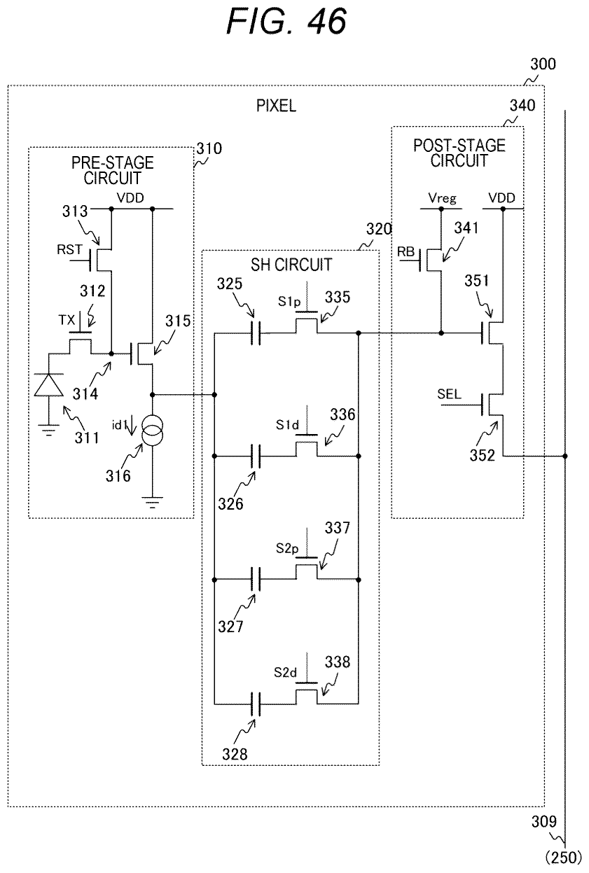

FIG. 46 is a circuit diagram illustrating a configuration example of a pixel 300 according to the third modification of the second embodiment of the present technology. The pixel 300 of the third modification of the second embodiment is different from that of the second embodiment in that four capacitive elements and four selection transistors are arranged.

The sample and hold circuit 320 includes capacitive elements 325, 326, 327, and 328 and selection transistors 335, 336, 337, and 338.

One end of each of the capacitive elements 325, 326, 327, and 328 is commonly connected to the pre-stage circuit 310.

The selection transistor 335 opens and closes a path between the other end of the capacitive element 325 and the post-stage circuit 340 in accordance with a selection signal S1p from the vertical scanning circuit 211. The selection transistor 336 opens and closes a path between the other end of the capacitive element 326 and the post-stage circuit 340 in accordance with a selection signal S1d from the vertical scanning circuit 211. The selection transistor 337 opens and closes a path between the other end of the capacitive element 327 and the post-stage circuit 340 in accordance with a selection signal S2p from the vertical scanning circuit 211. The selection transistor 338 opens and closes a path between the other end of the capacitive element 328 and the post-stage circuit 340 in accordance with a selection signal S2d from the vertical scanning circuit 211.

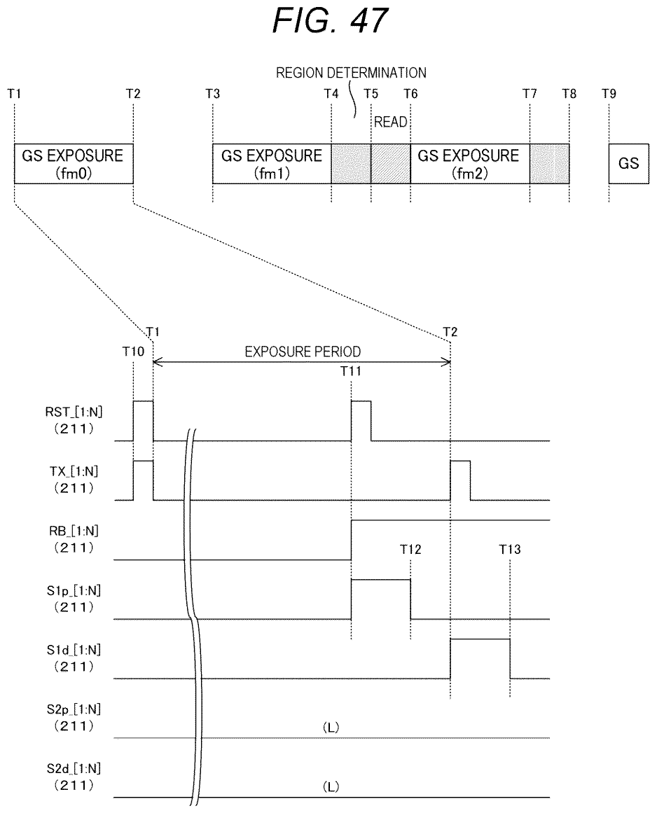

FIG. 47 is a timing chart illustrating an example of first global shutter control of the solid-state imaging element 200 according to the third modification of the second embodiment of the present technology. Differences from the second embodiment will be described.

The vertical scanning circuit 211 supplies the high-level selection signal S1p to all the pixels during the period from timing T11 to timing T12 immediately before the end of the exposure. Thus, the reset level of the first frame is sampled and held in all the pixels.

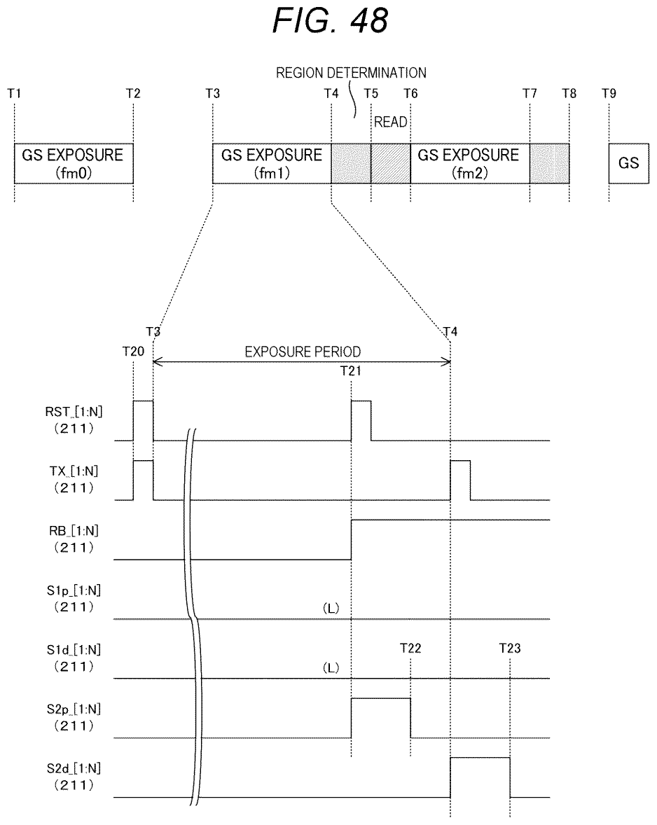

FIG. 48 is a timing chart illustrating an example of second global shutter control of the solid-state imaging element 200 according to the third modification of the second embodiment of the present technology. Differences from the second embodiment will be described.

The vertical scanning circuit 211 supplies the high-level selection signal S2p to all the pixels during the period from timing T21 to timing T22 immediately before the end of the exposure. Thus, the reset level of the second frame is sampled and held in all the pixels.

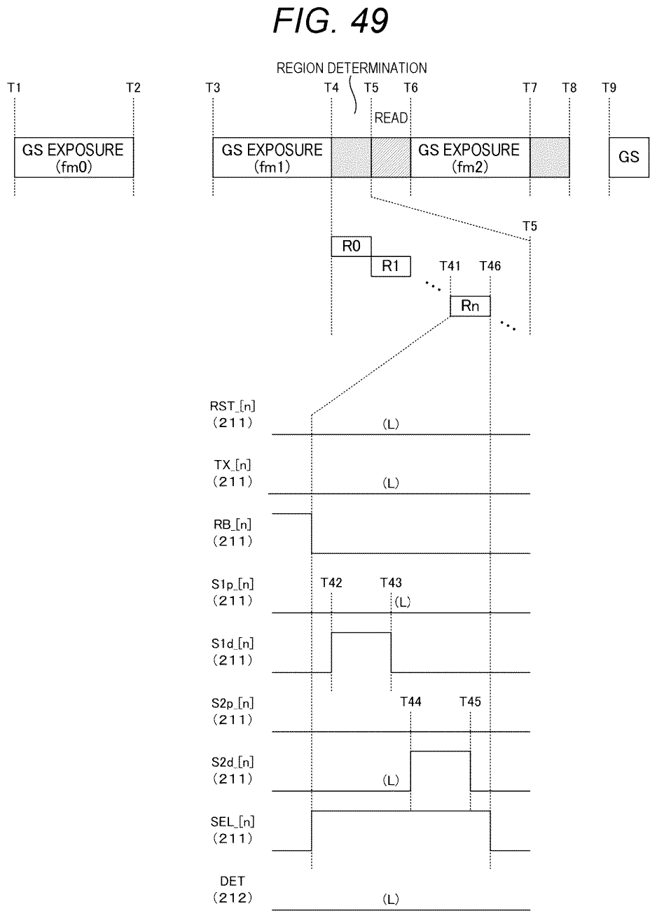

FIG. 49 is a timing chart illustrating an example of operation at the time of region determination of the solid-state imaging element 200 according to the third modification of the second embodiment of the present technology.

During a period from timing T42 to timing T43, the vertical scanning circuit 211 supplies the high-level selection signal S1d to the nth row. Thus, the signal level of the first frame is output. Then, during the period from timing T44 to timing T45, the vertical scanning circuit 211 supplies the high-level selection signal S2d to the nth row. Thus, the signal level of the second frame is output.

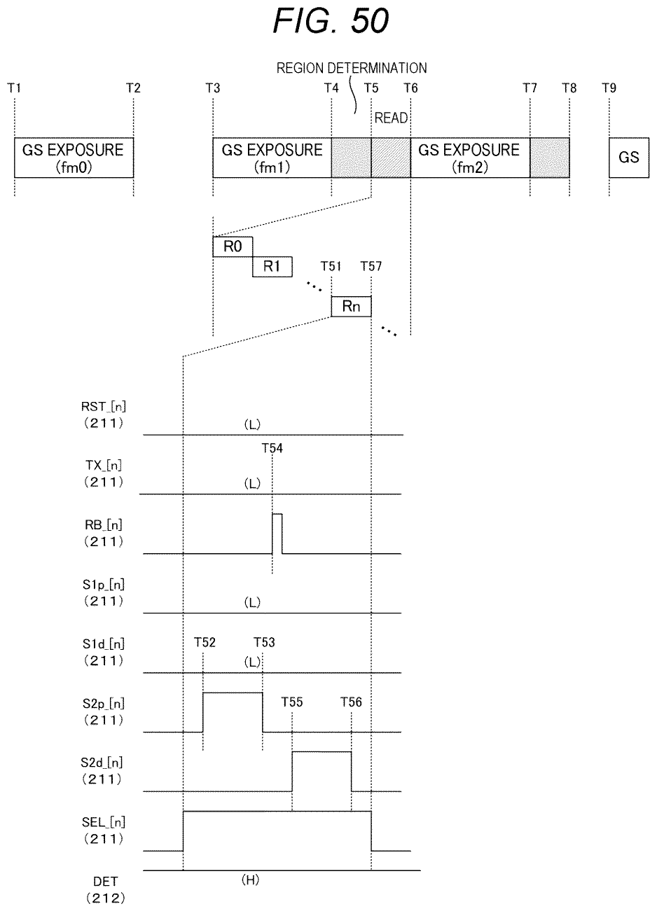

FIG. 50 is a timing chart illustrating an example of read operation of the solid-state imaging element 200 according to the third modification of the second embodiment of the present technology.

The vertical scanning circuit 211 supplies the high-level selection signal S2p to the nth row in a period from timing T52 to timing T53. Thus, the reset level of the second frame is output. Note that the FD reset signal RST remains at a low level, and a reset level is not newly generated.

Furthermore, the vertical scanning circuit 211 supplies the high-level selection signal S2d to the nth row during the period from timing T55 to timing T56. Thus, the signal level of the second frame is output.

Note that, in a case where the mobile object is detected after the exposure of the next frame fm2, the reset level and the signal level of the frame are read by the selection signals S1p and S1d.

As illustrated in FIGS. 46 to 50, since the pixel 300 holds the reset level and the signal level of each of the two frames, it is not necessary to newly generate a reset level at the time of reading. Thus, it is possible to suppress deterioration in image quality due to a shift in the timing of generating the reset level.

Note that each of the first and second modifications of the second embodiment can be applied to the third modification of the second embodiment.

As described above, according to the third modification of the second embodiment of the present technology, since the pixel 300 holds the reset level and the signal level of each of the two frames, it is possible to suppress deterioration in image quality.

### [Fourth Modification]

In the second embodiment described above, the circuits in the solid-state imaging element 200 are provided in a single semiconductor chip, but there is a possibility that this configuration prevents the elements from fitting in the semiconductor chip when the pixel 300 is miniaturized. A solid-state imaging element 200 of a fourth modification of the first embodiment differs from that of the second embodiment in that the circuits in the solid-state imaging element 200 are dispersedly disposed in two semiconductor chips.

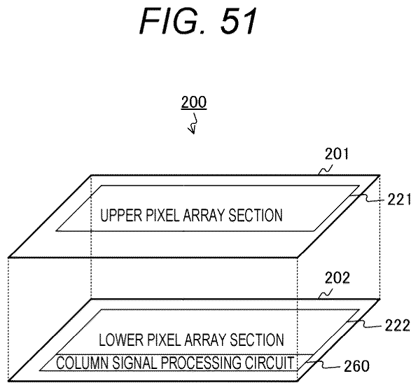

FIG. 51 is a diagram illustrating an example of a stacked structure of the solid-state imaging element 200 according to the fourth modification of the second embodiment of the present technology. The solid-state imaging element 200 of the fourth modification of the second embodiment includes a circuit chip 202 and a pixel chip 201 stacked on the circuit chip 202. These chips are electrically connected by, for example, Cu—Cu bonding. Note that, in addition to the Cu—Cu bonding, the connection can be made using a via or a bump.

The pixel chip 201 is provided with an upper pixel array section 221. The circuit chip 202 is provided with a lower pixel array section 222 and the column signal processing circuit 260. For each pixel in the pixel array section 220, a part of the pixel is arranged in the upper pixel array section 221, and the rest is arranged in the lower pixel array section 222.

Furthermore, the circuit chip 202 is further provided with the vertical scanning circuit 211, the control circuit 212, the DAC 213, and the load MOS circuit block 250. These circuits are not illustrated in the drawing.

Furthermore, the pixel chip 201 is manufactured, for example, by a pixel-dedicated process, and the circuit chip 202 is manufactured, for example, by a complementary MOS (CMOS) process.

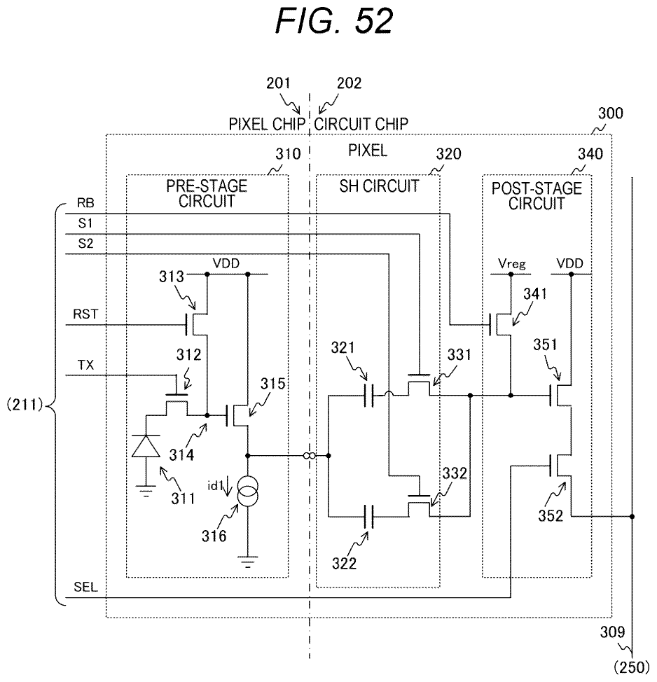

FIG. 52 is a circuit diagram illustrating a configuration example of a pixel 300 according to the fourth modification of the second embodiment of the present technology. In the pixel 300, the pre-stage circuit 310 is arranged in the pixel chip 201, and other circuits and elements (such as the capacitive elements 321 to 322) are arranged in the circuit chip 202. Note that the current source transistors 316 can be further arranged in the circuit chip 202. As illustrated in the drawing, dispersedly arranging the elements belonging to the pixel 300 in the pixel chip 201 and the circuit chip 202 stacked on top of each other allows a reduction in pixel area, thereby facilitating pixel miniaturization.

As described above, according to the fourth modification of the second embodiment of the present technology, the circuits and elements belonging to the pixel 300 are dispersedly arranged in the two semiconductor chips to facilitate pixel miniaturization.

### [Fifth Modification]

In the fourth modification example of the second embodiment described above, a part of the pixel 300 and the peripheral circuit (such as the column signal processing circuit 260) are provided in the circuit chip 202 on the lower side. However, with this configuration, the arrangement area of the circuits and elements on the circuit chip 202 side is larger than that of the pixel chip 201 by the peripheral circuit, and there is a possibility that an unnecessary space without circuits and elements is generated in the pixel chip 201. The solid-state imaging element 200 of a fifth modification of the second embodiment is different from the fourth modification of the second embodiment in that the circuits belonging to the solid-state imaging element 200 are dispersedly arranged in three semiconductor chips.

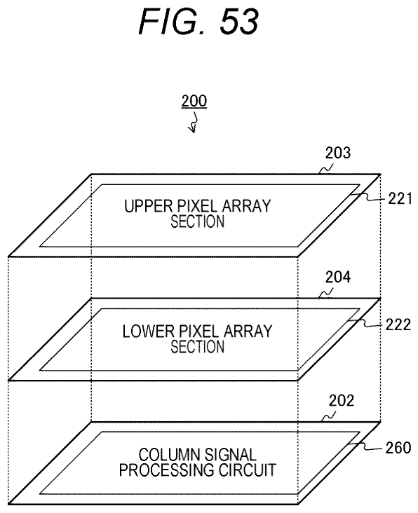

FIG. 53 is a diagram illustrating an example of a stacked structure of the solid-state imaging element 200 according to the fifth modification of the second embodiment of the present technology. The solid-state imaging element 200 of the fifth modification of the second embodiment includes an upper pixel chip 203, a lower pixel chip 204, and a circuit chip 202. These chips are stacked, and are electrically connected by, for example, Cu—Cu bonding. Note that, in addition to the Cu—Cu bonding, the connection can be made using a via or a bump.

The upper pixel chip 203 is provided with the upper pixel array section 221. The lower pixel chip 204 is provided with the lower pixel array section 222. For each pixel in the pixel array section 220, a part of the pixel is arranged in the upper pixel array section 221, and the rest is arranged in the lower pixel array section 222.

Furthermore, the circuit chip 202 is provided with the column signal processing circuit 260, the vertical scanning circuit 211, the control circuit 212, the DAC 213, and the load MOS circuit block 250. Circuits other than the column signal processing circuit 260 are not illustrated in the drawing.

Such a three-layer configuration as illustrated in the drawing allows a reduction in unnecessary space and allows further pixel miniaturization as compared with a two-layer configuration. Furthermore, the lower pixel chip 204 that is a second layer can be manufactured by a dedicated process for the capacitor and switch. Note that the first embodiment and each of the modifications may have a three-layer configuration.

As described above, in the fifth modification of the second embodiment of the present technology, since the circuits belonging to the solid-state imaging element 200 are dispersedly arranged in the three semiconductor chips, the pixels can be further miniaturized as compared with a case where the circuits are dispersedly arranged in the two semiconductor chips.

### 3. Third Embodiment

In the third modification of the second embodiment described above, the reset level is sampled and held in the exposure period, but in this configuration, the exposure period cannot be made shorter than the sample and hold period of the reset level. A solid-state imaging element 200 of a third embodiment is different from the third modification of the second embodiment in that an exposure period is further shortened by adding a transistor that discharges a charge from a photoelectric conversion element.

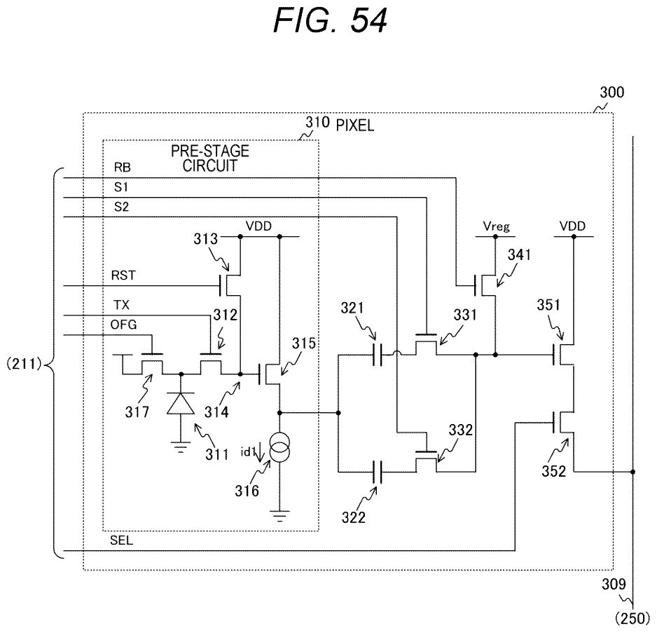

FIG. 54 is a circuit diagram illustrating a configuration example of the pixel 300 according to the third embodiment of the present technology. The pixel 300 of the third embodiment is different from the third modification of the second embodiment in that a discharge transistor 317 is further provided in a pre-stage circuit 310.

The discharge transistor 317 functions as an overflow drain that discharges a charge from the photoelectric conversion element 311 in accordance with a discharge signal ofg from the vertical scanning circuit 211. As the discharge transistor 317, for example, an nMOS transistors is used.

The configuration without the discharge transistor 317 as in the third modification of the second embodiment may suffer blooming when charges are transferred from the photoelectric conversion element 311 to the FD 314 for all the pixels. Then, at the time of FD reset, the potentials of the FD 314 and the pre-stage node drop. This pre-stage node is an output node of the pre-stage circuit 310. In response to the potential drop, charging and discharging currents of the capacitive elements 321 and 322 continue to occur, and IR drop in the power supply or the ground changes from a steady state without blooming.

On the other hand, at the time of sampling and holding the signal levels of all the pixels, after the transfer of the signal charges, the photoelectric conversion element 311 has no charge, so that blooming does not occur, and IR drop in the power supply or the ground goes into the steady state without blooming. Due to a difference between IR drop at the time of sampling and holding the reset level and IR drop at the time of sampling and holding the signal level, streaking noise occurs.

On the other hand, in the second embodiment in which the discharge transistor 317 is provided, the charges in the photoelectric conversion element 311 are discharged toward an overflow drain. Thus, IR drops at the time of sampling and holding the reset level and the signal level become almost identical to each other, so that it is possible to suppress streaking noise.

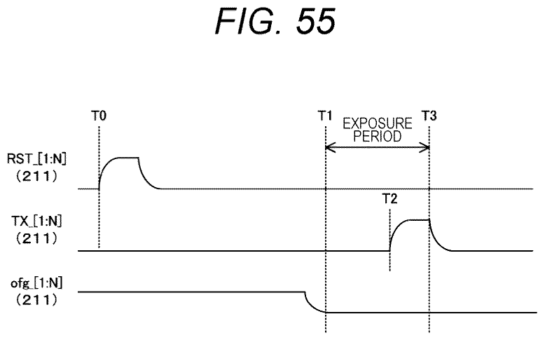

FIG. 55 is a timing chart illustrating an example of a global shutter operation according to the third embodiment of the present technology. At timing T0 before the start of exposure, the vertical scanning circuit 211 supplies the high-level FD reset signal RST to all the pixels over the pulse period while setting the discharge signal ofg to the high level for all the pixels. Thus, the PD reset and the FD reset are performed on all the pixels. Furthermore, the reset level is sampled and held. Here, ofg_[n] in the drawing indicates signals to the pixels in the n-th row of the N rows.

Then, at timing T1 that is the start of exposure, the vertical scanning circuit 211 returns the discharge signal ofg to the low level for all the pixels. The vertical scanning circuit 211 then supplies the high-level transfer signal TX to all the pixels over a period from timing T2 immediately before the end of exposure to timing T3 at the end of exposure. Thus, the signal level is sampled and held.

The configuration without the discharge transistor 317 as in the third modification of the second embodiment needs to turn on both the transfer transistor 312 and the FD reset transistor 313 at the start of exposure (that is, at the time of PD reset). With this control, at the time of PD reset, the FD 314 also needs to be reset at the same time. Accordingly, it is necessary to perform the FD reset again during the exposure period to sample and hold the reset level, so that the exposure period cannot be made shorter than the sample and hold period of the reset level. When the reset levels of all the pixels are sampled and held, a certain waiting time is required until the voltage and the current settle, and for example, a sample and hold period of several microseconds (μs) to several tens of microseconds (μs) is required.

On the other hand, in the third embodiment in which the discharge transistor 317 is provided, the PD reset and the FD reset can be separately performed. Accordingly, as illustrated in the example in the drawing, it is possible to sample and hold the reset level by performing the FD reset before cancellation of the PD reset (the start of exposure). Thus, the exposure period can be made shorter than the sample hold period of the reset level.

Note that the third embodiment can also be applied to each of the first embodiment and the modifications thereof.

As described above, according to the third embodiment of the present technology, since the discharge transistor 317 that discharges charges from the photoelectric conversion element 311 is provided, it is possible to sample and hold the reset level by performing the FD reset before the start of exposure. Thus, the exposure period can be made shorter than the sample hold period of the reset level.

### 4. Fourth Embodiment

In the second embodiment described above, the FD 314 is initialized with the power supply voltage VDD, but there is a possibility that this configuration causes deterioration of photo response non-uniformity (PRNU) due to variations of the capacitive elements 321 and 322 or parasitic capacitance. A solid-state imaging element 200 of this fourth embodiment is different from the solid-state imaging element 200 of the second embodiment in that PRNU is improved by lowering the power supply of the FD reset transistor 313 during reading.

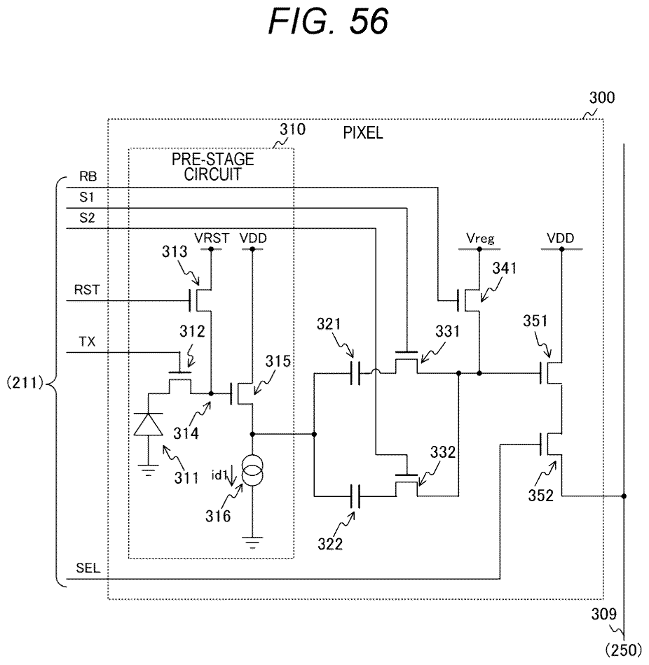

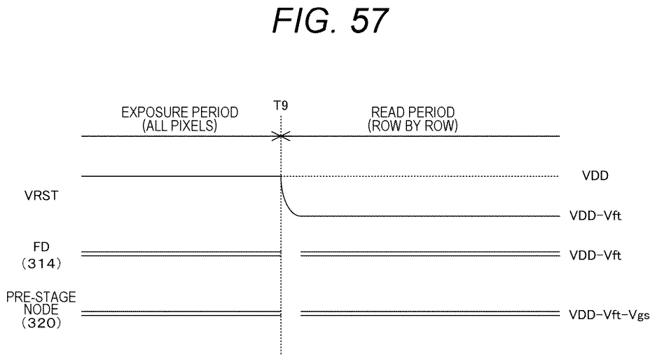

FIG. 56 is a circuit diagram illustrating a configuration example of the pixel 300 according to the fourth embodiment of the present technology. The pixel 300 of the third embodiment is different from that of the second embodiment in that the power supply for the FD reset transistor 313 is separated from the power supply voltage VDD for the pixel 300.

The FD reset transistor 313 of the fourth embodiment has a drain connected to a reset power supply voltage VRST. The reset power supply voltage VRST is controlled by, for example, the control circuit 212.

Here, deterioration of the PRNU in the pixel 300 of the second embodiment will be considered. In the second embodiment, at timing T0 immediately before the exposure start time, the potential of the FD 314 decreases due to reset feedthrough of the FD reset transistor 313. It is assumed that the amount of this fluctuation is denoted as Vft.

In the second embodiment, since the power supply voltage of the FD reset transistor 313 is VDD, the potential of the FD 314 varies from VDD to VDD−Vft at timing T0. Furthermore, the potential of the pre-stage node at the time of exposure is VDD−Vft−Vgs.

Furthermore, in the second embodiment, the FD reset transistor 313 shifts to the ON state at the time of reading, and the FD 314 is fixed to the power supply voltage VDD. The potentials of the pre-stage node and the post-stage node at the time of reading are shifted higher by about Vit by the amount of fluctuation Vit of the FD 314. The post-stage node is an input node of the post-stage circuit 340. However, due to variations in capacitance values of the capacitive elements 321 and 322 or parasitic capacitance, the shift voltage amount varies for each pixel, which causes deterioration of PRNU.

In particular, in order to reduce kTC noise during sampling and holding input conversion capacitance, it is necessary to increase a charge-voltage conversion efficiency of the FD 314. In order to increase the charge-voltage conversion efficiency, it is necessary to reduce the capacitance of the FD 314, but the smaller the capacitance of the FD 314, the larger the amount of fluctuation Vft, which may be several hundred millivolts (mV). In this case, the impact of the PRNU may be at a non-negligible level.

FIG. 57 is a timing chart illustrating an example of voltage control according to the fourth embodiment of the present technology.

The control circuit 212 performs control to make the reset power supply voltage VRST to be different between the row-by-row read period after timing T9 and the exposure period.

For example, during the exposure period, the control circuit 212 makes the reset power supply voltage VRST identical to the power supply voltage VDD. During the read period, on the other hand, the control circuit 212 lowers the reset power supply voltage VRST to VDD−Vft. That is, in the read period, the control circuit 212 decreases the reset power supply voltage VRST by an amount substantially matching the amount of fluctuation Vft due to the reset feedthrough. Through this control, the reset level of the FD 314 can be made the same during exposure and during reading.

By controlling the reset power supply voltage VRST, it is possible to reduce the amount of voltage fluctuation between the FD 314 and the pre-stage node as illustrated in the drawing. Thus, it is possible to suppress variations of the capacitive elements 321 and 322 and deterioration of PRNU due to parasitic capacitance.

Note that the fourth embodiment can also be applied to each of the first embodiment and its modifications. Furthermore, the modifications of the second embodiment and the third embodiment can also be applied to the fourth embodiment.

As described above, according to the fourth embodiment of the present technology, the control circuit 212 decreases the reset power supply voltage VRST by the amount of fluctuation Vft due to the reset feedthrough at the time of reading, and thus it is possible to equalize the reset level between the exposure and the reading. Thus, deterioration of photo response non-uniformity (PRNU) can be prevented.

### 5. Fifth Embodiment

In the second embodiment described above, the vertical scanning circuit 211 performs control to expose all the rows (all the pixels) simultaneously (that is, global shutter operation). However, in a case where simultaneous exposure is not required and low noise is demanded during testing or analysis, it is desirable to perform a rolling shutter operation. A solid-state imaging element 200 of a sixth embodiment is different from that of the second embodiment in that a rolling shutter operation is performed at the time of a test or the like.

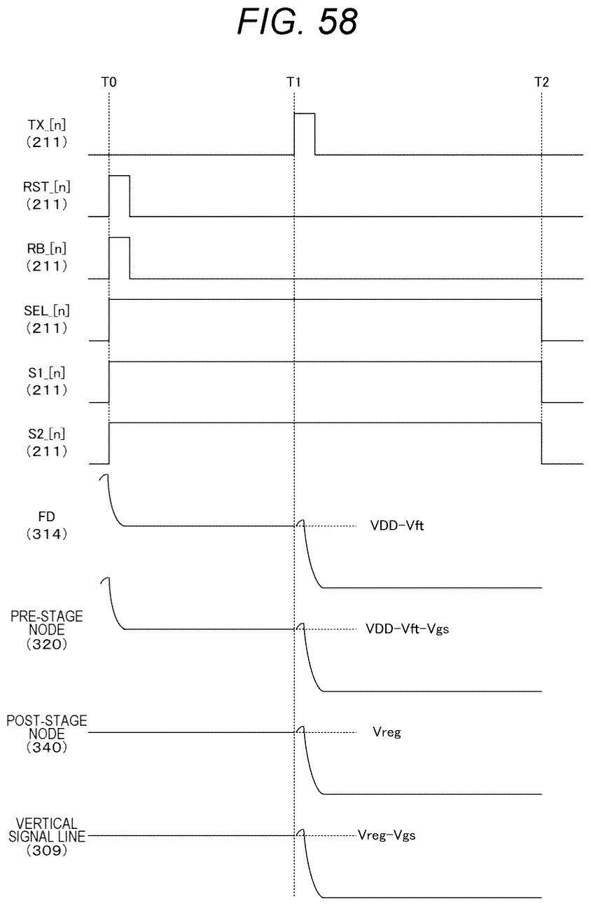

FIG. 58 is a timing chart illustrating an example of the rolling shutter operation according to the fifth embodiment of the present technology. The vertical scanning circuit 211 performs control to sequentially select a plurality of rows and start exposure. This drawing illustrates exposure control of the nth row.

During the period from timing T0 to timing T2, the vertical scanning circuit 211 supplies the high-level post-stage selection signal SEL, the selection signal S1, and the selection signal S2 to the nth row. Furthermore, at the exposure start timing T0, the vertical scanning circuit 211 supplies the high-level FD reset signal RST and the post-stage reset signal RB to the nth row over the pulse period. At timing T1 of the end of the exposure, the vertical scanning circuit 211 supplies the transfer signal TX to the nth row. The rolling shutter operation in the drawing allows the solid-state imaging element 200 to generate low-noise image data.

Note that, during normal imaging, the solid-state imaging element 200 according to the fifth embodiment performs the global shutter operation similarly to the second embodiment.

Furthermore, the sixth embodiment can be applied to each of the first embodiment and the modifications thereof.

Furthermore, modifications of the second embodiment and the third and fourth embodiments can also be applied to the fifth embodiment.

As described above, according to the fifth embodiment of the present technology, the vertical scanning circuit 211 performs control (that is, rolling shutter operation) to sequentially select a plurality of rows and start exposure, and thus it is possible to generate low-noise image data.

### 6. Sixth Embodiment

In the second embodiment described above, the source of the pre-stage source follower (the pre-stage amplification transistor 315 and the current source transistor 316) is connected to the power supply voltage VDD, and row-by-row reading is performed with the source follower in the on state. However, there is a possibility that this driving method causes circuit noise of the pre-stage source follower during row-by-row reading to propagate to the subsequent stages, and random noise increases accordingly. The solid-state imaging element 200 of the sixth embodiment is different from that of the second embodiment in that noise is reduced by turning off the source follower of the preceding stage at the time of reading.

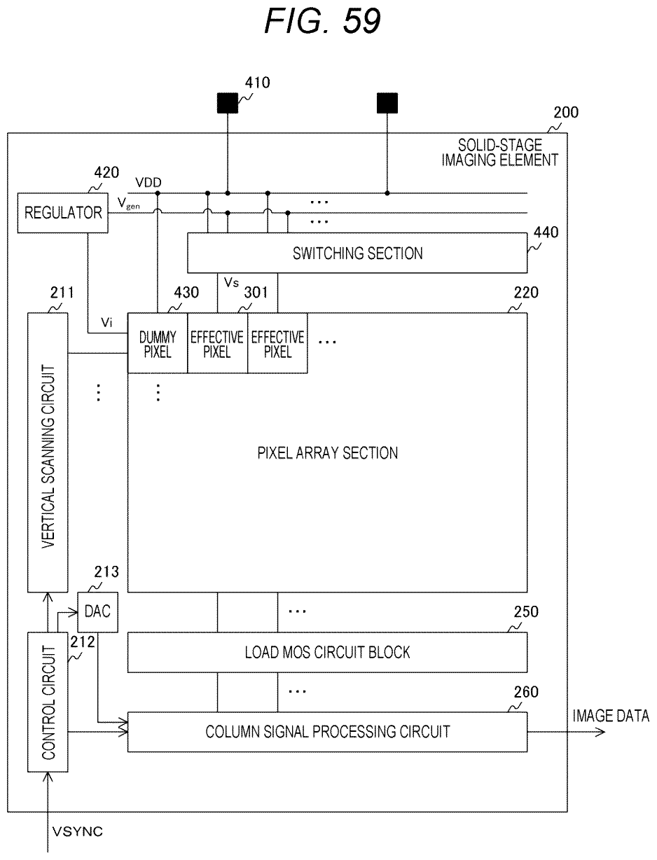

FIG. 59 is a block diagram illustrating a configuration example of a solid-state imaging element 200 according to a sixth embodiment of the present technology. The solid-state imaging element 200 of the sixth embodiment is different from that of the second embodiment in further including a regulator 420 and a switching section 440. Furthermore, in the pixel array section 220 of the sixth embodiment, a plurality of effective pixels 301 and a predetermined number of dummy pixels 430 are arranged. The dummy pixels 430 are arranged around the region in which the effective pixels 301 are arrayed.

Furthermore, the power supply voltage VDD is supplied to each of the dummy pixels 430, and the power supply voltage VDD and a source voltage Vs are supplied to each of the effective pixels 301. A signal line through which the power supply voltage VDD is supplied to the effective pixels 301 is omitted in the drawing. Furthermore, the power supply voltage VDD is supplied from a pad 410 located outside the solid-state imaging element 200.

The regulator 420 generates a constant generation voltage Vgen on the basis of an input voltage Vi from the dummy pixels 430, and supplies the generation voltage Vgen to the switching section 440. The switching section 440 selects either the power supply voltage VDD received from the pad 410 or the generation voltage Vgen received from the regulator 420, and supplies the selected voltage as the source voltage Vs to each of the columns of the effective pixels 301.

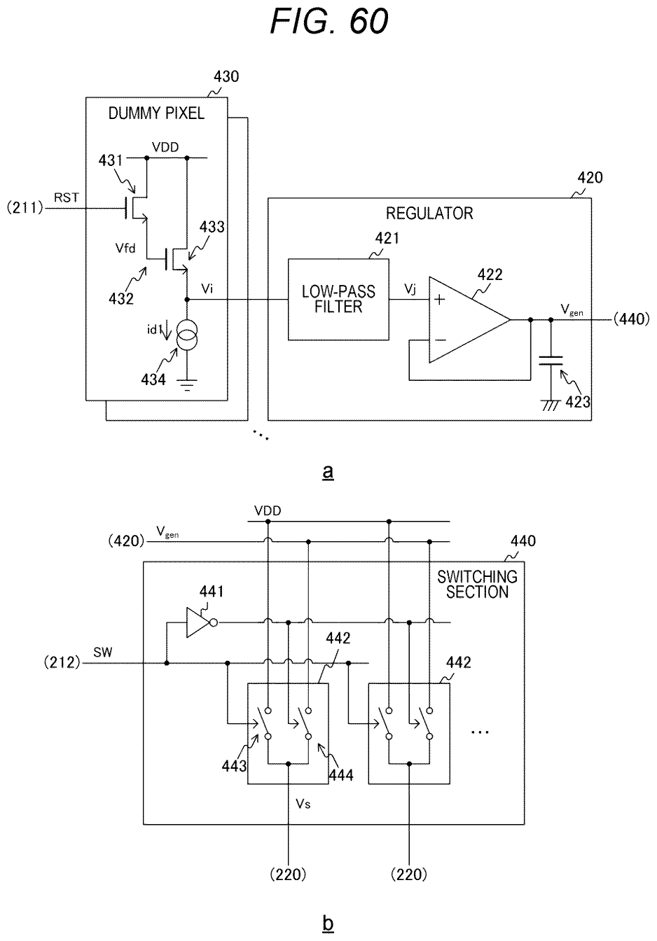

FIG. 60 is a circuit diagram illustrating a configuration example of the dummy pixel 430, the regulator 420, and the switching section 440 according to the sixth embodiment of the present technology. Of the drawing, a is a circuit diagram of the dummy pixel 430 and the regulator 420, and b is a circuit diagram of the switching section 440.

As illustrated in a of the drawing, the dummy pixel 430 includes a reset transistor 431, an FD 432, an amplification transistor 433, and a current source transistor 434. The reset transistor 431 initializes the FD 432 in accordance with an FD reset signal RST from the vertical scanning circuit 211. The FD 432 accumulates charges, and generates a voltage corresponding to the amount of charges. The amplification transistor 433 amplifies a level of a voltage of the FD 432 and supplies the amplified voltage as the input voltage Vi to the regulator 420.

Furthermore, the reset transistor 431 and the amplification transistor 433 have their respective sources connected to the power supply voltage VDD. The current source transistor 434 is connected to a drain of the amplification transistor 433. The current source transistor 434 supplies the current id1 under the control of the vertical scanning circuit 211.

The regulator 420 includes a low-pass filter 421, a buffer amplifier 422, and a capacitive element 423. The low-pass filter 421 passes, as an output voltage Vj, a component in a low-frequency band below a predetermined frequency out of a signal of the input voltage Vi.

The output voltage Vj is input to a non-inverting input terminal (+) of the buffer amplifier 422. An inverting input terminal (−) of the buffer amplifier 422 is connected to an output terminal thereof. The capacitive element 423 holds a voltage of the output terminal of the buffer amplifier 422 as Vgen. This Vgen is supplied to the switching section 440.

As illustrated in b of the drawing, the switching section 440 includes an inverter 441 and a plurality of switching circuits 442. The switching circuits 442 are each disposed for a corresponding one of the columns of the effective pixels 301.

The inverter 441 inverts the switching signal SW from the control circuit 212. The inverter 441 supplies the inverted signal to each of the switching circuits 442.

The switching circuits 442 each select either the power supply voltage VDD or the generation voltage Vgen, and supplies the selected voltage as the source voltage Vs to the corresponding column in the pixel array section 220. The switching circuit 442 includes switches 443 and 444. The switch 443 opens and closes a path between the node of the power supply voltage VDD and the corresponding column in accordance with the switching signal SW. The switch 444 opens and closes a path between the node of the generation voltage Vgen and the corresponding column, in accordance with an inverted signal of the switching signal SW.

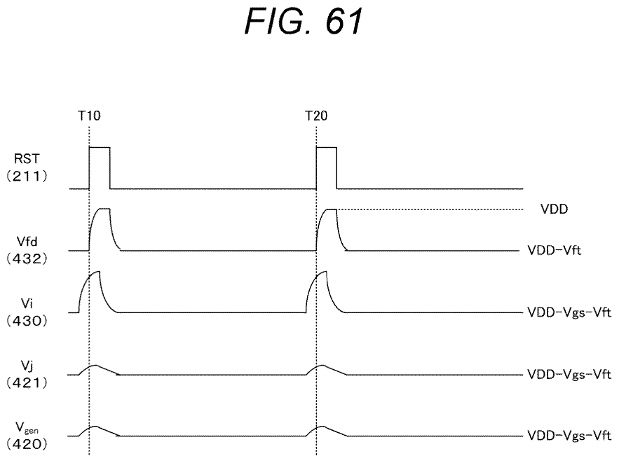

FIG. 61 is a timing chart illustrating an example of the operation of the dummy pixel 430 and the regulator 420 according to the sixth embodiment of the present technology. At timing T10 immediately before reading of a certain row, the vertical scanning circuit 211 supplies the FD reset signal RST (here, the power supply voltage VDD) to each of the dummy pixels 430. A potential Vfd of the FD 432 in each dummy pixel 430 is initialized to the power supply voltage VDD. Then, when the FD reset signal RST becomes a low level, the FD reset signal RST fluctuates to VDD−Vft due to reset feedthrough.

Furthermore, the input voltage Vi decreases to VDD−Vgs−Vsig after the reset. Passing through the low-pass filter 421 makes Vj and Vgen almost constant.

After timing T20 immediately before reading of the next row, similar control is performed for each row, and the constant generation voltage Vgen is supplied.

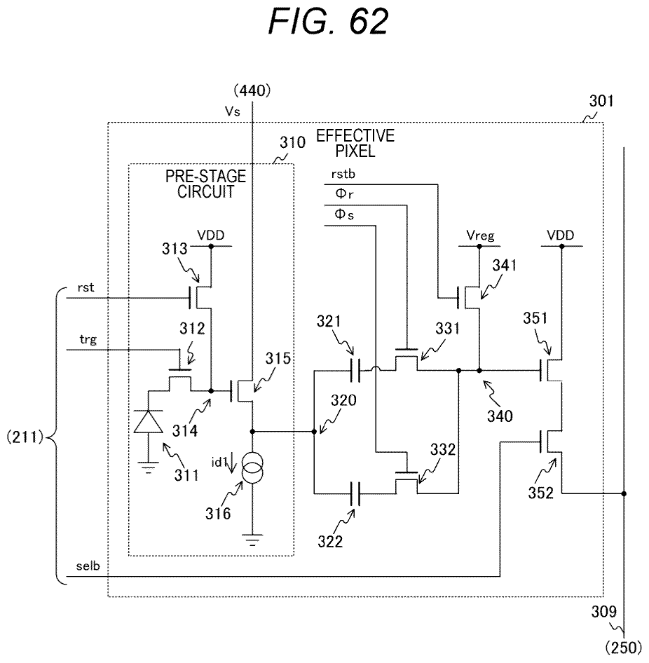

FIG. 62 is a circuit diagram illustrating a configuration example of the effective pixel 301 according to the sixth embodiment of the present technology. The effective pixel 301 is similar in circuit configuration to the pixel 300 of the second embodiment except that the source voltage Vs from the switching section 440 is supplied to the source of the pre-stage amplification transistor 315.

In the sixth embodiment, when exposure is performed simultaneously in all the pixels, the switching section 440 selects the power supply voltage VDD and supplies the power supply voltage VDD as the source voltage Vs. Furthermore, the voltage of the pre-stage node decreases from VDD−Vgs−Vth to VDD−Vgs−Vsig at timing T4. Here, Vth represents a threshold voltage of the transfer transistor 312.

Furthermore, in the sixth embodiment, at the time of reading, the switching section 440 selects the generation voltage Vgen and supplies the generated voltage Vgen as the source voltage Vs. The generation voltage Vgen is adjusted to VDD−Vgs−Vft. Furthermore, in the seventh embodiment, the vertical scanning circuit 211 controls the current source transistors 316 of all the rows (all the pixels) to stop the supply of the current id1.

As described above, according to the sixth embodiment of the present technology, since the source follower in the preceding stage is turned off at the time of reading, noise generated in the source follower can be reduced.

### 7. Example of Application to Mobile Object

The technology according to the present disclosure (the present technology) can be applied to various products. For example, the technology according to the present disclosure may be achieved in the form of a device to be mounted on a mobile object of any kind, such as an automobile, an electric vehicle, a hybrid electric vehicle, a motorcycle, a bicycle, a personal mobility, an airplane, a drone, a vessel, or a robot.

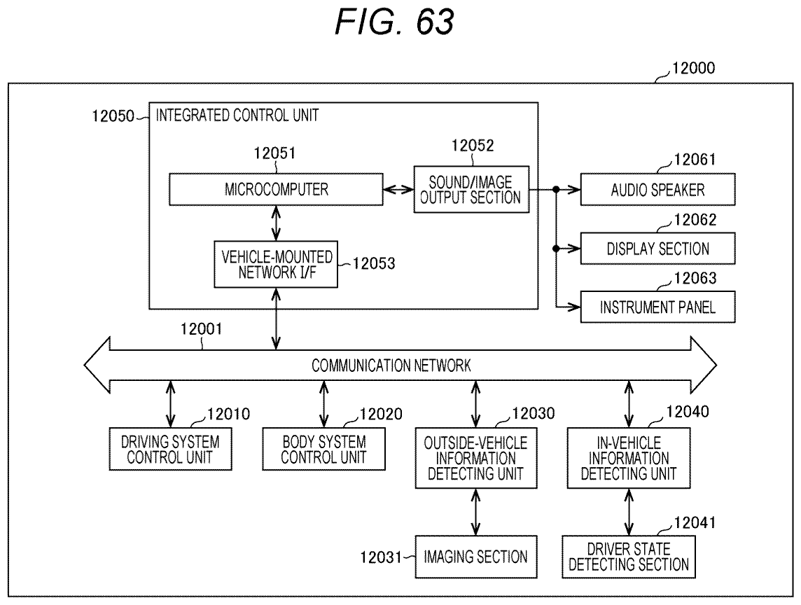

FIG. 63 is a block diagram illustrating a schematic configuration example of a vehicle control system which is an example of a mobile object control system to which the technology according to the present disclosure can be applied.

The vehicle control system 12000 includes a plurality of electronic control units connected to each other via a communication network 12001. In the example illustrated in FIG. 63, the vehicle control system 12000 includes a driving system control unit 12010, a body system control unit 12020, an outside-vehicle information detecting unit 12030, an in-vehicle information detecting unit 12040, and an integrated control unit 12050. Further, a microcomputer 12051, a sound/image output section 12052, and a vehicle-mounted network interface (I/F) 12053 are illustrated as functional components of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020, on the basis of the information about the outside of the vehicle acquired by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 63, an audio speaker 12061, a display section 12062, and an instrument panel 12063 are illustrated as output devices. The display section 12062 may, for example, include at least one of an on-board display and a head-up display.

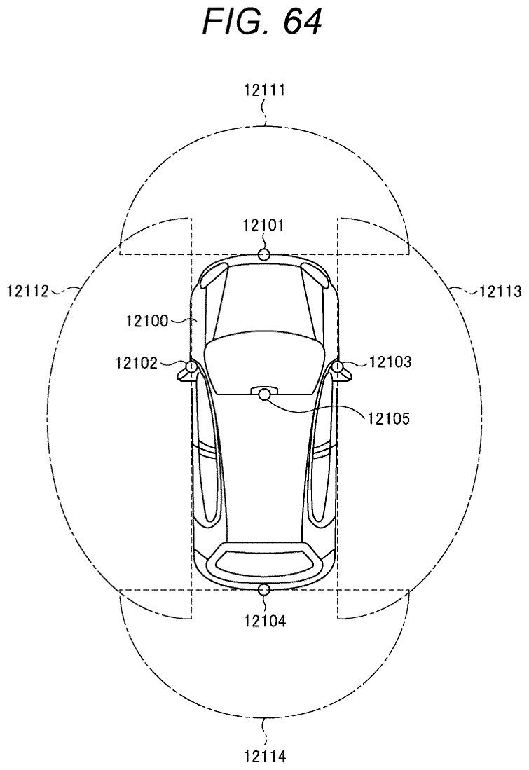

FIG. 64 is a diagram illustrating an example of an installation position of the imaging section 12031.

In FIG. 64, the imaging section 12031 includes imaging sections 12101, 12102, 12103, 12104, and 12105.

The imaging sections 12101, 12102, 12103, 12104, and 12105 are provided at positions such as the front nose, the sideview mirrors, the rear bumper, the back doors, and an upper portion of the windshield in the interior of the vehicle 12100, for example. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 64 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 among the configurations described above. Specifically, for example, the solid-state imaging element 200 in FIG. 1 can be applied to the imaging section 12031. By applying the technology according to the present disclosure to the imaging section 12031, it is possible to obtain a captured image that is easier to view, thereby making it possible to reduce driver fatigue.

Note that the embodiments described above illustrate an example for embodying the present technology, and the matters in the embodiments and the matters specifying the invention in the claims have a correspondence relationship. Similarly, the matters specifying the invention in the claims and the matters with the same names in the embodiments of the present technology have correspondence relationships, respectively. However, the present technology is not limited to the embodiments, and can be embodied by applying various modifications to the embodiments without departing from the scope of the present technology.

Note that the effects described in the present specification are merely examples and are not limited, and other effects may also be achieved.

Note that the present technology may also have the following configuration.

(1) A solid-state imaging element including:
a pixel signal generating section that sequentially generates first and second pixel signals;
a first sample and hold circuit that holds the first pixel signal;
a second sample and hold circuit that holds the second pixel signal; and
a vertical scanning circuit that controls the first and second sample and hold circuits to generate a combined signal of the first and second pixel signals.

(2) The solid-state imaging element according to (1) above, in which
the first pixel signal includes a first reset level and a first signal level,
the second pixel signal includes a second reset level and a second signal level, and
the vertical scanning circuit causes each of a signal obtained by adding the first reset level and the second signal level and a signal obtained by adding the first signal level and the second reset level to be generated as the combined signal.

(3) The solid-state imaging element according to (1) or (2) above, further including:
a third sample and hold circuit that holds the second pixel signal; and
a fourth sample and hold circuit that holds the second pixel signal.

(4) The solid-state imaging element according to (3) above, in which
the pixel signal generating section further generates a third pixel signal, and
the vertical scanning circuit performs control to cause the first and second sample and hold circuits to generate a combined signal of the first and second pixel signals and cause one of the third and fourth sample and hold circuits to output the second pixel signal, control to cause the first, second, and fourth sample and hold circuits to hold the third pixel signal, and control to cause the third and fourth sample and hold circuits to generate a combined signal of the second and third pixel signals and cause one of the first and second sample and hold circuits to output the third pixel signal.

(5) The solid-state imaging element according to (3) above, in which
the pixel signal generating section further generates a third pixel signal, and
the vertical scanning circuit performs control to cause the first and second sample and hold circuits to generate a combined signal of the first and second pixel signals and cause the fourth sample and hold circuit to output the second pixel signal, control to cause the first, second, and fourth sample and hold circuits to hold the third pixel signal, and control to cause the second and third sample and hold circuits to generate a combined signal of the second and third pixel signals and cause the fourth sample and hold circuit to output the third pixel signal.

(6) The solid-state imaging element according to any one of (1) to (5) above, in which
the pixel signal generating section includes first and second pre-stage circuits,
the first pre-stage circuit includes
a first transfer transistor that transfers a charge from a first photoelectric conversion element to a first floating diffusion layer, and
a first connection transistor that connects the first floating diffusion layer and a predetermined node, and
the second pre-stage circuit includes
a second transfer transistor that transfers a charge from a second photoelectric conversion element to a second floating diffusion layer, and
a second connection transistor that connects the second floating diffusion layer and a predetermined node.

(7) The solid-state imaging element according to any one of (1) to (5) above, in which
the pixel signal generating section includes a pre-stage circuit, and
the pre-stage circuit includes a transfer transistor that transfers a charge from a photoelectric conversion element to a floating diffusion layer.

(8) The solid-state imaging element according to any one of (1) to (7) above, further including:
a motion determination section that determines presence or absence of motion of a subject on the basis of the combined signal; and
an interface that outputs the second pixel signal in a case where the motion is made.

(9) The solid-state imaging element according to any one of (1) to (7) above, further including:
a column signal processing circuit that outputs the second pixel signal when receiving a determination result indicating that a subject has made motion from the outside.

(10) A method for controlling a solid-state imaging element, the method including:
a pixel signal generating procedure of sequentially generating first and second pixel signals;
a first sample and hold procedure of holding the first pixel signal by a first sample and hold circuit;
a second sample and hold procedure of holding the second pixel signal by a second sample and hold circuit; and
a vertical scanning procedure of controlling the first and second sample and hold circuits to generate a combined signal of the first and second pixel signals.

(11) A solid-state imaging element including:
a predetermined number of pixels that sequentially hold and sequentially output a first signal level and a second signal level according to an exposure amount, generate a reset level, and sequentially output the second signal level and the reset level;
a differentiation circuit that obtains a difference between the first signal level and the second signal level;
a comparison section that compares an absolute value of the difference with a predetermined threshold and outputs a comparison result;
a region determination section that determines whether or not each of the pixels is in a region of a mobile object on the basis of the difference and the comparison result; and
an analog-to-digital converter that sequentially converts the second signal level and the reset level into a digital signal.

(12) The solid-state imaging element according to (11) above, further including:
an analog-to-digital converter that converts each of the reset level and the second signal level into a digital signal;
a vertical scanning circuit that drives a predetermined number of the pixels; and
a control circuit that controls the vertical scanning circuit and the analog-to-digital converter to generate the digital signal in a clipping region including the region of the mobile object in a case where any of the pixels is determined to be in the region of the mobile object.

(13) The solid-state imaging element according to (12) above, in which
the control circuit may receive clipping region information indicating the clipping region from outside.

(14) The solid-state imaging element according to (11) above, further including:
a control circuit that changes an analog gain of the region of the mobile object in a case where it is determined that any of the pixels is within the region of the mobile object.

(15) The solid-state imaging element according to any one of (11) to (14) above, in which
the reset level includes a first reset level and a second reset level,
the pixels hold the first reset level, the first signal level, the second reset level, and the second signal level and sequentially output the first signal level and the second signal level, and in a case where it is determined that any of the pixels is in the region of the mobile object, the pixels sequentially output the second reset level and the second signal level.

(16) A method for controlling a solid-state imaging element, the method including:
a procedure in which a predetermined number of pixels sequentially hold and sequentially output a first signal level and a second signal level according to an exposure amount, generate a reset level, and sequentially output the second signal level and the reset level;
a differentiation procedure of obtaining a difference between the first signal level and the second signal level;
a comparison procedure of comparing an absolute value of the difference with a predetermined threshold and outputting a comparison result;
a region determination procedure of determining whether or not each of the pixels is in a region of the mobile object on the basis of the difference and the comparison result; and
an analog-to-digital conversion procedure of sequentially converting the second signal level and the reset level into a digital signal.

### REFERENCE SIGNS LIST

100 Host
111, 264 Motion determination section
112 Image processing section
113 Recording section
115 Clipping region setting section
116 Combining section
117 Background data holding section
200 Solid-state imaging element
201 Pixel chip
202 Circuit chip
203 Upper pixel chip
204 Lower pixel chip
211 Vertical scanning circuit
212 Control circuit
213 DAC
220 Pixel array section
221 Upper pixel array section
222 Lower pixel array section
250 Load MOS circuit block
251 Load MOS transistor
260 Column signal processing circuit
261, 741 ADC
262 Digital signal processing section
263, 710 Selector
265 Communication interface
300 Pixel
301 Effective pixel
310, 510, 520, 530, 540 Pre-stage circuit
311, 511, 521, 531, 541 Photoelectric conversion element
312, 512, 522, 532, 542 Transfer transistor
313, 513, 523, 533, 543 FD reset transistor
314, 432, 514, 524, 534, 544 FD
315, 515, 525, 535, 545 Pre-stage amplification transistor
316, 434 Current source transistor
317 Discharge transistor
320, 550, 560, 570, 580 Sample and hold circuit
321, 322, 325 to 328, 423, 551, 552, 561, 562, 571, 572, 581, 582, 721, 722 Capacitive element
331, 332, 335 to 338, 553, 554, 563, 564, 573, 574, 583, 584 Selection transistor
340, 590 Post-stage circuit
341, 591 Post-stage reset transistor
351, 592 Post-stage amplification transistor
352, 593 Post-stage selection transistor
420 Regulator
421 Low-pass filter
422 Buffer amplifier
430 Dummy pixel
431 Reset transistor
433 Amplification transistor
440 Switching section
441 Inverter
442 Switching circuit
443, 444, 711, 712 Switch
500 Pixel block
501 Pixel signal generating section
502 Sample and hold block
516, 526, 536, 546 Precharge transistor
517, 527, 537, 547 Connection transistor
700 Column circuit
720 Differentiation circuit
723 Operational amplifier
724 Auto-zero switch
730 Comparison section
731 Absolute value circuit
732 Comparator
742 Data conversion section
750 Region determination section
751, 752 Line buffer
753 Output control section
754, 755 Rise detecting section
756 Exclusive logical sum (XOR) gate
757 Logical sum (OR) gate
760 Flag holding section
12031 Imaging section

1. A solid-state imaging element comprising:
a pixel signal generating section that sequentially generates first and second pixel signals;
a first sample and hold circuit that holds the first pixel signal;
a second sample and hold circuit that holds the second pixel signal; and
a vertical scanning circuit that controls the first and second sample and hold circuits to generate a combined signal of the first and second pixel signals.

2. The solid-state imaging element according to claim 1, wherein
the first pixel signal includes a first reset level and a first signal level,
the second pixel signal includes a second reset level and a second signal level, and
the vertical scanning circuit causes each of a signal obtained by adding the first reset level and the second signal level and a signal obtained by adding the first signal level and the second reset level to be generated as the combined signal.

3. The solid-state imaging element according to claim 1, further comprising:
a third sample and hold circuit that holds the second pixel signal; and
a fourth sample and hold circuit that holds the second pixel signal.

4. The solid-state imaging element according to claim 3, wherein
the pixel signal generating section further generates a third pixel signal, and
the vertical scanning circuit performs control to cause the first and second sample and hold circuits to generate a combined signal of the first and second pixel signals and cause one of the third and fourth sample and hold circuits to output the second pixel signal, control to cause the first, second, and fourth sample and hold circuits to hold the third pixel signal, and control to cause the third and fourth sample and hold circuits to generate a combined signal of the second and third pixel signals and cause one of the first and second sample and hold circuits to output the third pixel signal.

5. The solid-state imaging element according to claim 3, wherein
the pixel signal generating section further generates a third pixel signal, and
the vertical scanning circuit performs control to cause the first and second sample and hold circuits to generate a combined signal of the first and second pixel signals and cause the fourth sample and hold circuit to output the second pixel signal, control to cause the first, second, and fourth sample and hold circuits to hold the third pixel signal, and control to cause the second and third sample and hold circuits to generate a combined signal of the second and third pixel signals and cause the fourth sample and hold circuit to output the third pixel signal.

6. The solid-state imaging element according to claim 1, wherein
the pixel signal generating section includes first and second pre-stage circuits,
the first pre-stage circuit includes
a first transfer transistor that transfers a charge from a first photoelectric conversion element to a first floating diffusion layer, and
a first connection transistor that connects the first floating diffusion layer and a predetermined node, and
the second pre-stage circuit includes
a second transfer transistor that transfers a charge from a second photoelectric conversion element to a second floating diffusion layer, and
a second connection transistor that connects the second floating diffusion layer and a predetermined node.

7. The solid-state imaging element according to claim 1, wherein
the pixel signal generating section includes a pre-stage circuit, and
the pre-stage circuit includes a transfer transistor that transfers a charge from a photoelectric conversion element to a floating diffusion layer.

8. The solid-state imaging element according to claim 1, further comprising:
a motion determination section that determines presence or absence of motion of a subject on a basis of the combined signal; and
an interface that outputs the second pixel signal in a case where the motion is made.

9. The solid-state imaging element according to claim 1, further comprising:
a column signal processing circuit that outputs the second pixel signal when receiving a determination result indicating that a subject has made motion from the outside.

10. A method for controlling a solid-state imaging element, the method comprising:
a pixel signal generating procedure of sequentially generating first and second pixel signals;
a first sample and hold procedure of holding the first pixel signal by a first sample and hold circuit;
a second sample and hold procedure of holding the second pixel signal by a second sample and hold circuit; and
a vertical scanning procedure of controlling the first and second sample and hold circuits to generate a combined signal of the first and second pixel signals.

11. A solid-state imaging element comprising:
a predetermined number of pixels that sequentially hold and sequentially output a first signal level and a second signal level according to an exposure amount, generate a reset level, and sequentially output the second signal level and the reset level;
a differentiation circuit that obtains a difference between the first signal level and the second signal level;
a comparison section that compares an absolute value of the difference with a predetermined threshold and outputs a comparison result;
a region determination section that determines whether or not each of the pixels is in a region of a mobile object on a basis of the difference and the comparison result; and
an analog-to-digital converter that sequentially converts the second signal level and the reset level into a digital signal.

12. The solid-state imaging element according to claim 11, further comprising:
an analog-to-digital converter that converts each of the reset level and the second signal level into a digital signal;
a vertical scanning circuit that drives a predetermined number of the pixels; and
a control circuit that controls the vertical scanning circuit and the analog-to-digital converter to generate the digital signal in a clipping region including the region of the mobile object in a case where any of the pixels is determined to be in the region of the mobile object.

13. The solid-state imaging element according to claim 12, wherein
the control circuit receives clipping region information indicating the clipping region from outside.

14. The solid-state imaging element according to claim 11, further comprising:
a control circuit that changes an analog gain of the region of the mobile object in a case where it is determined that any of the pixels is within the region of the mobile object.

15. The solid-state imaging element according to claim 11, wherein
the reset level includes a first reset level and a second reset level,
the pixels hold the first reset level, the first signal level, the second reset level, and the second signal level and sequentially output the first signal level and the second signal level, and in a case where it is determined that any of the pixels is in the region of the mobile object, the pixels sequentially output the second reset level and the second signal level.

16. A method for controlling a solid-state imaging element, the method comprising:
a procedure in which a predetermined number of pixels sequentially hold and sequentially output a first signal level and a second signal level according to an exposure amount, generate a reset level, and sequentially output the second signal level and the reset level;
a differentiation procedure of obtaining a difference between the first signal level and the second signal level;
a comparison procedure of comparing an absolute value of the difference with a predetermined threshold and outputting a comparison result;
a region determination procedure of determining whether or not each of the pixels is in a region of the mobile object on a basis of the difference and the comparison result; and
an analog-to-digital conversion procedure of sequentially converting the second signal level and the reset level into a digital signal.
